(19) United States
(12) Patent Application Publication
(10) Pub. No.: US 2026/0291892 A1
(43) Pub. Date: Sep. 24, 2026

(54) SYSTEM

(71) Applicant: SoftBank Group Corp., Tokyo (JP)

(72) Inventor: Shunichi TAMURA, Tokyo (JP)

(73) Assignee: SoftBank Group Corp., Tokyo (JP)

(21) Appl. No.: 19/567,419

(22) Filed: Mar. 16, 2026

(30) Foreign Application Priority Data
Mar. 19, 2025 (JP) 2025-044992

(51) Int. Cl. H04L 51/02; G06N 3/045; G10L 15/26

(52) U.S. Cl. CPC H04L 51/02; G06N 3/045; G10L 15/26

(57) ABSTRACT

A system includes a processor that is configured to provide an interface for collecting tax information through interaction with a user, analyze collected tax information and input a prompt sentence to a generative artificial intelligence model to generate an optimal tax strategy, and present the generated tax strategy to the user and update the tax strategy based on feedback from the user.

### CROSS-REFERENCE TO RELATED APPLICATION

This application is based on and claims priority under 35 USC 119 from Japanese Patent Application No. 2025-044992 filed on Mar. 19, 2025, the disclosure of which is incorporated by reference herein.

### BACKGROUND

### Technical Field

The present disclosure relates to a system.

### Related Art

Japanese Patent Application Laid-Open (JP-A) No. 2022-180282 discloses a persona chatbot control method executed by at least one processor. The method includes steps of: receiving a user utterance, adding the user utterance to a prompt including a description of a chatbot character and an associated instruction sentence, encoding the prompt, and inputting the encoded prompt to a language model to generate a chatbot utterance responding to the user utterance.

Conventional tax preparation tools and advisory systems require users to manually input structured data and to interpret complex tax rules without interactive guidance. In many cases, users are unable to fully utilize available deductions and tax-saving opportunities, because the systems do not flexibly collect tax information in natural language, do not effectively leverage generative artificial intelligence models, and do not provide iterative refinement of tax strategies based on user feedback. Furthermore, existing systems generally lack a unified mechanism that seamlessly connects interactive information collection, generation of an optimal tax strategy using a generative artificial intelligence model, strategy updating based on user feedback, and automatic preparation of a tax return in accordance with the updated strategy. Therefore, there is a need for a system and method that can interactively collect tax information, automatically generate and refine an optimal tax strategy using a generative artificial intelligence model, and automatically prepare a tax return based on the refined strategy, thereby reducing user burden and improving the quality and personalization of tax-saving support.

### SUMMARY

To solve the above-described problems, a system according to one aspect of the present invention comprises a processor, wherein the processor is configured to provide an interface for collecting tax information through interaction with a user, analyze collected tax information and input a prompt sentence to a generative artificial intelligence model to generate an optimal tax strategy, and present the generated tax strategy to the user and update the tax strategy based on feedback from the user. In one embodiment, the processor is further configured to analyze the feedback from the user and generate a new prompt sentence for updating the tax strategy, such that iterative refinement of the tax strategy is achieved in accordance with the user's preferences and additional information. In another embodiment, the processor is configured to automatically prepare a tax return based on the updated tax strategy, by mapping elements of the updated tax strategy and the collected tax information to corresponding fields of a tax return form, thereby enabling end-to-end automation from interactive tax information collection through strategy generation and refinement to automatic tax return preparation.

The term “system” refers to a combination of hardware and software components, including at least one processor and associated memory, configured to execute the functions described in the claims.

The term “processor” refers to one or more hardware processing units, such as a central processing unit (CPU), a graphics processing unit (GPU), or another computing device, configured to execute instructions stored in memory to perform the functions described in the claims.

The term “interface” refers to a hardware and/or software mechanism, such as a graphical user interface, command-line interface, application programming interface, or voice-based interface, that enables interaction between the user and the system for the purpose of collecting tax information and presenting a tax strategy.

The term “tax information” refers to information related to a user's tax situation, including but not limited to income, expenses, deductions, credits, exemptions, non-taxable income, personal attributes relevant to taxation, and any other data required for generating a tax strategy or preparing a tax return.

The term “interaction with a user” refers to a bidirectional exchange of information between the system and the user, using natural language or structured input, via text, voice, or other input/output modalities, in which the system prompts the user and the user provides responses.

The term “analyze” refers to processing, interpreting, classifying, aggregating, or otherwise operating on collected data, such as tax information or user feedback, using one or more algorithms, including rule-based methods, statistical methods, or machine learning methods.

The term “prompt sentence” refers to a text string or structured input that is provided as input to a generative artificial intelligence model, the text string or structured input being formulated based on the collected tax information or user feedback in order to cause the model to generate a tax strategy or an update to a tax strategy.

The term “generative artificial intelligence model” refers to a machine learning model, such as a neural network-based language model or other generative model, that is configured to generate text or other outputs in response to input data, including the prompt sentence, and that is used to generate or refine a tax strategy.

The term “optimal tax strategy” refers to a set of recommendations, guidelines, or actions related to tax planning or tax filing, generated based on the collected tax information, which aim to reduce tax liability, improve tax efficiency, or otherwise optimize the user's tax outcome within the constraints of applicable tax laws and regulations.

The term “generated tax strategy” refers to an instance of a tax strategy output by the generative artificial intelligence model in response to a prompt sentence, including both an initial tax strategy and any updated versions of the tax strategy.

The term “present” refers to outputting information, such as the generated tax strategy, to the user via the interface, including displaying the information on a screen, outputting the information by voice, or delivering the information through another perceptible medium.

The term “feedback from the user” refers to information provided by the user in response to a presented tax strategy, including but not limited to evaluations, comments, modifications, preferences, confirmations, or rejections, expressed in natural language or structured form.

The term “update the tax strategy” refers to modifying, refining, or supplementing an existing tax strategy based on additional information, such as user feedback or newly collected tax information, including generating a revised or alternative version of the tax strategy.

The term “new prompt sentence” refers to a prompt sentence that is generated based on the user's feedback or updated tax information, and that is used as input to the generative artificial intelligence model for the purpose of generating an updated tax strategy.

The term “tax return” refers to a document or electronic data set that is prepared for submission to a tax authority and that includes information such as income, deductions, credits, taxable income, tax due, and other required tax-related fields in accordance with applicable tax laws and regulations.

The term “automatically prepare a tax return” refers to generating at least part of the contents of a tax return without requiring the user to manually enter the corresponding tax calculations or field values, by using the updated tax strategy and the collected tax information to populate one or more fields of the tax return.

### BRIEF DESCRIPTION OF THE DRAWINGS

Exemplary embodiments of the present disclosure will be described in detail based on the following figures, wherein:

FIG. 1 is a schematic diagram illustrating an example of a configuration of a data processing system according to a first exemplary embodiment;

FIG. 2 is a schematic diagram illustrating an example of relevant functions of a data processing device and a smart device according to the first exemplary embodiment;

FIG. 3 is a schematic diagram illustrating an example of a configuration of a data processing system according to a second exemplary embodiment;

FIG. 4 is a schematic diagram illustrating an example of relevant functions of a data processing device and smart glasses according to the second exemplary embodiment;

FIG. 5 is a schematic diagram illustrating an example of a configuration of a data processing system according to a third exemplary embodiment;

FIG. 6 is a schematic diagram illustrating an example of relevant functions of a data processing device and a headset-type terminal according to the third exemplary embodiment;

FIG. 7 is a schematic diagram illustrating an example of a configuration of a data processing system according to a fourth exemplary embodiment;

FIG. 8 is a schematic diagram illustrating an example of relevant functions of a data processing device and a robot according to the fourth exemplary embodiment;

FIG. 9 illustrates an emotion map mapping plural emotions;

FIG. 10 illustrates an emotion map mapping plural emotions;

FIG. 11 is a sequence diagram showing the flow of data processing system processing in Example 1;

FIG. 12 is a sequence diagram showing the flow of data processing system processing in Application Example 1;

FIG. 13 is a sequence diagram showing the flow of data processing system processing in Example 2; and

FIG. 14 is a sequence diagram showing the flow of data processing system processing in Application Example 2.

### DETAILED DESCRIPTION

Description follows regarding an example of exemplary embodiments of a system according to technology disclosed herein, with reference to the appended drawings.

First, explanation follows regarding terminology employed in the following description.

In the following exemplary embodiments, a reference-numeral-appended processor (hereinafter simply referred to as “processor”) may be implemented by a single computation unit, and may be implemented by a combination of plural computation units. The processor may be implemented by a single type of computation unit, or may be implemented by a combination of plural types of computation units. Examples of computation unit include a central processing unit (CPU), a graphics processing unit (GPU), a general-purpose computing on graphics processing units (GPGPU), an accelerated processing unit (APU), and the like.

In the following exemplary embodiments, random access memory (RAM) appended with a reference numeral is memory temporarily stored with information, and is employed as working memory by a processor.

In the following exemplary embodiments, reference-numeral-appended storage is a single or plural non-volatile storage devices for storing various programs and various parameters and the like. Examples of non-volatile storage devices include flash memory (such as a solid state drive (SSD)), a magnetic disk (for example, a hard disk), magnetic tape, and the like.

In the following exemplary embodiments, a reference-numeral-appended communication interface (I/F) is an interface including a communication processor and an antenna or the like. The communication I/F has the role of communicating between plural computers. An example of a communication standard applied for the communication I/F is a wireless communication standard, such as a Fifth Generation Mobile Communication System (5G), Wi-Fi (registered trademark), Bluetooth (registered trademark), and the like.

In the following exemplary embodiments “A and/or B” has the same definition as “at least one out of A or B”. Namely, “A and/or B” may mean A alone, may mean B alone, or may mean a combination of A and B. Moreover, similar logic to “A and/or B” is applied when “and/or” is employed to link three or more items in the present specification.

### First Exemplary Embodiment

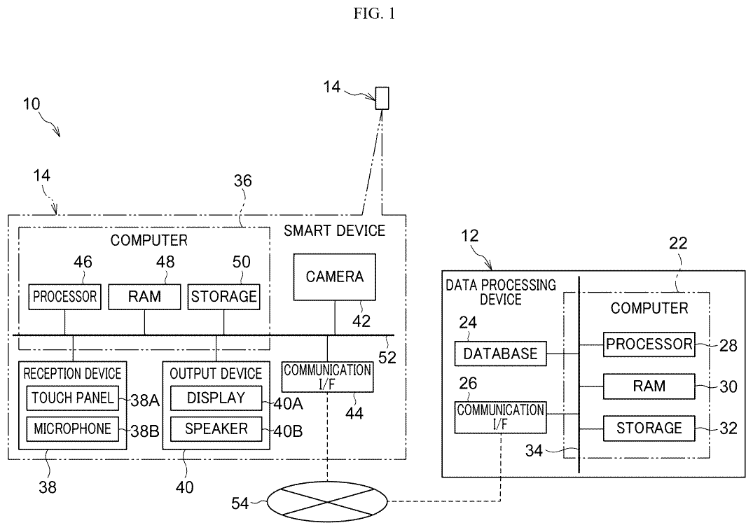

FIG. 1 illustrates an example of a configuration of a data processing system 10 according to a first exemplary embodiment.

As illustrated in FIG. 1, the data processing system 10 includes a data processing device 12 and a smart device 14. A server is an example of the data processing device 12.

The data processing device 12 includes a computer 22, a database 24, and a communication I/F 26. The computer 22 is an example of a “computer” according to technology disclosed herein. The computer 22 includes a processor 28, RAM 30, and storage 32. The processor 28, the RAM 30, and the storage 32 are connected to a bus 34. The database 24 and the communication I/F 26 are also connected to the bus 34. The communication I/F 26 is connected to a network 54. Examples of the network 54 include a Wide Area Network (WAN) and/or a local area network (LAN).

The smart device 14 includes a computer 36, a reception device 38, an output device 40, a camera 42, and a communication I/F 44. The computer 36 includes a processor 46, RAM 48, and storage 50. The processor 46, the RAM 48, and the storage 50 are connected to a bus 52. The reception device 38, the output device 40, the camera 42, and the communication I/F 44 are also connected to the bus 52.

The reception device 38 includes a touch panel 38A, a microphone 38B, and the like for receiving user input. The touch panel 38A receives user input from contact of a pointer (for example, a pen, a finger, or the like) by detecting contact of the pointer. The microphone 38B receives spoken user input by detecting speech of the user. A control unit 46A in the processor 46 transmits data representing the user input received by the touch panel 38A and the microphone 38B to the data processing device 12. A specific processing unit 290 in the data processing device 12 acquires the data indicating the user input.

The output device 40 includes a display 40A, a speaker 40B, and the like for presenting data to a user 20 by outputting the data in an expression format perceivable by the user 20 (for example, audio and/or text). The display 40A displays visual information such as text, images, or the like under instruction from the processor 46. The speaker 40B outputs audio under instruction from the processor 46. The camera 42 is a compact digital camera installed with an optical system such as a lens, an aperture, a shutter, and the like, and with an imaging device such as a complementary metal-oxide semiconductor (CMOS) image sensor or a charge coupled device (CCD) image sensor or the like.

The communication I/F 44 is connected to the network 54. The communication I/F 44 and the communication I/F 26 perform the role of exchanging various information between the processor 46 and the processor 28 over the network 54.

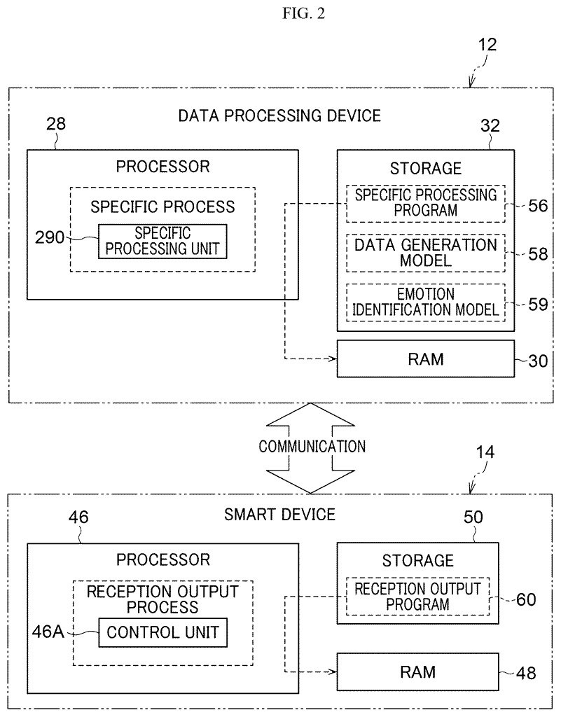

FIG. 2 illustrates an example of relevant functions of the data processing device 12 and the smart device 14.

As illustrated in FIG. 2, specific processing is performed by the processor 28 in the data processing device 12. A specific processing program 56 is stored in the storage 32. The specific processing program 56 is an example of a “program” according to technology disclosed herein. The processor 28 reads the specific processing program 56 from the storage 32, and in the RAM 30 executes the read specific processing program 56. The specific processing is implemented by the processor 28 operating as the specific processing unit 290 according to the specific processing program 56 executed in the RAM 30.

A data generation model 58 and an emotion identification model 59 are stored in the storage 32. The data generation model 58 and the emotion identification model 59 are employed by the specific processing unit 290. The specific processing unit 290 uses the emotion identification model 59 to estimate an emotion of a user, and is able to perform the specific processing using the user emotion. In an emotion estimation function (emotion identification function) that uses the emotion identification model 59, various estimations, predictions, and the like are performed related to emotions of the user, include estimating and predicting the emotion of the user, however, there is no limitation to such examples. Moreover, estimation and prediction of emotion also includes, for example, analyzing (parsing) emotions and the like.

Reception and output processing is performed by the processor 46 in the smart device 14. A reception and output program 60 is stored in the storage 50. The reception and output program 60 is employed by the data processing system 10 in combination with the specific processing program 56. The processor 46 reads the reception and output program 60 from the storage 50, and in the RAM 48 executes the read reception and output program 60. The reception and output processing is implemented by the processor 46 operating as the control unit 46A according to the reception and output program 60 executed in the RAM 48. Note that a configuration may be adopted in which a similar data generation model and emotion identification model to the data generation model 58 and the emotion identification model 59 are included in the smart device 14, and these models are used to perform similar processing to the specific processing unit 290. The reception and output program is implemented by the processor 46 operating as the control unit 46A according to the reception and output program 60 executed in the RAM 48.

Note that devices other than the data processing device 12 may include the data generation model 58. For example, a server device (for example, a generation server) may include the data generation model 58. In such cases, the data processing device 12 performs communication with the server device including the data generation model 58 to obtain a processing result (prediction result or the like) obtained using the data generation model 58. The data processing device 12 may be a server device, and may be a terminal device owned by the user (for example, a mobile phone, a robot, a home electrical appliance, or the like). Next, description follows regarding an example of processing by the data processing system 10 according to the first exemplary embodiment.

### Example 1

Description follows regarding a flow of the specific processing in an Example 1. The units of the system described below are implemented by the data processing device 12 and the smart device 14. The data processing device 12 is called a “server” and the smart device 14 is called a “terminal”.

Conventional tax support systems generally rely on rigid rule engines and static user interfaces that require users to manually input structured data into predetermined fields. These systems typically cannot robustly handle natural language input, particularly free-form text and voice input, without substantial manual preprocessing by the user. As a result, the underlying computing resources are underutilized, and the overall data processing pipeline is fragmented across multiple loosely integrated components, leading to inefficiencies in data ingestion, analysis, and response generation.

Furthermore, when generative AI models are used merely as downstream text generators, existing systems generally pass raw or minimally processed user text directly to a model, receive a natural language response, and display it to the user without deep integration into the system's internal data structures. Such usage fails to exploit the model as part of an end-to-end computational workflow. In particular, conventional approaches do not establish a closed-loop processing architecture in which user input, intermediate structured tax information, model prompts, model outputs, and user feedback are coherently managed, validated, and iteratively refined by computer-executable logic. This results in inconsistent tax strategies, difficulties in tracking the evolution of advice over multiple interactions, and an inability to reliably generate machine-readable tax return data suitable for electronic filing.

Additionally, in many existing architectures, the handling of voice input, text normalization, natural language understanding, prompt construction, and tax return document generation are implemented as separate, loosely coupled utilities. This leads to redundant parsing, ad hoc data conversions, and increased latency. The processor is often forced to perform repeated transformations of similar information in different modules, which degrades computational efficiency and makes it difficult to maintain data integrity across the pipeline from raw user input to finalized tax return data.

Moreover, conventional systems do not effectively exploit conversation history and user feedback for dynamically refining prompts to a generative AI model. Without explicit mechanisms to associate prior structured tax information, previously generated strategies, and user feedback into a unified context representation, the model is repeatedly invoked with incomplete or inconsistent context, which leads to lower-quality outputs and requires more manual correction by users. From a computing standpoint, this leads to inefficient resource usage on both the application server and the AI inference infrastructure.

Accordingly, there is a need for an improved computer-implemented system that: (i) unifies audio input processing, natural language processing, structured tax information generation, and tax strategy generation within a single coherent processing architecture; (ii) programmatically constructs and updates prompt sentences to a generative AI model based on validated structured data and conversation context; and (iii) automatically produces electronic tax return data by mapping structured tax information and model-derived strategy information into an authority-prescribed data format. Such a system should improve the efficiency, reliability, and repeatability of the underlying computer operations, reduce redundant parsing and data transformations, and enhance the integration between natural language interfaces and machine-readable tax document generation.

The specific processing by the specific processing unit 290 of the data processing device 12 in Example 1 is realized by the following means.

The present invention provides a server comprising a processor, a storage device, a communication interface, and an input/output interface, the processor being configured to execute computer-readable instructions to implement an integrated pipeline that (i) receives user authentication information, tax-related audio data or character data, and feedback information from a user terminal via the communication interface; (ii) converts audio data into character string data by invoking a speech recognition processing apparatus and records both raw and converted data in designated storage regions of the storage device; (iii) applies a natural language processing algorithm to the character string data or the character data to perform preprocessing, part-of-speech analysis, named entity recognition, and structuring, thereby generating structured tax information including income information, deduction information, taxation period information, and other tax-related elements, and storing the structured tax information in a structured tax information storage region; (iv) validates and complements the structured tax information by detecting missing or conflicting items and referencing auxiliary information including tax rate information and deduction limit information stored in an auxiliary information storage region; (v) programmatically constructs a prompt sentence for input to a generative AI model based on the structured tax information, user inquiry content, and dialogue context information derived from previously stored structured tax information, tax strategy information, and user feedback, and transmits the prompt sentence and generation parameters to a generative AI model execution apparatus via the communication interface; (vi) acquires a response text including at least one candidate tax strategy from the generative AI model execution apparatus, post-processes the response text using at least one of rule-based determination processing and additional natural language processing to reconstruct tax strategy information including summary information, execution procedure information, required document information, and cautionary risk information, and stores the tax strategy information in a tax strategy storage region of the storage device; (vii) iteratively updates the structured tax information and the tax strategy information based on subsequent feedback information received from the user and, in response, generates and transmits updated prompt sentences to the generative AI model execution apparatus to obtain updated tax strategy information; and (viii) automatically generates tax return data by mapping income information, deduction information, and tax credit information contained in the structured tax information and the tax strategy information to items defined by an item mapping rule corresponding to an electronic filing data format prescribed by a tax authority, thereby creating declaration document data as an electronic file or print file. This enables a computer-centric improvement in that the server realizes a tightly integrated, feedback-driven processing architecture in which natural language input, generative AI model interaction, structured data management, and electronic tax document generation are coherently orchestrated at the processor level, reducing redundant parsing and data transformations, improving consistency and traceability of tax strategy computation, and enhancing the efficiency and reliability of generating machine-readable tax return data suitable for electronic filing.

The term “server” refers to a computing apparatus including at least one processor, a storage device, and a communication interface, configured to execute programs that implement the tax-support functions described herein and to communicate with one or more user terminals over a network.

The term “processor” refers to a hardware processing unit or a set of hardware processing units, such as a central processing unit or an arithmetic processing unit, configured to execute machine-readable instructions to perform the functions described in the present disclosure.

The term “storage device” refers to a non-transitory computer-readable medium, such as a semiconductor memory, magnetic storage, or optical storage, configured to store programs, data structures, and intermediate processing results used by the processor.

The term “communication interface” refers to a hardware and software interface, such as a network interface controller and communication stack, configured to enable data transmission and reception between the server and external devices, including user terminals and external processing apparatuses.

The term “input/output interface” refers to a functional interface, including hardware and software components, configured to control input and output operations for presenting information to a user and receiving user operations, including by way of a graphical user interface or other interactive interface.

The term “user terminal” refers to an electronic device operated by a user, such as a general-purpose computing device or mobile device, configured to exchange data with the server and to present information to the user.

The term “authentication information” refers to information used to verify the identity of a user, such as a user identifier, password, token, or equivalent credential.

The term “session information” refers to data representing an authenticated interaction state between the server and a user terminal, including at least an identifier used to associate multiple requests with a single authenticated user.

The term “tax-related information” refers to information concerning a user's tax situation, including but not limited to income information, deduction information, taxation period information, tax credit information, and other elements relevant to tax computation and filing.

The term “audio data” refers to digitized sound signals representing spoken input from a user, encoded in any suitable audio format.

The term “character data” refers to textual information composed of characters, symbols, or numerals, including text entered directly by a user or text obtained by converting audio data.

The term “processing history storage region” refers to a logical area within the storage device configured to store raw and intermediate data relating to input, analysis, and generation processes performed by the server.

The term “speech recognition processing apparatus” refers to a processing resource, including hardware and software components, configured to convert audio data representing spoken language into character string data.

The term “character string data” refers to text data obtained by converting audio data through speech recognition, expressed as a sequence of characters suitable for natural language processing.

The term “natural language processing algorithm” refers to one or more software routines or models configured to analyze and transform human language text, including but not limited to preprocessing, part-of-speech analysis, named entity recognition, and structural analysis.

The term “structured tax information” refers to tax-related information that has been extracted and organized into a predefined data structure, such as a record or object, including fields for income information, deduction information, taxation period information, and other tax-related elements.

The term “structured tax information storage region” refers to a logical area within the storage device configured to store structured tax information for one or more users.

The term “income information” refers to data elements representing monetary amounts and categories of income received by a user, including employment income, business income, and other income types.

The term “deduction information” refers to data elements representing monetary amounts and categories of deductible expenses, allowances, or other items that reduce taxable income for a user.

The term “taxation period information” refers to data elements indicating a period to which tax calculations apply, such as a tax year or tax assessment period.

The term “auxiliary information” refers to reference data used to validate or complement structured tax information, including at least tax rate information and deduction limit information, and optionally other tax-related reference parameters.

The term “auxiliary information storage region” refers to a logical area within the storage device configured to store auxiliary information used by validation and completion processes.

The term “consistency validation” refers to a processing operation in which structured tax information is checked for missing items, conflicting values, logical inconsistencies, or violations of predetermined rules.

The term “prompt sentence” refers to a text sequence or text block constructed programmatically by the processor and provided as input to a generative AI model, the text including at least role description information, contextual information, and user inquiry content.

The term “generative AI model” refers to a machine learning model, such as a neural network-based language model, configured to generate text or other content based on an input prompt sentence and generation parameters.

The term “generative AI model execution apparatus” refers to a processing resource, including hardware and software components, configured to perform inference using the generative AI model upon receiving a prompt sentence and to output a response text.

The term “generation parameters” refers to control values provided together with a prompt sentence to the generative AI model, such as parameters for controlling output length, variability, style, or other generation behaviors.

The term “response text” refers to text data output from the generative AI model in response to a prompt sentence, including at least one candidate for a tax strategy.

The term “tax strategy information” refers to information derived from the response text and post-processed by the processor, including summary information, execution procedure information, required document information, cautionary risk information, and other structured or semi-structured elements indicating how a user should act with respect to taxes.

The term “tax strategy storage region” refers to a logical area within the storage device configured to store tax strategy information for one or more users.

The term “interactive interface” refers to a user interface that allows bidirectional communication between the user and the system, including the display of tax strategy information and the input of user feedback.

The term “feedback information” refers to information provided by a user in response to presented tax strategy information, including clarifications, corrections, preferences, or additional tax-related facts.

The term “dialogue context information” refers to information representing a history and state of interactions between the user and the system, including prior structured tax information, prior tax strategy information, and feedback information, used to provide contextual input to the generative AI model.

The term “updated prompt sentence” refers to a prompt sentence that has been modified or newly constructed based on updated structured tax information, updated tax strategy information, and dialogue context information for subsequent input to the generative AI model.

The term “updated tax strategy information” refers to tax strategy information newly obtained from the generative AI model based on an updated prompt sentence and reflecting changes derived from user feedback or newly acquired tax-related information.

The term “declaration data structure” refers to a structured representation of tax return content, defined in accordance with a predetermined declaration form definition and suitable for transformation into a machine-readable or human-readable tax return document.

The term “declaration form definition” refers to a specification of fields, formats, and relationships that define a tax return form as prescribed by a tax authority or other regulatory body.

The term “declaration document generation apparatus” refers to a processing resource, including hardware and software components, configured to generate tax return data or declaration document data based on a declaration data structure.

The term “tax return data” refers to data representing the contents of a tax return, including income information, deduction information, tax credit information, and other tax elements, generated in a form suitable for storage, transmission, or document generation.

The term “declaration data storage region” refers to a logical area within the storage device configured to store tax return data or declaration document data generated by the server.

The term “item mapping rule” refers to a set of rules defining how items within the structured tax information and tax strategy information are mapped to corresponding fields of an electronic filing data format prescribed by a tax authority.

The term “electronic filing data format” refers to a data format, such as a structured text format or structured markup format, defined by a tax authority for the electronic submission of tax returns.

The term “declaration document data” refers to a data set generated from the declaration data structure according to an item mapping rule and configured to be output as an electronic file or as a print file representing a tax return.

In one embodiment, a server cooperates with one or more terminals to implement a tax-support system that executes a sequence of computer-implemented operations on tax-related data, natural language input, and model-generated output. The server includes at least one processor, a main memory, a non-volatile storage device, a communication interface, and an input/output interface. The terminal includes a processor, a memory, a display device, an audio input device, a network interface, and a user input device such as a keyboard or touch panel.

The server executes an operating system such as a general-purpose server operating system and a web application framework such as an HTTP application framework. The server also executes a natural language processing library such as a tokenization and tagging library, an entity recognition library, and, in some implementations, a transformer-based encoder module. The server further executes a speech recognition engine, such as a model corresponding to a sequence-to-sequence neural network, either locally or by invoking an external speech-to-text service via the communication interface. The server additionally invokes a generative AI model, such as a large-scale neural network language model, using a model execution environment that may run on a graphics processing unit.

The terminal executes a web browser or a dedicated application that provides a graphical user interface. The terminal captures user operations, including keyboard entry and voice input, and transmits corresponding data to the server via a secure communication protocol. The terminal renders tax strategy information, intermediate status notifications, and generated tax return documents received from the server.

The server uses a storage device to maintain multiple logical regions, including an authentication information storage region, a session information region, a processing history storage region, a structured tax information storage region, an auxiliary information storage region, a tax strategy storage region, and a declaration data storage region. Each region is implemented as a set of records in a relational database or a structured document store, with explicit schemas defined for each type of data. For example, the structured tax information storage region stores records that include fields such as user identifier, tax year, income entries, deduction entries, tax credit entries, and validation status flags.

The server uses a particular internal data structure to represent structured tax information. In one embodiment, the server stores income information as a list of entries, each entry including an income type code, a numeric amount represented as a fixed-point decimal value, a currency code, and a source category. The server stores deduction information as a list of entries, each entry including a deduction type code, an amount value, a legal reference code, and flags indicating whether the deduction has been validated and whether supporting documents are required. The server stores taxation period information as a structure including a start date, an end date, and a tax regime identifier.

The server uses an auxiliary information storage region to store tax rate tables, deduction limit tables, and mapping rules for converting structured tax information into an electronic filing data format. Each tax rate table entry includes a threshold value, a rate value, and a taxation regime identifier. Each deduction limit entry includes a deduction type code, a maximum allowable amount or formula, and a set of conditions represented as machine-readable predicates.

The server uses a natural language processing pipeline to convert free-form user input into structured tax information. The server performs tokenization by splitting input text into lexical units using a deterministic finite automaton and a dictionary of known terms. The server applies part-of-speech tagging using a statistical sequence model, such as a conditional random field or a recurrent neural network, trained on domain-specific text. The server performs named entity recognition using a neural network model that takes token embeddings as input and outputs entity labels for each token, with labels such as income amount, deduction category, tax year, and person or organization roles.

The server performs a normalization operation on detected numeric terms. The server converts full-width numerals into half-width numerals, removes thousand separators, and converts expressions such as “7 million yen” or “700 man yen” into a numeric representation 7000000. The server converts different language expressions of the same deduction type, such as “medical expense deduction” and “healthcare cost deduction,” into a unified deduction type code, using a mapping table that associates surface forms with internal codes.

The server performs a consistency validation operation on structured tax information. The server compares each numeric field against range constraints stored in the auxiliary information storage region. For example, the server verifies that each income amount is non-negative and does not exceed a predetermined maximum threshold for a given income type and tax year. The server also applies rule-based conditions, such as verifying that a deduction type that requires income above a certain threshold is not applied when income is below that threshold. The server stores validation results, including error codes and warning codes, in the structured tax information record, which allows subsequent processing stages to detect incomplete or inconsistent data.

The server constructs a prompt sentence for a generative AI model based on structured tax information and the user's inquiry. The server generates a role description segment that instructs the model to behave as a tax advisor that adheres to specified constraints. The server generates a context segment that enumerates the user's income information, deduction information, and taxation period information in a concise and normalized textual format. The server generates a user inquiry segment that may be either the original user question or a normalized version.

In one example, the user enters the following prompt sentence at the terminal: “My income this year is 7,000,000 yen and I want to claim a medical expense deduction. How should I file my tax return?”

The terminal transmits this text to the server. The server normalizes the sentence, extracts the numeric value 7000000 as income, and identifies “medical expense deduction” as a specific deduction type. The server then constructs a composite prompt sentence of the following form: “You are a professional tax advisor. The user's annual income is 7,000,000 yen. The user wishes to claim a medical expense deduction under the applicable tax law for the current tax year.

Explain the eligibility conditions for the medical expense deduction, the method to calculate the deductible amount, the necessary supporting documents, and the step-by-step procedure to file the tax return. Provide concise and actionable instructions.”

In another example, the user enters the following prompt sentence:

“I am a freelancer with 5,500,000 yen in income and 1,200,000 yen in expenses. Please propose a tax-saving strategy within legal limits.”

The terminal sends this text to the server. The server identifies the income as business income, extracts 5500000 as income and 1200000 as expenses, and maps the user to a self-employed category. The server then constructs a prompt sentence such as:

“You are a professional tax advisor. The user is a self-employed individual with annual business income of 5,500,000 yen and business expenses of 1,200,000 yen for the current tax year.

Propose a tax-saving strategy within legal limits, including how to categorize expenses, how to utilize available deductions and tax credits, and any steps the user should take before the end of the tax year. Present the results as a numbered list of recommendations.”

The server sends the constructed prompt sentence and generation parameters, such as a token limit and a temperature parameter, to a generative AI model execution apparatus. The generative AI model is implemented as a transformer-based neural network language model including multiple self-attention layers, feed-forward layers, and layer normalization units. The model parameters consist of matrices of weights that are applied to token embeddings through attention computations. During inference, the model receives the tokenized prompt sentence as input and generates a sequence of output tokens by repeatedly computing attention distributions, applying softmax operations, and sampling or selecting the next token according to the configured generation parameters.

The server uses a dedicated GPU or a specialized hardware accelerator to execute the generative AI model, which reduces the time required for each inference compared to purely CPU-based execution. The server invokes the model using an interface that accepts arrays of token identifiers and returns arrays of token identifiers representing the generated text. The server decodes the output token identifiers into a response text string.

The server performs post-processing operations on the response text. The server uses rule-based patterns to segment the text into sections such as summary, prerequisites, steps, and cautions.

The server scans the text for numeric expressions and legal references and aligns them with the structured tax information fields. The server stores the post-processed tax strategy information in the tax strategy storage region with links to the corresponding structured tax information records.

The server uses a dialogue context representation to incorporate user feedback and prior interactions. The server maintains a dialogue context record that includes a list of previous user inputs, previous prompt sentences, previous model outputs, and structured tax information snapshots. When the user provides feedback, such as “You ignored my housing loan interest” or “I also have 300,000 yen of foreign dividend income,” the terminal sends this text or corresponding audio to the server. The server processes the feedback using the same natural language pipeline, updating the structured tax information by adding new income or deduction entries. The server updates the dialogue context record by appending the new feedback and the updated structured tax information.

The server reconstructs an updated prompt sentence that incorporates the dialogue context. For example, the server may generate a text of the form:

“Previously, you provided tax advice for a user with annual income of 7,000,000 yen and a medical expense deduction. The user now adds that they have a housing loan interest deduction and foreign dividend income of 300,000 yen. Revise your previous advice to incorporate these additional elements, update the calculation conditions, and clarify any changes in the recommended filing procedure.”

The server thereby ensures that the generative AI model receives a coherent and complete context rather than isolated prompts. This design reduces the need to re-parse and re-normalize redundant information at each conversational turn, improving both the computational efficiency and the consistency of generated strategies.

The server automatically generates tax return data from the structured tax information and the tax strategy information. The server applies item mapping rules that define the correspondence between internal data fields and fields of an electronic filing data format prescribed by a tax authority. For example, the server maps an income field representing “employment income” to a specific element in the authority's XML or structured text schema. The server maps each deduction entry to a corresponding field, using deduction type codes and legal reference codes to select the correct target field. The server then constructs a declaration data structure that satisfies all structural constraints defined by the declaration form definition, including hierarchical relationships and mandatory field sets.

The server uses a document generation module to convert the declaration data structure into a final tax return document. The server can generate an electronic file formatted according to an electronic filing protocol, or a print-ready file such as a page description file. The server stores the generated tax return data in the declaration data storage region and provides a reference to the terminal. The terminal allows the user to download, view, or print the generated document.

This system produces technical effects beyond simple automation of human tasks. The server reduces redundant parsing operations by centralizing natural language processing and by maintaining structured tax information and dialogue context across multiple interactions.

Because the server uses structured representations for tax data and maps them deterministically to an electronic filing format, the server reduces the likelihood of conversion errors and improves the reproducibility of tax return generation. The server improves processing speed by offloading computationally intensive neural network inference to specialized hardware and by organizing data into fixed schemas that support efficient indexing and retrieval.

The system also improves accuracy in tax strategy generation. The server enforces consistency checks and auxiliary information validation before constructing prompt sentences, thereby ensuring that the generative AI model receives cleaner and more coherent inputs. This reduces the probability of generating inconsistent or incorrect advice, compared to a baseline system that passes unvalidated free-form text directly to the model. The server's rule-based post-processing of model output further reduces errors by detecting and rectifying obvious contradictions with stored reference data.

The system departs from conventional human work patterns by applying non-intuitive, machine-centric rules for context construction and mapping. For example, the server aggregates multiple interaction steps into a compact context vector represented as a sequence of normalized textual summaries rather than full histories, and the server selectively includes only those elements that exceed certain relevance thresholds for prompt construction. These thresholds are computed using similarity measures between new input tokens and existing structured tax entities. This differs from typical human advisory workflows, where an advisor subjectively recalls or scans prior information without such algorithmic filtering.

The server applies a specific training and inference approach for the generative AI model in certain implementations. During training, the model minimizes a cross-entropy loss between predicted tokens and reference tokens over a large corpus of tax-related and financial text. The training process uses gradient-based optimization with backpropagation, updating model weights to reduce prediction error. The server or an associated training module may perform data augmentation by introducing paraphrased variants of prompts and responses, generated by rule-based synonym substitution and minor syntactic variation, to enhance the model's robustness to diverse user inputs. During inference, the server sets generation parameters such as temperature and top-k sampling to balance determinism and diversity, and the server may apply a repetition penalty to discourage the model from repeating phrases.

The system improves computer technology by defining and using specialized data structures, control flows, and validation operations that align natural language processing, generative model usage, and document generation in a unified computational framework. By using a structured tax information schema and item mapping rules, the server reduces the memory footprint associated with storing duplicate or unnormalized text strings and enables efficient indexing of tax entities across sessions. By using a dialogue context representation and updated prompt sentences, the server reduces network traffic to the generative AI model execution apparatus, because the server can reuse previously validated context elements rather than resending full transcripts.

In another embodiment, the server uses different types of generative AI models, such as smaller models for preliminary classification and larger models for detailed advice. The server may first invoke a classifier model to categorize the user's primary intent (for example, “deduction optimization,” “foreign income handling,” or “tax return review”), using a shallow neural network or a decision tree trained on labeled intents. The server then selects or configures a generative AI model specialized for that intent, thereby reducing overall computation and focusing higher-capacity models only on inputs that require detailed reasoning. This modular approach produces an additional technical effect of reducing the total number of tokens processed by large models, which directly decreases processing time and hardware resource usage.

In a further embodiment, the server locally hosts the generative AI model on a GPU-equipped machine, rather than relying on a remote model provider. In this embodiment, the server controls memory allocation for model weights, organizes prompt and response buffers in high-bandwidth memory, and uses batch processing to handle multiple users' prompts concurrently. The server thereby increases throughput and reduces average latency per request. The server can also apply quantization to model weights, reducing the precision from floating-point to lower-bit representations, which decreases memory usage and accelerates matrix multiplication operations while maintaining acceptable output quality for tax advice.

In yet another embodiment, the server supports multiple tax regimes and languages. The server stores separate auxiliary information sets for each jurisdiction and switches between them based on a jurisdiction identifier in the structured tax information. The server modifies the prompt sentence to include explicit jurisdiction indications and language constraints. The server thereby enables a single generative AI model architecture to support multiple regulatory environments, while controlling which tax rate tables and deduction limits are applied in consistency validation.

By organizing the system in this manner, the server, the terminal, and the associated data structures cooperate to produce concrete improvements in the way computers process and manage tax-related natural language input, model-based reasoning, and electronic document generation. The system reduces manual intervention, but more importantly, it restructures the underlying computation so that the processor performs fewer redundant transformations, uses specialized data schemas for tax information, orchestrates generative AI model interactions using algorithmically constructed prompt sentences, and generates machine-readable tax return data with higher speed and accuracy than conventional systems that merely automate human decision steps.

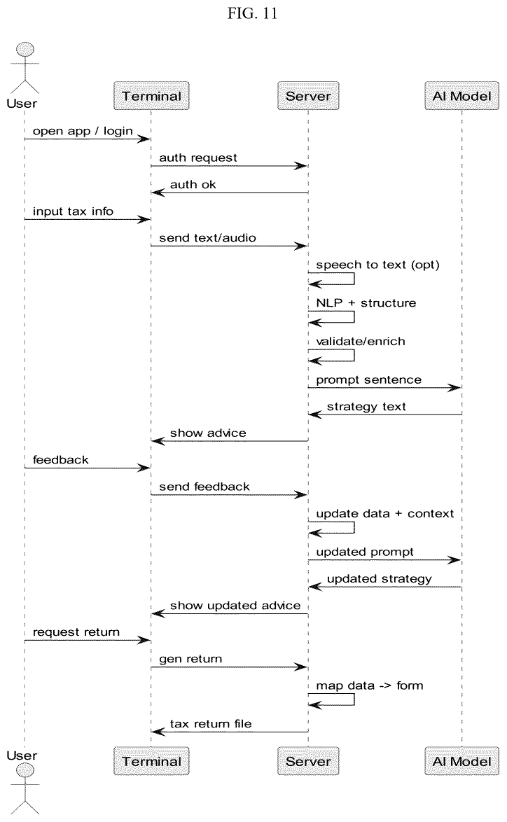

The following describes the processing flow using FIG. 11.

### Step 1

The user operates a terminal to start a tax-support session. The terminal displays a login or access screen and sends an access request to the server.

Input: A request from the terminal including at least a request type and device information.

Output: A response from the server containing a login screen definition or session start instructions, rendered on the terminal display.

### Step 2

The user enters authentication information such as a user identifier and a password on the terminal. The terminal attaches the entered credentials to a login request and transmits the login request to the server over a secure channel.

Input: User authentication information entered via keyboard or touch input (user ID, password, optional second factor).

Output: A formatted login request message transmitted from the terminal to the server, including the authentication information in a predefined data structure.

### Step 3

The server receives the login request and validates the authentication information. The server compares the received user identifier and password hash with stored authentication records in the storage device. If the values match, the server generates session information such as a session identifier and expiration time.

Input: Login request containing a user identifier and an authentication secret value.

Output: Either (i) session information stored in a session table and a success response to the terminal, or (ii) an authentication failure response if validation fails.

### Step 4

The terminal receives the authentication response from the server. If authentication is successful, the terminal stores a session token in a secure storage area and initializes a user interface for tax support, such as a menu or chat screen.

Input: Authentication result (success/failure) and, in case of success, a session token provided by the server.

Output: A local session state on the terminal, including the stored session token and a displayed main screen for tax-related operations.

### Step 5

The user selects a tax-support function (for example, consultation or strategy generation) and provides tax-related input in natural language. The user either enters text using the terminal's input interface or speaks into a microphone. The terminal captures the input as character data or audio data and associates it with the active session.

Input: User's natural language content describing income, deductions, and questions (text or speech).

Output: A structured request message including either text data or encoded audio data, plus session information, sent from the terminal to the server.

### Step 6

The server receives the tax-related request from the terminal and stores the raw payload in a processing history storage region. The server inspects a flag or header indicating whether the input is audio or text.

Input: Tax-related request message containing raw user input and session information.

Output: A stored record of raw input data and a classification of the input type (audio or text) for further processing.

### Step 7

When the input is audio, the server invokes a speech recognition processing apparatus. The server passes the encoded audio samples to the apparatus, which executes an acoustic model and language model to convert waveforms into character sequences. The server receives the recognized character string data and stores it as part of the processing history.

Input: Encoded audio data representing the user's speech.

Output: Character string data representing the transcribed user input, stored and marked as ready for natural language processing.

### Step 8

The server performs text normalization on the character data. The server converts full-width characters to half-width characters, replaces locale-specific numerals with standardized digits, removes extraneous whitespace, and normalizes currency expressions into a canonical form.

Input: Raw or transcribed text string containing user tax-related statements.

Output: A cleaned and normalized text string suitable for tokenization and subsequent analysis.

### Step 9

The server applies a natural language processing algorithm to the normalized text. The server performs tokenization, part-of-speech tagging, and named entity recognition using trained models. The server identifies numeric expressions, income types, deduction categories, tax years, and other tax-related entities based on token labels and contextual patterns.

Input: Normalized text string from the previous step.

Output: A sequence of tokens annotated with part-of-speech tags and entity labels, forming an intermediate linguistic representation.

### Step 10

The server converts the annotated token sequence into structured tax information. The server groups related entities into records, such as income entries and deduction entries, and assigns each record a code, numeric amount, and associated attributes. The server stores the structured records in a structured tax information storage region.

Input: Token-level annotations including entity types and spans.

Output: Structured tax information represented as organized records (for example, lists of income and deduction entries) linked to the user's session and identifier.

### Step 11

The server performs consistency validation on the structured tax information. The server compares each field against constraints stored in the auxiliary information storage region, such as valid ranges and compatibility rules. When missing or conflicting items are detected, the server marks corresponding fields with error or warning flags.

Input: Structured tax information records and auxiliary reference data (tax rate tables, deduction limits, rules).

Output: Validated structured tax information with additional flags indicating errors, warnings, and completion status.

### Step 12

The server complements incomplete structured tax information using auxiliary information. For instance, when a tax year is omitted but can be inferred from the current date or session settings, the server populates the missing field. The server also calculates derived values, such as total income or aggregate deduction amounts, by summing individual entries.

Input: Validated structured tax information with potential gaps and auxiliary reference data.

Output: Completed structured tax information with inferred values and calculated totals ready for use in prompt construction and strategy generation.

### Step 13

The server generates a prompt sentence for a generative AI model. The server constructs a text that includes a role description, a formatted summary of the structured tax information, and the user's inquiry or objective. The server may also include explicit instructions about level of detail, output structure, and legal constraints.

Input: Completed structured tax information and user inquiry content.

Output: A prompt sentence or prompt text block prepared for input to the generative AI model, stored and optionally logged for traceability.

### Step 14

The server sends the prompt sentence and generation parameters to a generative AI model execution apparatus. The server converts the textual prompt into token identifiers and passes them, together with configuration parameters such as maximum token count and sampling settings, to the model. The execution apparatus performs neural network inference to generate a token sequence.

Input: Prompt sentence, tokenization rules, and generation parameters.

Output: A sequence of output token identifiers generated by the generative AI model, which the server then decodes into a response text string.

### Step 15

The server decodes the generated tokens into a response text and performs post-processing. The server searches for structural markers such as numbered lists or headings, segments the text into sections (summary, steps, required documents, cautions), and aligns any numeric or legal references with internal fields. The server stores the resulting tax strategy information in the tax strategy storage region.

Input: Token sequence from the generative AI model and decoding vocabulary.

Output: Human-readable tax strategy information, structured internally with section boundaries and associated metadata.

### Step 16

The server prepares a response message for the terminal. The server embeds the tax strategy information, section titles, and any validation warnings in a message format understood by the terminal UI. The server may include identifiers for follow-up actions, such as generating a draft tax return or requesting more details.

Input: Structured tax strategy information and user/session identifiers.

Output: A formatted response message containing advice content and metadata, transmitted to the terminal over the communication interface.

### Step 17

The terminal receives the response message and renders the tax strategy for the user. The terminal parses section markers, displays summaries and step-by-step instructions, and highlights important figures and warnings. The terminal also displays input controls to allow the user to provide feedback or request additional explanations.

Input: Response message containing tax strategy information and display instructions.

Output: A rendered user interface on the terminal's display, including visible advice text and interactive elements for further interaction.

### Step 18

The user reviews the displayed advice and provides feedback or corrections. The user may type comments such as “I also have mortgage interest” or “I have foreign dividend income” or speak equivalent statements. The terminal captures this feedback as text or audio and associates it with the context of the previously displayed strategy.

Input: User-generated feedback content and a reference to the previous strategy instance.

Output: A feedback request message, including feedback text or audio and context identifiers, sent from the terminal to the server.

### Step 19

The server receives the feedback request and processes it using the same normalization and natural language processing pipeline used for the initial input. The server updates the structured tax information by adding or modifying records to reflect new income, deduction, or tax credit items indicated in the feedback. The server also updates a dialogue context record that maintains a history of interactions.

Input: Feedback text or transcribed feedback, plus existing structured tax information and dialogue context.

Output: Updated structured tax information and dialogue context with additional entities and revised values.

### Step 20

The server generates an updated prompt sentence that incorporates the dialogue context. The server summarizes prior advice, references newly added tax elements from the feedback, and instructs the generative AI model to revise or refine the previous strategy. The server constructs a new prompt text that explicitly indicates which aspects should be reconsidered.

Input: Updated structured tax information, dialogue context, and past tax strategy information.

Output: An updated prompt sentence that captures current and historical information for input to the generative AI model.

### Step 21

The server again invokes the generative AI model with the updated prompt sentence. The server performs the same tokenization, inference, decoding, and post-processing operations, but the content now reflects both original and feedback-derived conditions. The newly generated tax strategy information is stored as an updated version linked to the previous strategy.

Input: Updated prompt sentence and generation parameters.

Output: Updated tax strategy information that refines or extends the previous advice, stored and made available for further interaction.

### Step 22

When the user requests automatic tax return generation, the server retrieves finalized structured tax information and associated tax strategy information for the relevant taxation period. The server applies predetermined item mapping rules to assign each data field to a specific element in an electronic filing data format. The server composes a declaration data structure that satisfies the schema of the tax authority.

Input: Final structured tax information, final tax strategy information, and item mapping rules.

Output: A complete declaration data structure representing the contents of a tax return in an internal machine-readable form.

### Step 23

The server invokes a declaration document generation apparatus to create tax return data from the declaration data structure. The server converts internal fields into an electronic file format or a print-ready document, applying formatting rules and embedding numeric values in predefined positions. The server stores the resulting tax return data in the declaration data storage region and returns a reference or binary stream to the terminal.

Input: Declaration data structure conforming to the tax authority's format definition.

Output: Tax return data in an electronic filing format or print file, along with a reference for download or viewing on the terminal.

### Step 24

The terminal receives the generated tax return data and presents it to the user. The terminal may display a preview of the tax return form, allow the user to scroll through pages, and offer options to save, print, or export the document.

Input: Tax return data or a link to tax return data provided by the server.

Output: A visual representation of the tax return on the terminal and user-selectable operations for final handling of the document.

### Application Example 1

Description follows regarding a flow of the specific processing in an Application Example 1. The units of the system described below are implemented by the data processing device 12 and the smart device 14. The data processing device 12 is called a “server” and the smart device 14 is called a “terminal”.

Conventional computerized tax support systems primarily implement static rule engines and fixed form-based input screens. These systems typically require the user to manually categorize each transaction, to manually determine deductibility of expenses, and to repeatedly re-enter similar information when circumstances change. As a result, such systems tend to exhibit several technical problems.

First, existing systems do not efficiently integrate large volumes of heterogeneous electronic transaction history data originating from multiple external services, such as different electronic payment services and financial institutions. Each provider may expose transaction data in different formats, with inconsistent merchant descriptors and category codes. Traditional systems often process this data using rigid, manually designed mapping tables. This leads to frequent misclassification, a need for intensive manual maintenance of rules, and an inability to scale to new providers or changing data formats, thereby increasing processing latency and compute overhead in the server.

Second, when conventional systems apply rule-based classification and tax calculation logic, they typically execute the same static logic for all users and transactions, without adaptively updating processing behavior based on user feedback. Even if a user repeatedly corrects misclassified transactions (for example, classifying a specific merchant as non-deductible), such corrections are rarely fed back into the underlying processing pipeline or model behavior in a systematic manner. This causes redundant computation, repeated misclassifications, and unnecessary network and storage usage due to reprocessing the same data with ineffective rules.

Third, prior systems which attempt to incorporate machine learning or natural language processing often treat model invocation as an external, monolithic step. These approaches do not tightly integrate model prompts with structured tax and transaction data, and they do not maintain stateful, user-specific prompt generation strategies. As a consequence, model invocations may include redundant or poorly structured context, increasing token size, network bandwidth, and inference time, while still producing inconsistent or low-quality outputs for tax classification and deductibility determination.

Fourth, in conventional architectures, explanation generation for the user is typically performed as a separate, manually authored layer on top of underlying computation results. This disconnect between internal data structures and explanatory content can force the system to perform format conversions and ad hoc transformations, which increase CPU cycles, memory usage, and code complexity. It also hinders automated regeneration of explanation data when tax rules or transaction classifications are updated.

Additionally, conventional tax systems rarely provide a unified computation pipeline that: (i) collects taxation-related information through interactive user input, (ii) automatically acquires and pre-processes electronic transaction history data, (iii) coordinates a generative AI model via structured prompt sentences tied to normalized internal data, and (iv) iteratively refines both tax strategies and prompts using user feedback. The lack of such an integrated pipeline limits the system's ability to optimize both computational efficiency (e.g., reduced redundant processing, better caching of normalized data, and smaller, more effective prompt payloads) and output quality (e.g., more accurate classification and consistent deductibility decisions across sessions).

Accordingly, there is a need for a computer-implemented system and server-side processing architecture that technically improves the way tax-related data is acquired, normalized, analyzed, and utilized, by (1) coordinating structured data processing with generative AI model invocation through optimized prompt sentences, (2) adaptively updating classification and prompt generation rules based on user feedback, and (3) automatically generating both machine-usable strategy information and user-facing explanatory information in a unified processing pipeline.

Such a system should reduce computational redundancy, improve accuracy and consistency of tax-related classification and calculation, and enhance scalability when handling heterogeneous electronic transaction data from multiple external services.

The specific processing by the specific processing unit 290 of the data processing device 12 in Application Example 1 is realized by the following means.

The present invention provides a server comprising a processor configured to perform input/output processing to collect taxation-related information from a user through an interactive interface between a terminal and the server; to generate structured information including the taxation-related information and perform data processing to construct a prompt sentence including the structured information and to input the prompt sentence into a generative AI model; to acquire electronic transaction history data of the user by using a communication function of an electronic payment service or a financial service and perform data acquisition processing and pre-processing to normalize and classify the electronic transaction history data; to generate a prompt sentence for determining a classification and a deductibility for each transaction based on the electronic transaction history data and the taxation-related information and perform inference processing to input the prompt sentence into the generative AI model and obtain response data including transaction classification information and deductibility determination information; to aggregate the transaction classification information and the deductibility determination information and perform tax amount calculation processing to calculate a taxable amount and a deduction amount based on tax amount calculation rules and perform strategy generation processing to generate strategy information representing a tax burden reduction strategy; to convert the strategy information and explanation information generated by the generative AI model into a format viewable by the user, to transmit the converted information to the terminal, and to present the converted information as notification information by output processing; and to receive feedback information and transaction classification correction information from the user and perform strategy updating processing and prompt generation updating processing to update contents of the prompt sentence and the strategy information based on the feedback information and the transaction classification correction information. This enables an integrated, computer-implemented pipeline in which heterogeneous taxation-related data and electronic transaction history are normalized and efficiently processed, in which prompt sentences supplied to the generative AI model are dynamically constructed and refined using structured internal data and user feedback, and in which the server improves computational efficiency and accuracy of transaction classification, deductibility determination, tax amount calculation, and generation of user-facing explanatory information.

The term “processor” refers to one or more hardware computation units, such as central processing units or specialized processing circuitry, configured to execute instructions and perform the data processing, control, and communication operations described in the system.

The term “user” refers to an individual or an organization that interacts with the system via a terminal in order to provide taxation-related information, review analysis results, and supply feedback regarding tax classifications and strategies.

The term “terminal” refers to an information processing device, such as a mobile device, a portable computing device, or a stationary computing device, that executes an application or a browser and provides an interface through which the user exchanges data with the server.

The term “server” refers to an information processing apparatus, including at least the processor and associated memory and communication interfaces, that executes the processing operations for data acquisition, analysis, strategy generation, and communication with the terminal.

The term “taxation-related information” refers to information associated with tax computation and reporting for the user, including income information, expense information, deduction information, and tax-exempt information, which is provided by the user or derived from electronic transaction history.

The term “electronic transaction history data” refers to transaction records obtained from electronic payment services or financial services, each record including at least a transaction date, an amount, and counterparty information, and representing electronic payments or receipts made by the user.

The term “communication function of an electronic payment service or a financial service” refers to a network-accessible interface, such as an application programming interface, provided by a payment system or a financial institution, through which the server can request and receive electronic transaction history data.

The term “data acquisition processing” refers to processing performed by the processor to establish communication with external services, to transmit requests for electronic transaction history data, to receive responses, and to store the obtained data in storage in association with the user.

The term “pre-processing” refers to processing performed by the processor on raw taxation-related information or electronic transaction history data to normalize formats, remove inconsistencies, convert units or currencies, and prepare the data for subsequent classification and analysis.

The term “normalize” refers to converting data into a consistent internal representation, including standardizing date formats, numeric formats, textual encodings, and category labels, so that heterogeneous input data can be handled uniformly in subsequent processing.

The term “classify” refers to assigning one or more categories or labels to a data item, such as assigning a transaction to a particular expense type or deductibility type, based on rules, model outputs, or combined logic.

The term “generative AI model” refers to a machine-learned model that generates output data, such as text or structured information, in response to input data and instructions, and that is used by the server to perform tasks including classification, deductibility determination, and explanation generation.

The term “prompt sentence” refers to text data, optionally including structured representations of taxation-related information or transaction data, that is constructed by the processor and supplied as input to the generative AI model to cause the model to perform a specified processing task.

The term “inference processing” refers to processing performed by the processor to submit a prompt sentence and associated data to the generative AI model, to obtain model output such as classification results or generated text, and to interpret and store the output as structured response data.

The term “transaction classification information” refers to structured data indicating, for each transaction in the electronic transaction history data, a category, type, or classification label determined by the generative AI model, by rule-based logic, or by a combination of both.

The term “deductibility determination information” refers to structured data indicating, for each transaction or expense item, whether the item is considered deductible, non-deductible, or conditionally deductible under applicable tax rules, as determined by the generative AI model and tax calculation logic.

The term “tax amount calculation rules” refers to stored rule data, including tax brackets, deduction thresholds, rates, and other parameters, which are used by the processor to compute taxable amounts and deduction amounts from the classification information and the taxation-related information.

The term “tax amount calculation processing” refers to processing performed by the processor to compute a taxable amount and a deduction amount for the user based on the taxation-related information, the electronic transaction history data, the transaction classification information, the deductibility determination information, and the tax amount calculation rules.

The term “tax burden reduction strategy” refers to a set of recommendations, decisions, or configurations derived from the calculation of taxable amounts and deduction amounts, indicating actions or filing approaches that reduce the overall tax liability of the user within applicable tax rules.

The term “strategy information” refers to structured data representing the tax burden reduction strategy, including at least recommended deductions, categorizations, and suggested actions to be taken by the user when preparing or submitting tax-related documentation.

The term “explanation information” refers to narrative or structured explanatory content generated at least in part by the generative AI model, which explains transaction classifications, deductibility determinations, tax calculations, and tax burden reduction strategy to the user in human-readable form.

The term “notification information” refers to data transmitted from the server to the terminal and presented to the user, indicating availability of new or updated strategy information, explanation information, or other tax-related results, and including at least a summary or pointer to detailed content.

The term “feedback information” refers to information provided by the user through the terminal in response to the output of the system, including evaluations, confirmations, or comments regarding classification results, tax strategies, or explanatory content.

The term “transaction classification correction information” refers to data supplied by the user through the terminal that corrects or overrides automatically determined classifications or deductibility determinations for one or more transactions or items.

The term “strategy updating processing” refers to processing performed by the processor to modify previously generated strategy information based on new data, including feedback information, transaction classification correction information, updated electronic transaction history data, or updated tax amount calculation rules.

The term “prompt generation updating processing” refers to processing performed by the processor to modify or regenerate one or more prompt sentences supplied to the generative AI model, based on feedback information, transaction classification correction information, or updated classification rules, so that subsequent model inferences reflect user-specific constraints and preferences.

The term “classification rule” refers to a rule or rule set indicating how certain transactions, entities, or patterns in the data should be categorized or considered for deductibility, the rule being stored and applied by the processor during classification or prompt generation.

The term “transaction type” refers to a category of transactions sharing a common characteristic, such as a particular expense category, merchant group, or purpose, that is used as a basis for classification rules and deductibility determinations.

The term “transaction entity” refers to a party or counterparty associated with a transaction, such as a merchant, a service provider, or a payer, which may be used as a feature in classification rules and prompt generation.

The term “taxation-related documentation” refers to documents or electronic records used in a tax filing or reporting process, including tax returns, schedules, and supporting statements, whose items can be automatically populated or generated based on the taxable amount, the deduction amount, and the strategy information.

The term “description items of taxation-related documentation” refers to individual fields or entries of taxation-related documentation, such as income fields, deduction fields, and summary fields, that are filled or generated by the system using calculated values and classification results.

The term “explanatory text for the user” refers to natural language text generated at least partially by the generative AI model, which explains the contents of the taxation-related documentation, the basis for deductions, and the reasoning behind classifications and tax strategies.

In one embodiment, a server cooperates with one or more terminals operated by a user to implement a taxation support system that integrates structured data processing and a generative AI model. The server includes at least one processor, a memory, a non-volatile storage device, and a network interface. The processor executes a program stored in the memory and storage, the program being implemented for example on a general-purpose application server platform using an operating system, a web application framework, and a database management system.

The server operates on computing hardware such as a multi-core central processing unit and, in some embodiments, one or more graphics processing units or tensor processing units for accelerating neural network inference. The server connects to terminals and external services via a network using secure communication protocols. The terminal operates as an input/output device that presents user interfaces, captures user inputs, and exchanges structured messages with the server. The user operates the terminal to provide taxation-related information, review classification and calculation results, and supply feedback to refine future processing.

The server executes an application that manages taxation-related information. The server stores user-specific data in relational database tables, such as a user table, a tax_input table, a transaction raw table, a transaction processed table, a tax_summary table, and a feedback table.

The server uses a database management system to execute structured queries, manage indexes, and maintain data integrity. In one example, the server executes software modules implemented using a high-level programming language and a data analysis library to perform normalization, aggregation, and feature extraction over taxation-related information and electronic transaction history.

The terminal executes a client application or a web browser that communicates with the server using a request/response protocol. The terminal presents forms and interactive components that allow the user to input taxation-related information such as income, expense descriptions, deduction claims, and tax-exempt amounts. The terminal transmits user inputs as structured messages to the server, where the messages are encoded, for example, in a hierarchical data format. The terminal also receives structured responses from the server and renders text, tables, and graphical summaries, thereby enabling the user to understand tax burden reduction strategies generated by the system.

The server uses a generative AI model to perform content generation and classification tasks based on prompt sentences constructed from internal structured data. In one embodiment, the generative AI model is implemented as a transformer-based neural network with multiple layers of self-attention and feed-forward units. The model includes an input embedding layer that converts tokens into dense vectors, a positional encoding component, a stack of attention blocks with query, key, and value projections, and an output projection layer that produces token probabilities. The model parameters include weight matrices and bias vectors that are learned from training data through gradient-based optimization.

The server trains the generative AI model using a machine learning procedure executed on training hardware. The server prepares a training dataset that includes pairs of input prompt sentences and desired outputs. For transaction classification, the inputs include textual descriptors of transactions together with structured context such as categories, merchant descriptors, and example labels; the outputs include category labels and deductibility flags with rationales. For explanation generation, the inputs include structured summaries of taxable amounts, deduction amounts, and classification results; the outputs include natural language explanations. The server evaluates a loss function that combines cross-entropy loss for token prediction with additional penalty terms to encourage consistency in classification and deductibility decisions. The server updates model parameters using a stochastic gradient-based algorithm such as adaptive moment estimation, and may apply techniques such as learning rate scheduling, gradient clipping, and regularization to stabilize training.

The server performs fine-tuning of the generative AI model on domain-specific data related to taxation and electronic transactions. The server selects training examples from anonymized historical user sessions, where taxation-related information and transaction classification outcomes are known. The server may augment the training data by perturbing textual descriptors, changing numeric values within realistic ranges, or reordering items in structured lists, thereby improving model robustness. The server stores the fine-tuned model parameters and deploys the model on an inference engine running on specialized hardware.

The server constructs prompt sentences by integrating normalized taxation-related information and transaction features into textual prompts that are optimized for the generative AI model. The server uses template structures and rule-based formatting to ensure that important fields are presented in a consistent order and that extraneous data is excluded. By reducing prompt size and improving structure, the server reduces token length, decreases inference latency, and improves model output consistency.

In one embodiment, the server constructs a prompt sentence for analyzing transaction history as follows:

“Analyze the following electronic transaction history for this user. For each transaction, output JSON-like fields in plain text with: transaction_id, final_category (medical, business, education, personal), deductible_flag (true/false), and a brief reasoning. Use typical income tax rules to decide deductibility. Transactions: [list with date, merchant, amount, and preliminary category].”

In another embodiment, the server constructs a prompt sentence for strategy generation as follows:

“Given this user's total income, categorized deductible expenses, and tax-exempt income, generate a clear, step-by-step tax-saving strategy suitable for a non-expert. Highlight which deductions the user should claim and which documents or receipts they must keep. The data is: [summary of income, deduction categories with amounts, and thresholds].”

The server embeds structured data into such prompt sentences by converting numeric fields to formatted text and attaching concise labels. The server excludes irrelevant fields detected through feature selection logic, thereby reducing the dimensionality of the input to the generative AI model and lowering computational cost.

The server applies additional pre-processing and feature engineering to electronic transaction history data before constructing prompt sentences. The server normalizes merchant names by lowercase conversion, removal of punctuation, and mapping of variations to canonical forms stored in a mapping table. The server extracts features such as merchant category, time of transaction, frequency of merchant occurrence, and proximity to known tax-relevant periods. The server stores these features in a transaction processed table with fields for normalized merchant identifiers, inferred usage type, and candidate deductibility status.

The server combines rule-based classification with model-based classification to improve accuracy. The server defines classification rules that use merchant category codes, regular expressions on merchant descriptions, and thresholds on transaction amounts. When a rule has high confidence, the server assigns a preliminary category and a preliminary deductibility flag.

When confidence is ambiguous, the server flags the transaction for model-based refinement. The server then constructs prompt sentences that include both preliminary classification and relevant explanatory context for the ambiguous cases. This combined approach reduces the number of transactions that require full model inference, thereby improving processing throughput and reducing load on the generative AI model.

The server receives outputs from the generative AI model and parses them into structured records. The server uses text parsing logic and, in some embodiments, a restricted output format to extract fields such as final_category, deductible_flag, and reasoning. The server validates that the outputs conform to expected patterns and handles parsing errors by applying fallback logic or reissuing refined prompt sentences. The server writes the parsed results into database tables and indexes the records for fast retrieval.

The server computes taxable amounts and deduction amounts by applying tax amount calculation rules to the classification results. The server stores rule parameters such as thresholds and rates in rule tables, and loads them into memory as data structures when executing tax amount calculation logic. The server computes category-wise aggregates of deductible transactions and compares the sums to thresholds. The server computes intermediate tax metrics, including gross income, adjusted income, and taxable income, and then applies progressive tax rates to obtain an estimated tax amount. The server writes these computed values to a tax_summary table, where each row includes breakdowns by category and calculation steps.

The server generates a tax burden reduction strategy by applying both deterministic logic and generative AI-based narrative generation. The server determines which deductions are underused, which categories approach thresholds, and where specific documentation is needed.

The server then constructs a prompt sentence that summarizes these computed values and requests narrative advice. For example, the server may construct the following prompt sentence:

“Using the user's annual medical expense transactions and the applicable deduction threshold, generate a concise explanation that informs the user whether they can claim a medical expense deduction and what steps they should take to prepare their tax return. Base your explanation on: [total medical expenses, threshold amount, and classification rationale].”

The server receives the narrative explanation from the generative AI model, stores the explanation as explanation information, and connects it to the underlying numerical data. The server uses this linkage to regenerate updates whenever classifications or rule parameters change, without recomputing text from scratch in all cases. By caching partial results and reusing them, the server reduces CPU usage and network bandwidth required for repeated analyses.

The server collects feedback information and transaction classification correction information from the user via the terminal. The terminal presents user interfaces which allow the user to confirm or modify the classification of transactions, to mark transactions as deductible or non-deductible, and to comment on explanations. The server records these corrections and uses them to update classification rules. For example, the server associates a merchant identifier with a user-specific rule that indicates that all future transactions from this merchant are to be treated as personal, non-deductible expenses. The server updates a rule table and modifies future prompt sentences to include instructions such as “Treat all payments to this merchant as personal unless explicitly overridden.” This feedback loop improves future classification accuracy without requiring the user to repeat manual corrections.

The server utilizes user feedback to update prompt generation patterns. When the server observes that certain prompt sentence formulations lead to more stable and accurate outputs from the generative AI model, the server adjusts template structures accordingly. The server may, for example, reorder sections, add explicit requirements for output format, or emphasize constraints such as “Do not classify personal entertainment expenses as business expenses even if merchant categories are ambiguous.” This continual refinement of prompt sentences constitutes a programmatic improvement in model invocation logic, which leads to lower error rates, fewer ambiguous outputs, and reduced need for human review.

The server improves computer technology by optimizing data flows, reducing redundant computation, and enhancing model utilization. By performing normalization and feature extraction before model invocation, the server reduces input token counts and inference time, thereby permitting more efficient use of processing resources. By combining rule-based classification with model-based classification, the server limits expensive AI inference to cases that truly require contextual reasoning. By storing and reusing structured intermediate results, the server minimizes repeated analysis of unchanged data. As a consequence, the system processes large volumes of electronic transaction history data more quickly and with reduced memory and network usage compared to naive architectures that invoke a generative AI model on raw, unfiltered data.

The server also improves accuracy through specialized feature design and rule integration. By including domain-specific features such as merchant category, timing relative to known tax deadlines, and frequency patterns, the server supplies the generative AI model with richer, more discriminative information. This leads to more reliable classification outcomes and fewer misclassifications. The server quantifies accuracy improvements by comparing classification results against validated ground truth, thereby demonstrating that the combined data processing and prompt engineering approach yields lower error rates than conventional rule-only or model-only methods.

The server avoids merely automating human judgment by implementing algorithmic procedures that a human user would not practically perform. The server dynamically structures large volumes of data into optimized prompt sentences, uses learned patterns from large datasets not accessible to a single human, and executes iterative feedback-based adaptation of classification rules and prompt structures at machine speed. The server applies mathematically defined optimization procedures to tune model behavior and prompt content, which results in technical improvements in resource utilization and processing quality.

In alternative embodiments, the generative AI model is implemented as an encoder-decoder architecture or as a recurrent neural network, rather than a transformer-only model. The server can deploy a smaller model for devices with constrained resources or a larger model for servers with dedicated accelerators. The server may also use different learning objectives, such as multi-task losses that jointly train classification and explanation tasks, or contrastive losses that differentiate correct from incorrect deduction rationales. In another embodiment, the server employs a mixture-of-experts architecture where separate sub-models specialize in different transaction types, and the server selects appropriate experts based on meta-features of each transaction batch.

In still another embodiment, the server performs local inference on the terminal for certain lightweight tasks, while reserving heavy computations for the server. For example, the terminal may host a small model that performs preliminary classification of repeated transactions with simple patterns, while the server handles complex, ambiguous transactions that require more extensive reasoning. This configuration reduces network latency and balances computational load across devices.

In summary, the server and the terminal cooperate to execute a series of technical processing steps involving data acquisition, normalization, feature extraction, rule-based classification, generative AI-based refinement, tax amount calculation, strategy generation, explanation generation, and feedback-based adaptation. By structuring taxation-related data into optimized prompt sentences and by tightly integrating model outputs with internal rule-based logic, the system improves computational efficiency, accuracy, data management, and communication performance, thereby providing a concrete improvement in computer processing for tax-related analysis and reporting.

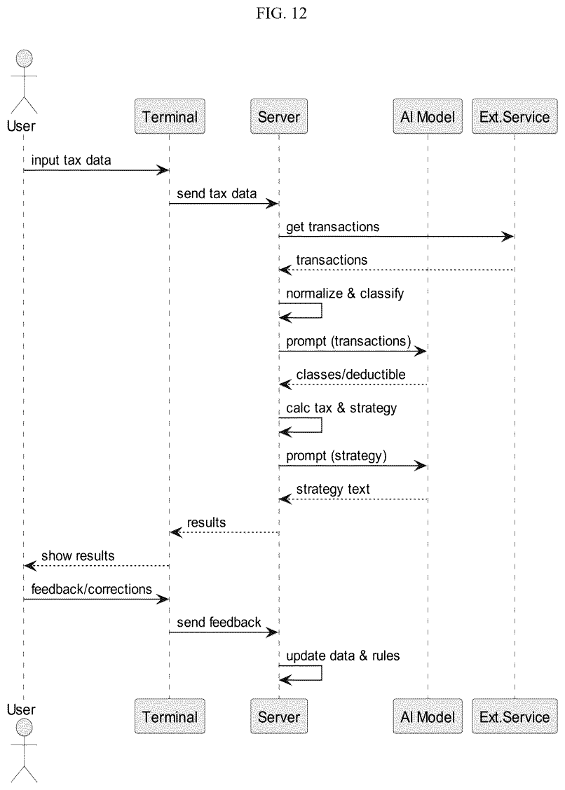

The following describes the processing flow using FIG. 12.

### Step 1

The user activates the tax-assistance application on the terminal.

The user inputs taxation-related information such as income amounts, expense descriptions, and potential deductions through forms or voice input.

The terminal receives raw input data (input: unstructured text, numeric values, optional voice data) and converts voice data to text using a speech recognition component, then validates required fields and formats.

The terminal outputs a structured message (output: a structured taxation-related information object) and prepares it for transmission to the server.

### Step 2

The terminal transmits the structured taxation-related information to the server.

The terminal packages the taxation-related information object into a request message, attaches authentication data, and sends it via a secure protocol to a defined server endpoint.

The input of this step is the structured taxation-related information object held by the terminal, and the output is a network request delivered to the server containing the same data in an encoded format.

### Step 3

The server receives and stores the taxation-related information.

The server parses the incoming request (input: encoded taxation-related information and user identifier), validates schema and data types, and writes the information into a database table associated with the user.

The server performs basic normalization, such as converting number formats and date formats, and outputs normalized taxation-related records (output: normalized taxation-related records stored in persistent storage).

### Step 4

The server acquires electronic transaction history data from external services.

The server reads configuration data for linked payment or financial services (input: user-linked service identifiers and access tokens) and issues API calls to each external service to obtain raw electronic transaction history.

The server receives responses containing transaction records, aggregates them across providers, and writes them into a raw transaction table (output: aggregated raw electronic transaction history data).

### Step 5

The server pre-processes and normalizes the electronic transaction history data.

The server takes the raw transaction records (input: raw electronic transaction history data), removes duplicates, standardizes date and currency formats, normalizes merchant names, and maps service-specific category codes to internal category labels.

The server produces a cleaned and normalized transaction dataset (output: normalized transaction records with standardized fields) that is stored in a processed transaction table.

### Step 6

The server performs initial rule-based classification of transactions.

The server retrieves normalized transaction records (input: normalized transaction records) and applies rule-based logic using stored classification rules, such as mapping specific merchant identifiers to medical, business, or personal categories.

The server assigns preliminary categories and confidence scores, and marks transactions that require model-based refinement.

The output of this step is a set of transaction records with preliminary categories and flags (output: preliminarily classified transaction records).

### Step 7

The server generates a first type of prompt sentence for classifying transactions with the generative AI model.

The server selects all or a subset of preliminarily classified transaction records (input: preliminarily classified transaction records and associated features), formats each record with date, merchant, amount, and preliminary category, and embeds them into a textual structure.

The server constructs a prompt sentence such as:

“Analyze the following electronic transaction history for this user. For each transaction, output: transaction_id, final_category (medical, business, education, personal), deductible_flag (true/false), and a brief reasoning. Use typical income tax rules to decide deductibility.

Transactions: [formatted list].”

The output of this step is a set of prompt sentences ready for submission to the generative AI model (output: transaction classification prompt sentences).

### Step 8

The server performs inference processing by sending the transaction classification prompt sentences to the generative AI model.

The server provides the prompt sentences and any required model parameters (input: transaction classification prompt sentences and model configuration) to an inference engine that hosts the generative AI model.

The generative AI model processes tokenized prompt text using its neural network architecture and generates output text containing final categories, deductibility flags, and reasoning for each transaction.

The server receives the textual response (output: transaction classification response text) for further parsing.

### Step 9

The server parses the response from the generative AI model and updates transaction records.

The server uses parsing logic to read the response text (input: transaction classification response text), extract transaction identifiers, final_category values, deductible_flag values, and reasoning strings, and validate that each transaction has a complete set of fields.

The server writes the extracted fields into the processed transaction table and stores reasoning text in a separate explanation table for later display.

The output of this step is a set of transaction records with final categories and deductibility determinations (output: fully classified transaction records with deductibility information).

### Step 10

The server generates structured data for tax amount calculation.

The server retrieves normalized taxation-related information and fully classified transaction records (input: normalized taxation-related records and fully classified transaction records) and groups transactions by category and deductibility status.

The server computes sums of deductible amounts in each category, such as medical, business, and education, and correlates them with user-provided expenses.

The output of this step is a structured summary of income, deductible expenses, and tax-exempt items (output: tax calculation input summary).

### Step 11

The server executes tax amount calculation based on stored rule data.

The server takes the tax calculation input summary and tax amount calculation rules (input: tax calculation input summary and tax amount calculation rules) and performs arithmetic operations to compute gross income, adjusted income, taxable income, and deduction components.

The server applies thresholds, caps, and rate schedules, performing comparisons and piecewise computations to determine deduction applicability and calculate an estimated tax amount.

The output of this step is a tax summary record with detailed breakdowns (output: tax summary record including taxable amount, deduction amount, and estimated tax).

### Step 12

The server generates a second type of prompt sentence for creating a tax burden reduction strategy.

The server reads the tax summary record and categorized deduction information (input: tax summary record and deduction breakdown details) and composes a textual prompt that includes key figures and constraints.

The server constructs a prompt sentence such as:

“Given this user's total income, categorized deductible expenses, and tax-exempt income, generate a clear, step-by-step tax-saving strategy suitable for a non-expert. Highlight which deductions the user should claim and which documents or receipts they must keep. Data: [summarized income and deduction information].”

The output of this step is a strategy-generation prompt sentence (output: tax strategy prompt sentence).

### Step 13

The server performs inference processing by sending the strategy-generation prompt sentence to the generative AI model.

The server supplies the prompt sentence to the generative AI model (input: tax strategy prompt sentence), receives token-by-token generated text from the model, and collects the complete narrative output.

The model output consists of sections such as overview, key deductions, and recommended actions.

The output of this step is a narrative strategy description (output: tax burden reduction strategy text).

### Step 14

The server post-processes the narrative strategy and links it to structured data.

The server takes the narrative strategy text and tax summary record (input: tax burden reduction strategy text and tax summary record) and segments the text into logical sections aligned with specific deduction categories and transaction groups.

The server may truncate or reorganize long sections, insert headings, and attach internal identifiers indicating which part of the tax summary each paragraph refers to.

The output of this step is explanation information that is both human-readable and linked to machine-usable records (output: structured explanation information).

### Step 15

The server prepares response data for display on the terminal.

The server collects explanation information, classified transaction lists, and the tax summary (input: structured explanation information, fully classified transaction records, and tax summary record) and assembles a response payload that includes summary metrics and detailed item lists.

The server formats numeric values, applies localization for currency and date display, and compresses the payload if necessary to reduce communication load.

The output of this step is a display-ready response message (output: formatted response payload sent to the terminal).

### Step 16

The terminal receives and displays the response payload.

The terminal parses the payload (input: formatted response payload), updates the user interface to show total income, total deductions, estimated tax, and the narrative strategy text, and renders transaction tables with final categories and deductibility flags.

The terminal allows the user to expand or collapse sections, tap individual transactions, and read the reasoning behind each deductibility decision.

The output of this step is a displayed user interface state (output: rendered tax analysis and strategy view on the terminal).

### Step 17

The user reviews and corrects classifications or provides feedback using the terminal.

The user inspects transaction details and narrative explanations (input: rendered tax analysis and strategy view) and may tap a transaction to change its category or deductibility status, or submit comments on the clarity or correctness of the strategy.

The terminal captures these corrections and comments and aggregates them into a feedback object.

The output of this step is user-generated feedback and correction data (output: feedback and transaction classification correction information).

### Step 18

The terminal transmits the feedback and correction data to the server.

The terminal takes the feedback object (input: feedback and transaction classification correction information), attaches user authentication data, and sends it to a dedicated feedback endpoint on the server.

The terminal ensures reliable delivery and may queue the data if the network connection is temporarily unavailable.

The output of this step is a server-directed feedback request (output: feedback request message).

### Step 19

The server updates classification records and strategy information based on feedback.

The server receives the feedback request (input: feedback request message), parses corrected categories, deductibility overrides, and user comments, and updates the corresponding transaction records in the database.

The server recalculates aggregated deduction amounts and, if necessary, recomputes the tax summary using updated classifications.

The output of this step is a revised set of transaction records and, optionally, an updated tax summary (output: updated classification and tax summary data).

### Step 20

The server updates classification rules and prompt generation patterns using the feedback.

The server uses the corrected transaction data and comments (input: updated classification and tax summary data plus feedback details) to infer user-specific or global adjustments to classification rules, such as permanently treating certain merchants as personal or business-related.

The server also modifies prompt templates by adding explicit instructions like “Treat all transactions from this merchant as personal unless explicitly overridden,” thereby adjusting how future prompt sentences are constructed.

The output of this step is an updated set of classification rules and prompt templates (output: revised rule set and prompt generation configuration).

### Step 21

The server stores updated rules and templates for subsequent processing cycles.

The server writes the revised classification rules and prompt template definitions (input: revised rule set and prompt generation configuration) into configuration tables or files and reloads relevant modules to apply the changes.

The server ensures that subsequent acquisition and analysis of electronic transaction history will utilize these updated rules and prompt structures, thereby reducing repeated misclassification and improving inference efficiency.

The output of this step is a persistent, updated processing configuration (output: stored configuration enabling improved future processing by the server).

It is also possible to incorporate an emotion engine for estimating the user's emotions.

That is, the specific processing unit 290 may estimate the user's emotions using an emotion identification model 59, and perform specific processing based on the estimated emotions.

### Example 2

Description follows regarding a flow of the specific processing in an Example 2. The units of the system described below are implemented by the data processing device 12 and the smart device 14. The data processing device 12 is called a “server” and the smart device 14 is called a “terminal”.

Conventional tax support systems that merely store financial data and apply static rule sets are insufficient to handle complex, user-specific optimization of tax-saving strategies. Such systems typically rely on fixed decision trees or manually encoded tax rules and therefore cannot flexibly adapt to diverse patterns in taxation-related information or to changes in user behavior over time. As a result, these systems often generate generic advice that does not fully exploit potential tax-saving opportunities and that fails to reflect evolving legal or factual contexts captured in large-scale data.

Further, in many existing architectures, data processing for tax optimization is implemented as an ad hoc sequence of scripts that perform inconsistent preprocessing, fragmented analysis, and manual scenario design. This fragmentation produces several technical problems: data inconsistency across modules, repeated and inefficient data transformation, redundant queries to storage systems, and difficulty in scaling the computation to large numbers of users. The lack of a unified data pipeline from structured storage through machine-learning prediction to natural-language explanation leads to high latency and resource waste when generating tax advice at scale.

Additionally, existing systems that incorporate machine-learning components often treat the learning models and the user-facing explanation layer as independent modules. Machine-learning predictions are not systematically transformed into multi-scenario simulations, and they are not tightly integrated with natural-language generation. As a result, the system cannot programmatically construct detailed prompt sentences that fully encode prediction outputs, simulation conditions, and explanation requirements. This deficiency limits the expressive power and accuracy of any generative artificial intelligence model used for explanation, and prevents the system from delivering technically coherent and data-grounded natural-language advice.

Moreover, conventional interfaces capture user feedback in an informal way, such as free-text comments or simple rating flags, without feeding that feedback back into the core computation pipeline. There is no standardized mechanism by which the system can use feedback to update selection criteria for candidate tax-saving strategies, adjust prompt construction rules, or systematically refine the utilization manner of the trained prediction model. Consequently, the system cannot automatically improve the technical quality of subsequent strategy generation, resulting in persistent mismatches between system outputs and user preferences or comprehension levels.

There is therefore a need for a computer-implemented system that (i) integrates relational database management, structured data preprocessing, and machine-learning-based prediction into a coherent technical pipeline, (ii) automatically generates and evaluates multiple tax-related simulation conditions via a trained prediction model, (iii) programmatically constructs prompt sentences that encode structured prediction results and constraints for consumption by a generative artificial intelligence model, and (iv) feeds user feedback back into the pipeline to dynamically adjust model utilization and prompt construction. Such a system should improve the efficiency, scalability, and technical accuracy of generating personalized tax-saving strategies, reduce redundant computation and data inconsistency, and enhance the quality and relevance of natural-language explanations delivered to users.

The specific processing by the specific processing unit 290 of the data processing device 12 in Example 2 is realized by the following means.

The present invention provides a server comprising a processor configured to execute instructions that cause the server to provide an input/output interface through which a user terminal interacts with the server to collect taxation-related information from a user, store the taxation-related information as structured information in a storage device by using a relational database management mechanism, read the stored taxation-related information and perform, by using data-processing software operating on a general-purpose program execution environment, data preprocessing including missing-value completion, data-type conversion, duplicate elimination, and aggregation processing to generate a machine-learning data set, construct and store a trained prediction model by executing, by using a machine-learning software library, a learning process including regression analysis based on the machine-learning data set so that the trained prediction model outputs prediction results regarding tax-saving effectiveness, generate, for individual taxation-related information of the user, a plurality of simulation conditions and estimate, by using the trained prediction model, a tax-burden index and a tax-saving effectiveness index for each of the simulation conditions to calculate a set of candidate tax-saving strategies, configure a prompt sentence that encodes the set of candidate tax-saving strategies and the tax-burden index for input to a generative artificial intelligence model so as to cause the generative artificial intelligence model to generate a natural-language explanatory text, input the prompt sentence into the generative artificial intelligence model and obtain, from the generative artificial intelligence model, a natural-language tax-saving strategy explanation, present the obtained tax-saving strategy explanation to the user through the input/output interface and acquire feedback information including evaluation information or additional input from the user regarding the presented tax-saving strategy explanation, and store the feedback information in association with the taxation-related information in the relational database management mechanism and, based on the feedback information, update at least one of a selection criterion for the set of candidate tax-saving strategies and a component of the prompt sentence so as to dynamically adjust at least one of a utilization manner of the trained prediction model and the prompt sentence to improve a subsequently generated tax-saving strategy explanation. This enables a technically integrated and computer-implemented pipeline that converts structured taxation-related data into optimized, data-grounded, and user-adaptive tax-saving strategies with reduced processing redundancy, improved computational efficiency, and enhanced relevance and clarity of natural-language outputs.

The term “processor” refers to one or more hardware-based data processing units, such as a central processing unit or an execution core, configured to execute machine-readable instructions to perform computational and control operations.

The term “user terminal” refers to an electronic device, such as a personal computer, smartphone, or tablet, operated by a user to input information to and receive information from a server via an input/output interface.

The term “input/output interface” refers to a hardware and software communication mechanism, such as a graphical user interface or an application programming interface, that enables data to be transmitted between the user terminal and the server.

The term “taxation-related information” refers to data items associated with a user's tax situation, including income amounts, expense amounts, deduction items, tax credits, filing status, and other parameters used for tax assessment and tax optimization.

The term “storage device” refers to a non-transitory computer-readable medium, such as a magnetic storage medium, an optical storage medium, or a semiconductor memory, configured to store instructions and data for access by a processor.

The term “relational database management mechanism” refers to a software-controlled data management system that organizes data into relational tables and supports structured query, insertion, update, and deletion operations using a relational model.

The term “structured information” refers to data organized according to a predefined schema, including typed fields, records, and relationships, such that the data can be queried, processed, and updated in a consistent and machine-readable manner.

The term “data-processing software” refers to a software component, executed by the processor, that performs data manipulation operations including reading, transforming, cleaning, and aggregating data to generate processed datasets.

The term “general-purpose program execution environment” refers to a runtime environment, such as an operating system and interpreter or virtual machine, that is configured to execute application programs written in a general-purpose programming language.

The term “data preprocessing” refers to a set of machine-executed operations applied to raw data, including missing-value completion, data-type conversion, duplicate elimination, filtering, and aggregation, in order to prepare the data for analysis or machine learning.

The term “missing-value completion” refers to a process of detecting absent or undefined data entries and filling such entries with substitute values determined according to predetermined rules or statistical methods.

The term “data-type conversion” refers to a process of changing the representation of data from one data type to another, such as converting character data into numerical data or date/time formats, so that the data can be consistently processed.

The term “duplicate elimination” refers to a process of detecting and removing multiple occurrences of equivalent records in a dataset to avoid redundant entries and ensure data consistency.

The term “aggregation processing” refers to a process of combining multiple data records according to grouping criteria to compute aggregate values, such as sums, averages, or counts, for use in analysis or modeling.

The term “machine-learning data set” refers to a collection of processed data instances represented as feature values and, optionally, target values, prepared for use as input to a machine-learning algorithm.

The term “machine-learning software library” refers to a software component that implements one or more machine-learning algorithms, including regression, classification, or clustering algorithms, for training and applying predictive models.

The term “trained prediction model” refers to a machine-learning model whose parameters have been determined by a learning process on a machine-learning data set such that the model can generate prediction outputs for new input data.

The term “regression analysis” refers to a machine-learning or statistical method that models a numerical relationship between one or more explanatory variables and a continuous target variable to predict the target variable from the explanatory variables.

The term “prediction results regarding tax-saving effectiveness” refers to numerical outputs of the trained prediction model that estimate the degree of reduction in tax burden achievable by applying one or more tax-related strategies or conditions.

The term “simulation condition” refers to a set of parameter values, derived from taxation-related information, representing a hypothetical configuration of income, expenses, or deductions used to evaluate potential tax outcomes.

The term “tax-burden index” refers to a numerical indicator representing an estimated tax amount or tax load for a given simulation condition.

The term “tax-saving effectiveness index” refers to a numerical indicator representing an estimated tax reduction or improvement in tax efficiency for a given simulation condition relative to a baseline condition.

The term “candidate tax-saving strategy” refers to a potential action plan or configuration of tax-related parameters that is calculated by the system and that is associated with predicted tax-saving effectiveness.

The term “set of candidate tax-saving strategies” refers to a collection of two or more candidate tax-saving strategies derived from different simulation conditions and their corresponding prediction results.

The term “prompt sentence” refers to a sequence of natural-language or structured-language tokens that encodes input instructions, contextual information, and constraints for use by a generative artificial intelligence model to produce an output.

The term “generative artificial intelligence model” refers to a trained artificial intelligence model configured to receive a prompt sentence and generate content, including natural-language text, that satisfies conditions or tasks specified in the prompt sentence.

The term “natural-language explanatory text” refers to a human-readable textual output, generated by the generative artificial intelligence model, that describes or explains tax-saving strategies using a natural language.

The term “tax-saving strategy explanation” refers to a natural-language explanatory text that details recommended tax-saving strategies, associated reasoning, and optionally expected outcomes, tailored to taxation-related information of a user.

The term “feedback information” refers to data acquired from the user in response to a presented tax-saving strategy explanation, including evaluation signals, ratings, selection indicators, or additional natural-language input.

The term “evaluation information” refers to a part of the feedback information that indicates a user's assessment of the usefulness, clarity, or relevance of a presented tax-saving strategy explanation.

The term “additional input” refers to a part of the feedback information that includes further user-provided information, such as clarification requests, questions, or updated taxation-related details, in response to the presented explanation.

The term “selection criterion for the set of candidate tax-saving strategies” refers to a rule or parameter used to choose one or more candidate tax-saving strategies from the set of candidate tax-saving strategies for presentation or further processing.

The term “component of the prompt sentence” refers to a segment or element of a prompt sentence, such as context description, constraint specification, or output-format instruction, that can be individually modified or updated.

The term “utilization manner of the trained prediction model” refers to a configuration specifying how the trained prediction model is invoked, including which input features are used, how scenarios are generated, and how prediction results are integrated into subsequent processing.

The term “preference information” refers to information derived from feedback that indicates user-specific tendencies, such as desired level of detail, favored explanation style, or prioritization of particular tax-saving objectives.

The term “comprehension-level index” refers to a metric derived from feedback that represents a user's level of understanding of tax-related content, used to adjust explanation complexity or terminology difficulty.

The term “modified prompt sentence” refers to a prompt sentence that has been changed or extended based on preference information, comprehension-level indices, feedback information, or system-determined rules to improve the quality of generated outputs.

The term “output-format specification” refers to an instruction within a prompt sentence that indicates how the generative artificial intelligence model should structure its output, such as using bullet lists, sections, or summaries.

The term “declaration form” refers to a format specification or template corresponding to a tax-declaration document defined by a taxation authority, including required fields and structural layout.

The term “electronic data format” refers to a machine-readable representation of information, such as a structured file or message format, that conforms to a predefined schema for electronic processing or submission.

The term “tax-declaration record” refers to an electronic data object that contains taxation-related information arranged according to a declaration form and that is suitable for storage, review, or electronic submission to a taxation authority.

In one embodiment, a server implements the claimed system as a network-accessible computation node equipped with at least one processor, a main memory, a non-transitory storage device, and a network interface. The server runs an operating system such as a general-purpose server operating system and executes application software including a web application framework, a relational database management system, a data-processing environment based on a general-purpose programming language (for example, a Python runtime), a machine-learning software library, and a generative AI client library for interacting with a generative AI model.

The server communicates with one or more terminals operated by users via a digital communication network using a standardized application-layer protocol.

The terminal operates as a user interface device and may be realized as a desktop computer, a portable computer, or a mobile terminal such as a smartphone or tablet. The terminal executes client software such as a web browser or a native application that provides graphical user interface components for data entry, visualization of results, and feedback input. The terminal sends taxation-related information, prompt sentences, and feedback information to the server and receives, from the server, tax-saving strategy explanations, tax-declaration records, and status information.

The user operates the terminal to input taxation-related information including income amounts, expense categories, deduction items, and other parameters required for tax assessment. The user may also provide qualitative feedback, such as ratings of the usefulness of generated advice, indications of unclear portions of the explanation, or additional narrative context about the user's tax situation. The user reviews the tax-saving strategy explanations and tax-declaration records displayed on the terminal.

The server uses a relational database management mechanism to store structured information representing taxation-related information, user profiles, simulation results, model versions, and feedback information. The server defines multiple tables, such as a user table storing user identifiers and profile attributes, a taxation data table storing per-year income and deduction records, a simulation table storing simulation conditions and associated prediction results, a strategy table storing generated tax-saving strategy explanations, and a feedback table linking user evaluations and comprehension-level indices to specific strategies and prompts. The server configures indexes on frequently queried columns, such as user identifier and tax year, to reduce query latency and improve input/output efficiency.

The server uses data-processing software running on a general-purpose program execution environment to perform data preprocessing on taxation-related information retrieved from the relational database management mechanism. The server constructs data structures such as tabular arrays or data frames where each row corresponds to a particular user and tax year and each column corresponds to a feature, such as total annual income, total deductible medical expenses, total housing-related deductions, number of dependents, and employment type. The server performs missing-value completion by applying predetermined rules, such as filling empty deduction fields with zero or estimating missing expense amounts based on historical averages for the same user. The server performs data-type conversion by converting text-encoded numbers and dates into numeric and time formats that can be processed by machine-learning algorithms.

The server performs duplicate elimination by identifying taxation-related records with identical primary keys or identical combinations of critical attributes and removing redundant copies. The server performs aggregation processing by grouping raw transaction-level records by user and tax year and computing aggregate feature values, such as sums of expenses in specific categories and counts of relevant events.

The server uses a machine-learning software library to construct a trained prediction model from the machine-learning data set. In one embodiment, the server defines an input feature vector for each training instance that includes numerical features (for example, income, expense totals, counts of deduction categories) and categorical features (for example, filing status, employment type) encoded as numerical representations. The server defines a target variable representing tax-saving effectiveness, such as the difference between a baseline tax amount and an optimized tax amount achieved by a known strategy in historical data. The server configures a regression model, such as a gradient-boosted decision tree model or a random-forest regression model, with hyperparameters including a number of trees, maximum tree depth, and learning rate.

The server trains the prediction model by repeatedly applying a learning algorithm over the machine-learning data set. The server defines a loss function, such as mean squared error between predicted tax-saving effectiveness and observed tax-saving effectiveness, and iteratively adjusts model parameters to minimize the loss function on the training data. In the case of a gradient-boosted tree model, the server constructs decision trees stage by stage, where each new tree is trained to approximate the negative gradient of the loss function with respect to current predictions. The server applies regularization parameters to avoid overfitting and evaluates the model on a separate validation set to assess generalization performance. The server stores the resulting trained prediction model, along with version identifiers and metadata describing the training dataset and hyperparameters, in the storage device.

The server uses the trained prediction model to generate simulation conditions and candidate tax-saving strategies for each user. The server receives taxation-related information for a target user and derives a baseline feature vector representing the user's current tax situation. The server programmatically constructs multiple simulation conditions by modifying selected feature values, such as increasing or decreasing deductible expense amounts within realistic bounds, shifting the timing of certain expenses between tax years, or toggling the presence of specific deduction categories. The server passes each simulation-condition feature vector through the trained prediction model to obtain a tax-burden index and a tax-saving effectiveness index for that condition. The server then forms a set of candidate tax-saving strategies by pairing each simulation condition with its predicted indices and discarding strategies that fail to meet predefined feasibility criteria, such as negative predicted tax-saving effectiveness or violations of regulatory constraints.

The server constructs a prompt sentence for a generative AI model based on the set of candidate tax-saving strategies and the prediction results. The server encodes relevant features, including user profile information, baseline tax-burden index, and predicted tax-saving effectiveness indices for selected strategies, into natural-language text segments. The server arranges these segments in a structured format including sections that describe the user's situation, summarize key simulation results, and specify instructions for the type and format of explanation required.

In one example, the server may generate a prompt sentence of the following form:

### “User Profile:

Annual income: 5,000,000 yen (salary income)
Medical expenses so far this year: 300,000 yen
Mortgage interest paid this year: 200,000 yen
Filing status: single, no dependents

### Model Predictions:

Baseline expected tax with current data: X yen
Expected tax if medical expenses increase to 350,000 yen this year: Y yen
Expected tax if certain elective treatments are postponed to next year: Z yen

You are a tax strategy assistant. Based on the above information, propose a concrete tax-saving strategy for this user. Explain:

1. How the user can maximize the medical expense deduction this year.

2. Whether it is beneficial to bring forward or defer any medical or related payments.

3. How to combine medical expense deductions with mortgage-related deductions when filing the tax return.

Provide clear, step-by-step recommendations in natural language.”

The server transmits the prompt sentence to a generative AI model via a generative AI client library. In one embodiment, the generative AI model is a neural-network-based language model comprising an encoder-decoder or decoder-only transformer architecture with multiple self-attention layers, feedforward layers, and normalization layers. The generative AI model receives the prompt sentence as a sequence of token identifiers, processes the sequence through its attention and transformation layers to compute contextual representations, and outputs a sequence of token probabilities representing the tax-saving strategy explanation. The generative AI model has been previously trained on a large corpus of text and optionally fine-tuned on domain-specific taxation-related text using a supervised learning procedure that minimizes cross-entropy loss between model outputs and reference text. The generative AI model performs generation by iteratively sampling or selecting tokens under constraints such as temperature and maximum output length.

The server receives the generated token sequence from the generative AI model, converts token identifiers to text characters according to a pre-defined vocabulary, and obtains a natural-language tax-saving strategy explanation. The server may further process the explanation text by segmenting it into numbered steps, bullet points, or sections, according to formatting rules. The server stores the explanation and associated metadata in the strategy table of the relational database and associates it with the corresponding user and simulation conditions.

The terminal receives the tax-saving strategy explanation from the server and displays it in a human-readable format. The terminal may present interactive controls that allow the user to mark certain recommendations as helpful, not applicable, or unclear. The terminal may also provide an input field where the user can submit a follow-up question as a free-text prompt sentence, such as:

“My income this year is 5,000,000 yen, and I want to maximize the medical expense deduction.

Which actions should I take before the end of the year?”

The terminal sends the feedback information and the follow-up prompt sentence to the server.

The server processes feedback information to derive preference information and comprehension-level indices for each user. The server applies data-processing software to generate feature representations of feedback, such as counts of “unclear” labels per concept, average ratings per strategy type, and linguistic complexity metrics of user follow-up questions. The server may compute a comprehension-level index based on indicators such as the frequency of clarification requests and the presence of domain-specific vocabulary in user inputs. The server stores these derived metrics in the feedback table to be reused in subsequent interactions.

The server modifies prompt sentences based on preference information and comprehension-level indices. For a user with a lower comprehension-level index, the server may select a prompt template that instructs the generative AI model to use simpler terminology and shorter sentences.

For a user who consistently prefers tabular summaries, the server may incorporate explicit output-format specifications into the prompt sentence, such as requiring bullet points or structured headings. The server updates components of the prompt sentence, including context description and output formatting instructions, to match user preferences, which in turn changes the input sequence to the generative AI model and results in explanations that more closely align with user needs.

The server dynamically adjusts the utilization manner of the trained prediction model using feedback information. For example, if feedback indicates that certain types of candidate strategies are frequently rejected or marked as not applicable, the server may adjust selection criteria to deprioritize or filter such strategies in subsequent candidate sets. The server may update threshold values used to determine which strategies are considered viable or modify feature weighting schemes used to rank strategies. This feedback-driven adjustment reduces the number of irrelevant or low-quality candidate strategies that are later passed to the generative AI model, which improves overall computation efficiency and explanation quality.

The server additionally generates a tax-declaration record by automatically arranging taxation-related information into an electronic data format corresponding to a prescribed declaration form.

The server applies mapping rules that link features in the structured taxation-related information to designated fields in the declaration form schema. The server may verify consistency constraints, such as cross-field totals and validation ranges, before storing the resulting tax-declaration record in the storage device. The server then provides the tax-declaration record to the terminal, which displays the record for user confirmation or automatically transmits the record to an external tax authority system through a secure communication channel.

The described architecture and data flow improve computer technology in several ways. The server reduces redundant data transformations by centralizing data preprocessing in a defined pipeline that uses the same feature extraction and cleaning rules both for training the prediction model and for generating simulation conditions. This design improves computation efficiency and data consistency because the same preprocessed features are available to multiple modules without repeated parsing and conversion. The use of a trained prediction model to pre-screen simulation conditions reduces the search space of possible strategies, thereby decreasing the amount of text that must be encoded into prompt sentences and processed by the generative AI model, which lowers communication and computation load.

The integration of prediction outputs into structured prompt sentences improves the relevance and accuracy of generative AI explanations because the generative AI model is constrained by explicit, machine-generated numerical results rather than relying solely on generic prior knowledge. The server uses structured encoding of indices and constraints in the prompt sentence to align the generative AI model's output with quantitatively evaluated strategies. This integration yields technical effects, such as reduced error rates in predicted tax-saving effectiveness, more stable and repeatable explanation patterns, and lower risk of generating advice that conflicts with underlying numeric predictions.

The use of feedback information to adjust both model utilization and prompt construction constitutes more than mere automation of human judgment. The server applies non-conventional rules that map quantitative feedback patterns to changes in strategy-selection thresholds and prompt templates, effectively performing dynamic system-level adaptation. This design allows the system to improve response quality and processing efficiency over time without manual reconfiguration, which is a technical optimization of the system's internal operation. For instance, by learning which explanation formats and strategy types yield fewer follow-up questions, the server can reduce overall network round trips and processing time per completed advice session.

In alternative embodiments, the server may employ different machine-learning models, such as a deep neural network with fully connected layers or a recurrent architecture, to predict tax-saving effectiveness. The server may use different optimization algorithms, such as stochastic gradient descent with momentum or adaptive gradient methods, to adjust model weights during training.

The server may perform data augmentation by synthesizing additional training examples derived from perturbations of existing taxation-related records within legally acceptable ranges. The server may also use transfer learning techniques to adapt a pre-trained predictive model or generative AI model to a new tax jurisdiction by fine-tuning on jurisdiction-specific data.

In further embodiments, the server may deploy the generative AI model locally on the same hardware as the relational database management mechanism to reduce network latency and improve data privacy. In such configurations, the server processes prompt sentences through a built-in transformer model whose architecture parameters (such as number of layers, hidden dimension size, and attention heads) are selected based on hardware capabilities. The server can also implement caching policies for frequent prompt patterns or strategies to further reduce processing time.

By combining relational data management, explicit feature engineering, machine-learning-based simulation, and controlled natural-language generation via structured prompt sentences, the system achieves a tightly integrated technical solution. The server, terminal, and user cooperate in this solution, but the critical improvements reside in how the server internally structures data, trains predictive models, generates and filters simulation conditions, and constructs and adapts prompt sentences in response to feedback, resulting in enhanced processing speed, improved prediction and explanation accuracy, reduced resource usage, and more robust and scalable computer operation.

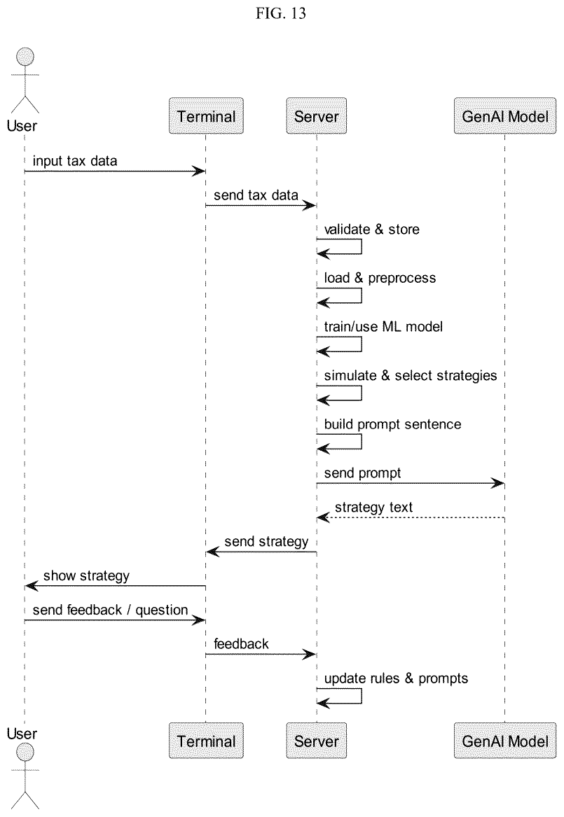

The following describes the processing flow using FIG. 13.

### Step 1

User prepares and inputs taxation-related information.

User collects raw taxation-related information such as income amounts, expense items, deductible categories, and filing status. User enters this information into input fields on the terminal using a web browser or a native application. The input includes structured values (for example, numbers, dates, category selections) and optionally free-text notes. The input of this step is the user's raw taxation-related information as typed values on the terminal screen. The output of this step is a structured request payload in the terminal, typically represented as key-value pairs (for example, JSON fields), ready to be sent to the server.

### Step 2

Terminal validates and transmits taxation-related information.

Terminal performs client-side validation such as checking that required fields are present, numeric fields contain valid numbers, and date fields conform to a prescribed format. Terminal converts the user inputs into a structured data object, for example a JSON document with fields like “annual_income”, “medical_expenses”, and “mortgage_interest”. Terminal then sends this structured data object to the server via a secure network protocol. The input of this step is the user-entered taxation-related information captured in the user interface. The output of this step is a network request containing a structured representation of the taxation-related information addressed to the server.

### Step 3

Server receives, validates, and stores taxation-related information.

Server accepts the incoming network request through an application framework and parses the structured payload. Server performs server-side validation, including range checks (for example, income must be non-negative), cross-field consistency checks (for example, total expenses should not exceed income beyond a threshold), and user authentication checks using session identifiers or tokens. Server converts the validated data into relational records matching schema definitions for user, tax year, and category. Server then issues insertion or update commands to a relational database management mechanism, storing the structured data into corresponding tables and committing the transaction. The input of this step is the structured taxation-related payload received from the terminal. The output of this step is a set of persistent database records indexed by user identifier and tax year, with unique record identifiers assigned.

### Step 4

Server extracts and preprocesses data for machine-learning use.

Server retrieves taxation-related records from the relational database management mechanism by executing database queries based on user identifier and tax year. Server loads the query results into a data-processing environment, creating tabular data structures where each column corresponds to a feature (for example, total income, total medical expenses, total housing deductions) and each row corresponds to a particular user-year. Server performs data preprocessing operations: missing-value completion by substituting default or statistically derived values, data-type conversion by casting text fields to numeric or date formats, duplicate elimination by removing records with identical primary keys or equivalent content, and aggregation processing by grouping transactions and computing sums or counts per category.

The input of this step is the raw relational records retrieved from storage. The output of this step is a cleaned and normalized machine-learning data set represented as feature matrices suitable for model training and prediction.

### Step 5

Server trains or updates a prediction model for tax-saving effectiveness.

Server uses the machine-learning data set to configure input features and target labels. Server selects an algorithm, such as a regression model using decision trees or gradient boosting, and initializes model parameters. Server splits the data into training and validation subsets and applies an optimization algorithm to minimize a loss function, for example mean squared error between predicted and actual tax-saving effectiveness. Server repeatedly updates internal model parameters, such as tree splits or weight vectors, based on gradients of the loss function computed on the training subset. Server evaluates performance on the validation subset and may adjust hyperparameters to improve predictive accuracy. The input of this step is the preprocessed machine-learning data set. The output of this step is a trained prediction model stored on the server with associated metadata describing its configuration and performance metrics.

### Step 6

Server generates simulation conditions for an individual user.

Server selects the target user's latest taxation-related record and constructs a baseline feature vector representing the current situation. Server creates multiple simulation conditions by programmatically modifying particular feature values under predetermined rules, such as increasing medical expenses within a plausible range, adjusting the timing of expense recognition, or toggling specific deduction options. For each simulation condition, server ensures that modified features remain within legal and logical constraints. The input of this step is the baseline feature vector derived from the user's current taxation-related data. The output of this step is a set of simulation-condition feature vectors representing alternative hypothetical tax scenarios for the user.

### Step 7

Server predicts tax-burden and tax-saving indices for each simulation condition.

Server applies the trained prediction model to each simulation-condition feature vector and computes predicted outputs, such as an estimated tax-burden index and a tax-saving effectiveness index. Server aggregates and stores these predictions together with the defining parameters of each simulation condition in a simulation table. Server may rank or filter the simulation conditions based on predicted effectiveness and feasibility thresholds. The input of this step is the set of simulation-condition feature vectors generated in the previous step. The output of this step is a set of candidate strategies, each with an associated tax-burden index and tax-saving effectiveness index, stored as structured records.

### Step 8

Server selects candidate tax-saving strategies and structures them as strategy data.

Server analyzes the set of predicted simulation results to identify candidate tax-saving strategies that meet selection criteria, such as exceeding a minimum tax-saving effectiveness threshold or conforming to specific risk profiles. Server assigns internal identifiers to each candidate strategy and compiles descriptive metadata, such as which features changed relative to the baseline and how much tax reduction is predicted. Server stores these candidate strategies in a strategy-related data structure ready for explanation generation. The input of this step is the complete set of simulation results with predicted indices. The output of this step is a filtered and organized set of candidate tax-saving strategies represented as structured data elements.

### Step 9

Server constructs a prompt sentence for a generative AI model.

Server reads the selected candidate strategies and their associated prediction indices and extracts key quantities and variations. Server then uses a prompt-construction template to assemble these values into a natural-language prompt sentence that describes the user's profile, the baseline case, and selected high-value strategies, and that instructs the generative AI model on the kind of explanation required. Server inserts specific numbers (for example, annual income, medical expenses, and predicted tax savings) into predefined text slots to create a coherent instruction. The input of this step is the structured set of candidate strategies and their numerical indices. The output of this step is a complete prompt sentence in natural language that encodes the quantitative analysis and desired output format.

### Step 10

Server transmits the prompt sentence to a generative AI model and obtains an explanation.

Server sends the prompt sentence to a generative AI model through an application program interface. The generative AI model, implemented as a neural network (for example, a transformer-based language model), receives the prompt and performs tokenization, encoding, and multi-layer processing to generate a sequence of output tokens forming a natural-language explanation. Server receives the generated token sequence, decodes it into text, and treats the result as a tax-saving strategy explanation tailored to the input prompt. The input of this step is the constructed prompt sentence containing user profile and strategy data. The output of this step is a natural-language tax-saving strategy explanation produced by the generative AI model and received by the server.

### Step 11

Server post-processes and stores the tax-saving strategy explanation.

Server analyzes the generated explanation text and applies formatting rules, such as segmenting it into paragraphs, numbered steps, or bullet points. Server may detect references to specific strategies or indices and link them to their underlying simulation records. Server stores the formatted explanation, along with the original prompt sentence and associated strategy identifiers, in the relational database for later retrieval, auditing, or refinement. The input of this step is the raw explanation text returned by the generative AI model. The output of this step is a formatted and indexed explanation record persisted in the storage system.

### Step 12

Server sends the strategy explanation to the terminal.

Server prepares a response message that includes the formatted explanation text and any relevant numerical summaries, such as predicted tax savings for the top strategies. Server may also include structured metadata (for example, labels for each recommendation) to support interactive display on the terminal. Server transmits this response over the network to the terminal using a reliable communication protocol. The input of this step is the stored explanation record and associated summary data. The output of this step is a network response carrying the explanation and metadata to the terminal.

### Step 13

Terminal displays the explanation and collects user feedback.

Terminal receives the response from the server and parses the included explanation text and metadata. Terminal renders the explanation on a display, using layout elements such as headings, bullet lists, and emphasis to increase readability. Terminal also presents user controls, such as rating buttons, checkboxes for marking suggestions as helpful or not applicable, and a text box for follow-up questions. The input of this step is the explanation and metadata received from the server. The output of this step is a displayed interface that allows the user to understand the strategies and to input feedback and additional prompt sentences.

### Step 14

User reviews the explanation and submits feedback or additional queries.

User reads the presented explanation and evaluates its usefulness and clarity. User may select evaluation options (for example, “helpful”, “unclear”) for particular recommendations and may type a follow-up question, such as “My income this year is 5,000,000 yen, and I want to maximize the medical expense deduction. Which actions should I take before the end of the year?” User then confirms submission, causing the terminal to bundle the evaluation signals and the new prompt sentence as feedback information. The input of this step is the explanation as displayed on the terminal. The output of this step is user-generated feedback information and an optional additional prompt sentence captured by the terminal.

### Step 15

Terminal packages and sends feedback information to the server.

Terminal structures the user's ratings, selection flags, and free-text input into a feedback payload. Terminal identifies the associated explanation record and includes its identifier so that the server can link the feedback to the corresponding prompt and strategies. Terminal sends this structured feedback payload to the server via a network request. The input of this step is the user feedback and additional prompt sentence provided through the interface. The output of this step is a network message containing feedback information and identifiers referencing the original explanation.

### Step 16

Server analyzes feedback and updates selection criteria and prompt-construction rules.

Server receives the feedback payload and stores the raw feedback into a feedback table. Server then applies data-processing operations to derive higher-level metrics, such as a user-specific comprehension-level index and preference indicators (for example, preference for short explanations or preference for detailed procedural steps). Server updates internal configuration values, such as thresholds for selecting candidate strategies and template parameters for building prompt sentences, by applying rules that map feedback metrics to configuration changes. For example, server may lower the complexity of future prompts for users with low comprehension-level indices or exclude certain categories of strategies that receive consistently low ratings. The input of this step is the structured feedback information linked to specific explanations and users. The output of this step is an updated set of system parameters and prompt templates that influence subsequent strategy generation and explanation flows.

### Application Example 2

Description follows regarding a flow of the specific processing in an Application Example 2. The units of the system described below are implemented by the data processing device 12 and the smart device 14. The data processing device 12 is called a “server” and the smart device 14 is called a “terminal”.

Conventional tax support and financial planning systems typically implement fixed rule engines and static user interfaces that require engineers to hard-code decision logic, dialog flows, and form-filling rules. Such systems suffer from several technical problems. First, conventional systems process tax-related data, natural language input, and model output in separate, loosely coupled modules, which forces repeated parsing and conversion between different internal representations and increases processing latency and resource consumption. Second, conventional systems cannot systematically control the behavior of a generative AI model; prompt sentences are often crafted manually or heuristically, without programmatic integration of structured data (such as aggregated transaction results) and user state (such as emotional state), leading to non-deterministic behavior, unstable output quality, and increased need for human post-processing. Third, conventional systems are not designed to collect and exploit interaction history, model responses, and user feedback as machine-readable training data for improving future prompt construction, strategy generation, and automatic document generation.

As a result, the overall computing system cannot efficiently adapt to user preferences or error patterns, and processing remains largely stateless and non-learning.

Furthermore, existing architectures generally treat the user interface, data analysis engine, and document generator as isolated subsystems that communicate through coarse-grained APIs. This fragmentation prevents the processor from executing an end-to-end optimization that spans input acquisition, structured data processing, generative AI invocation, and automatic generation of tax return documents or financial reports. Because the generative AI model is invoked with ad hoc natural language queries, the computing platform cannot reliably map internal numerical aggregates and classification results into prompt sentences and cannot robustly validate and refine the model output. Consequently, the system tends to produce inconsistent recommendations, requires manual review for compliance, and incurs unnecessary network calls and CPU cycles.

Additionally, known systems do not incorporate emotion estimation as a first-class input into the control flow. Even when sentiment analysis is used at the user interface layer, the processing engine does not exploit emotion information to dynamically modulate explanation complexity, dialog tone, or the structure of prompt sentences provided to the generative AI model. This results in generic responses that are not tuned to user cognitive load, causing repeated clarification cycles, redundant processing, and inefficient use of computational resources.

Accordingly, there is a need for an improved computer-based system that integrates structured transaction processing, natural language understanding, emotion estimation, and generative AI control into a unified processing pipeline. Such a system should programmatically generate and refine prompt sentences on the basis of machine-understandable data (including transaction aggregates, user intent, and emotion state), automatically post-process and validate generative AI output, and use accumulated history to optimize subsequent prompt generation and automatic tax return or financial report creation. By redesigning the interactions between these components as specific operations performed by a processor, the invention seeks to improve the functioning of the computer itself in executing tax and financial strategy workflows, rather than merely computerizing a human tax advisor's mental process.

The specific processing by the specific processing unit 290 of the data processing device 12 in Application Example 2 is realized by the following means.

The present invention provides a server comprising a processor and a storage device, the processor being configured to execute instructions that cause the server to (i) provide an interactive information input/output interface for acquiring tax information or financial information and electronic transaction information from a user, (ii) classify and aggregate the electronic transaction information using a data processing program to identify candidate deductible expense items or candidate non-taxable income items, (iii) perform natural language processing on user-supplied natural language input to extract user intent and inquiry content and to supplement structured tax or financial records, (iv) estimate an emotional state of the user using an emotion estimation model and determine explanation difficulty and dialog tone in accordance with the emotional state, (v) automatically construct, on the basis of the identified candidates, the supplemented structured data, the user intent, and the emotional state, a machine-generated prompt sentence to be input to a generative AI model together with data processing results, (vi) invoke the generative AI model with the prompt sentence and the data processing results to obtain response information including a tax strategy or a financial strategy applicable to the user, (vii) post-process and validate recommended items included in the response information according to rule information or verification logic and generate strategy information whose explanation format and level of detail are adjusted in accordance with the emotional state, (viii) present the strategy information to the user via the interface and acquire feedback information from the user, (ix) parse the feedback information to extract constraint conditions and preferences of the user and generate an updated prompt sentence reflecting the constraint conditions and preferences for re-input to the generative AI model so as to update the tax or financial strategy, and (x) compute item values of declaration form data based on the updated strategy and the data processing results and automatically generate a tax return document or a financial report document as an output of the server. This enables the computing platform to perform an integrated, stateful, and adaptive processing pipeline in which structured data computation, natural language understanding, emotion-aware prompt sentence construction, generative AI invocation, automatic validation, and document generation are orchestrated as coordinated operations of the processor, thereby reducing redundant parsing, stabilizing model behavior, improving response relevance and clarity, and enhancing overall system efficiency and robustness compared to conventional rule-based or manually tuned architectures.

The term “processor” refers to a hardware computing element, such as a central processing unit or a programmable logic device, that executes machine-readable instructions to perform arithmetic, logical, control, and input/output operations.

The term “storage device” refers to a hardware data retention element, such as a memory or non-volatile storage medium, that stores instructions, configuration data, transaction data, intermediate processing results, and generated documents for access by the processor.

The term “information input/output interface” refers to a hardware and software combination that enables exchange of data between the system and a user or external device, including graphical user interfaces, application programming interfaces, and communication modules for sending and receiving input and output information.

The term “tax information” refers to structured or semi-structured data related to a user's taxable activities, including income amounts, expense amounts, deduction items, credit items, filing status, and other parameters relevant to calculation and reporting of tax obligations.

The term “financial information” refers to structured or semi-structured data representing a user's economic situation, including income, expenses, assets, liabilities, cash flows, and other financial parameters used for analysis and planning.

The term “electronic transaction information” refers to digital records of financial transactions, including payment records, receipts, transfers, and settlements, that specify at least a transaction date, an amount, and a counterparty or category.

The term “data processing program” refers to a sequence of machine-readable instructions executed by the processor to perform operations such as reading, filtering, transforming, aggregating, and classifying data stored in the storage device.

The term “classify and aggregate” refers to processing operations that assign data entries to categories and compute combined values, such as totals, counts, or averages, for data entries belonging to each category.

The term “candidate deductible expense item” refers to an expense entry or category that has been programmatically identified, based on rules or thresholds, as potentially qualifying for tax deduction treatment under applicable tax regulations.

The term “candidate non-taxable income item” refers to an income entry or category that has been programmatically identified, based on rules or thresholds, as potentially qualifying for non-taxable treatment under applicable tax regulations.

The term “natural language input” refers to information expressed in a human language, such as text or transcribed speech, that is provided by a user for the purpose of describing facts, asking questions, or giving feedback.

The term “natural language processing” refers to computational techniques that analyze natural language input to perform tasks such as tokenization, part-of-speech tagging, parsing, entity recognition, and intent detection.

The term “user intent” refers to a semantic representation of an action or goal that a user wants the system to perform, inferred from the user's natural language input or interaction behavior.

The term “inquiry content” refers to the specific subject matter or question expressed by the user in natural language, such as a request for an explanation of a deduction rule or a request for a particular tax strategy.

The term “structured tax or financial records” refers to tax information or financial information that has been normalized into a machine-readable format with defined fields, data types, and relationships.

The term “emotion estimation model” refers to a computational model that receives user-related signals, such as text, voice features, or other behavioral indicators, and outputs an estimated emotional state label and optionally an associated confidence or intensity score.

The term “emotional state” refers to a classification of a user's psychological condition, such as stress, anxiety, confusion, calmness, or excitement, inferred by the emotion estimation model from user input or behavior.

The term “explanation difficulty” refers to a level of complexity and abstraction used in presenting information to the user, including factors such as vocabulary sophistication, sentence length, and amount of technical detail.

The term “dialog tone” refers to stylistic characteristics of system-generated messages, including politeness, reassurance, neutrality, or urgency, selected in accordance with the user's emotional state and preferences.

The term “generative AI model” refers to a machine learning model that produces output content, such as text or other data structures, in response to input data and instructions, where the output is generated based on learned patterns rather than simple retrieval or fixed rules.

The term “prompt sentence” refers to one or more machine-generated natural language expressions that instruct a generative AI model to perform a specified task and provide contextual information, including user data, system objectives, and formatting requirements.

The term “data processing result” refers to information produced by execution of the data processing program, including classified categories, aggregated values, identified candidate items, and other derived metrics.

The term “response information” refers to data output by the generative AI model in response to a prompt sentence and context, including at least one tax strategy or financial strategy and associated explanation text.

The term “tax strategy” refers to a plan comprising one or more recommended actions or configurations that, when applied to a user's tax situation, aim to lawfully reduce tax burden or optimize tax outcomes.

The term “financial strategy” refers to a plan comprising one or more recommended actions or configurations that, when applied to a user's financial situation, aim to improve financial health, efficiency, or risk profile, including but not limited to savings, investment, and tax-related measures.

The term “rule information” refers to machine-readable representations of conditions, thresholds, or logical constraints used to validate or post-process data or recommendations, including but not limited to compliance rules and sanity checks.

The term “verification logic” refers to computational procedures that evaluate whether data or model outputs satisfy rule information or expected ranges, and that may flag, adjust, or reject outputs that do not satisfy such conditions.

The term “strategy information” refers to a processed and formatted representation of a tax strategy or financial strategy, including recommendations, explanations, and supporting numerical values, that is prepared for presentation to the user.

The term “feedback information” refers to data received from the user after presentation of strategy information, including natural language comments, approvals, rejections, modification requests, and preference indications.

The term “constraint conditions” refers to limitations or boundaries specified or implied by the user, such as preferences regarding risk level, complexity, required documentation, or time to implement.

The term “preferences” refers to user-specific tendencies or choices, such as favored explanation style, acceptable trade-offs between tax savings and effort, and desired detail level for output.

The term “update prompt sentence” refers to a prompt sentence that is constructed to modify or refine a previously generated strategy by incorporating feedback information, constraint conditions, or updated data.

The term “declaration form data” refers to a structured representation of fields and values required to complete a tax return document or a financial report document in a format accepted by an authority or recipient.

The term “item values” refers to numerical or categorical entries assigned to respective fields in the declaration form data, such as total income, total deductions, taxable income, or reporting period identifiers.

The term “tax return document” refers to a completed digital or printable representation of a tax filing form, generated from declaration form data and suitable for submission to a tax authority.

The term “financial report document” refers to a completed digital or printable representation of a financial statement or report, generated from declaration form data and suitable for presentation to a recipient.

The term “history information” refers to stored records of past data processing results, prompt sentences, response information, feedback information, and generated documents associated with one or more users or sessions.

The term “learning process” refers to a computational procedure that analyzes history information to adjust parameters, rules, templates, or models used by the system, with the goal of improving future prompt sentence generation, strategy generation, validation, or document generation.

The term “interactive dialog” refers to a sequence of exchanges between the system and the user in which the system presents questions or content and receives responses, and in which later system behavior depends on prior user input.

The term “post-process” refers to processing operations performed after an initial output has been produced by a module or model, including filtering, restructuring, validating, annotating, or rephrasing the output.

In one embodiment, a server, a plurality of terminals, and at least one communication network cooperatively implement the claimed system. The server includes a processor and a storage device. The processor executes instructions to implement a set of functional modules, including an interface control module, a data ingestion module, a data processing module, a natural language processing module, an emotion estimation module, a prompt construction module, a generative AI invocation module, a post-processing module, a feedback analysis module, a form generation module, and a learning module. The storage device stores structured tax and financial records, electronic transaction records, model parameters, rule information, and interaction history.

A terminal includes an input/output unit, such as a touch display, a microphone, and a speaker, and a local communication module. The terminal executes an application that communicates with the server via a network protocol such as HTTPS. The user operates the terminal to provide tax information or financial information, to view generated strategies and documents, and to submit feedback.

The server uses a general-purpose central processing unit as the processor. The server executes an operating system and application software implemented, for example, using a server-side framework and a relational database management system. The storage device includes volatile memory and non-volatile storage, and stores database tables such as a user table, a transaction table, an expense table, an income table, a deduction table, a prompt history table, and a document table. Each table defines specific fields. For example, the transaction table includes fields such as transaction_id, user_id, timestamp, amount, merchant_code, category_code, and raw_description.

The server uses a data analysis library to implement the data processing module. The data processing module loads transaction records from the storage device into a tabular in-memory data structure. The data processing module classifies each transaction record into categories such as medical, education, transportation, or other by applying a combination of deterministic rules and statistical mappings. The data processing module aggregates classified transactions by category and period. The data processing module computes, for each user, aggregated values such as total_medical_expense, total_business_expense, total_non_taxable_income_candidate, and other metrics required for downstream processing. The data processing module writes derived metrics back into the database, for example as rows in a summary table indexed by user_id and tax_year.

The server uses a natural language processing library to implement the natural language processing module. The natural language processing module receives user utterances as text. The terminal converts voice input into text using a speech-to-text engine and transmits the text to the server. The natural language processing module tokenizes sentences, generates part-of-speech tags, performs dependency parsing, and runs named entity recognition. The natural language processing module identifies entities such as income amounts, expense types, and tax concepts (for example, medical expense deduction or housing deduction). The natural language processing module maps extracted entities to structured fields in the database. For example, when the user says “My income is 5 million and I want to claim a medical expense deduction,” the natural language processing module extracts “income: 5,000,000” and a flag indicating a desire to apply a medical expense deduction, and stores these as normalized fields in the tax information table.

The server uses an emotion estimation model to implement the emotion estimation module. The emotion estimation model can be implemented as a neural network trained on labeled text or audio features. In one embodiment, the emotion estimation model comprises an encoder that converts input tokens into continuous embeddings, a sequence model such as a bidirectional recurrent neural network or a transformer encoder that aggregates contextual information, and a classification head that outputs a probability distribution over emotion labels such as stress, anxiety, confusion, calmness, and excitement. The emotion estimation module receives as input either user text or acoustic features computed from audio, such as prosodic features (pitch, energy, speaking rate). The emotion estimation module outputs an emotion label and, optionally, a confidence score. The emotion estimation module stores the current emotion label in association with the user session identifier in the storage device.

The server uses rule information stored in the storage device to map emotion labels to target explanation difficulty and dialog tone. For example, the server maps “stress” to an explanation difficulty of “low” and a dialog tone of “reassuring,” and maps “excitement” to an explanation difficulty of “normal” and a dialog tone of “encouraging.” By converting a high-dimensional emotion estimation output into discrete control parameters, the server enables downstream modules to consistently adjust their behavior without repeating heavy computations.

The server uses a generative AI model as a text generation engine. In one embodiment, the generative AI model is a transformer-based neural network with multiple self-attention layers, feedforward layers, layer normalization, and positional encodings. The generative AI model receives as input a sequence of tokens representing a prompt sentence and, optionally, additional context tokens generated from structured data. The generative AI model has been pre-trained on large corpora of text and optionally fine-tuned on domain-specific tax and financial corpora. The training process minimizes a cross-entropy loss between predicted tokens and ground truth tokens using an optimization algorithm such as stochastic gradient descent with adaptive learning rate. During training, the model updates internal weight matrices by backpropagation to reduce prediction error. The generative AI model runs with fixed weights at inference time in the server.

The server uses a prompt construction module to convert structured data and state information into a prompt sentence suitable for the generative AI model. The prompt construction module reads aggregated metrics from the summary table, tax information from the tax information table, and inferred user intent from the natural language processing module. The prompt construction module also reads the emotion-derived control parameters from the emotion estimation module. The prompt construction module uses a set of templates and formatting logic to assemble these elements into a natural language string.

For example, the prompt construction module generates a prompt sentence such as:

“The user's annual income is 5,000,000 yen. The total medical expenses recorded in the transaction history are 180,000 yen. The user asked about the possibility of a medical expense deduction and is feeling stressed. Please evaluate eligibility for a medical expense deduction under applicable income tax rules and propose an optimal tax-saving strategy in simple, non-technical language.”

In another example, the prompt construction module generates a prompt sentence such as:

“User question: ‘Please explain this year's medical expense deduction.’ From the user's electronic payment history, extract medical expenses, calculate the deductible amount, and generate advice. If the user is stressed, use a simple and reassuring tone.”

In yet another example, when the user provides feedback, the prompt construction module generates a prompt sentence such as:

“The user thinks the previous strategy is too complex and wants a simpler, low-risk approach.

Using the same income and expense data, please propose a revised tax-saving strategy that reduces the number of required documents and minimizes audit risk, and explain it in three or four short paragraphs.”

By building prompt sentences directly from machine-readable structures rather than from free-form text, the server reduces the need for repeated parsing and conversion. The prompt construction module encodes precise numerical values, classifications, and control parameters into the prompt sentence. This results in more stable generative AI behavior because the generative AI model receives consistent, fully specified input that embeds the outcome of prior data processing modules.

The server uses a generative AI invocation module to call the generative AI model. The generative AI invocation module tokenizes the prompt sentence, encodes the tokens into numerical vectors, and feeds the token sequence to the generative AI model. The generative AI model computes, layer by layer, attention scores between tokens, aggregates contextual information, and outputs a probability distribution over the next token at each step. The generative AI invocation module uses a decoding strategy such as greedy decoding or beam search with constraints on length and repetition to generate a complete response sequence. The generative AI invocation module converts the token sequence back to text and returns the result as response information to other modules.

The server uses a post-processing module to inspect, validate, and transform the response information. The post-processing module parses the generated text to identify key recommendations, such as “claim medical expense deduction,” “reclassify expense type,” or “use specific allowance.” The post-processing module maps these textual recommendations back to internal representations using pattern matching and natural language understanding. The post-processing module applies rule information and verification logic to ensure that recommended values fall within plausible ranges. For instance, the post-processing module checks that recommended deduction amounts do not exceed aggregated expense totals and that total deductions do not exceed statutory caps stored in a rule table.

The post-processing module uses the emotion-derived control parameters to adjust the presentation form. When the explanation difficulty is low, the post-processing module generates an additional prompt sentence instructing the generative AI model to simplify the content, such as:

“Rewrite the following tax strategy in a very simple, step-by-step format, suitable for a user who is feeling confused, and avoid legal jargon: [insert previous AI output].”

The post-processing module then uses the generative AI invocation module to obtain a refined explanation. The post-processing module structures the final output into labeled sections such as “Summary,” “Steps to follow,” and “Notes,” which facilitates efficient display and reduces cognitive load on the user.

The server uses a feedback analysis module to process feedback information from the user. The feedback analysis module receives feedback text via the terminal, performs natural language processing to extract preference indicators and constraint conditions, and updates a user preference profile stored in the storage device. For example, the feedback analysis module marks that a particular user prefers “simple explanations,” “low documentation burden,” or “conservative strategies.” By storing preferences as persisted data, the server allows the prompt construction module to adjust future prompt sentences automatically without requiring the user to restate preferences.

The server uses a form generation module to create tax return documents or financial report documents. The form generation module reads the finalized strategy information and the underlying aggregated metrics from the summary table. The form generation module uses a form template definition that describes required fields for a particular jurisdiction's tax form or financial report. Each template entry includes a field identifier, a data type, a mapping rule from internal fields, and formatting rules. The form generation module computes final field values by applying mapping rules and numerical operations. For example, the form generation module computes taxable income as total income minus allowable deductions. The form generation module then populates a document structure, such as a hierarchical representation of sections and fields, and optionally renders the document into a displayable or printable format using a document rendering library. The server stores the generated document in the storage device and returns a document identifier to the terminal.

The server uses a learning module to improve system behavior over time. The learning module reads history information from the storage device, including past prompt sentences, generative AI responses, user feedback, and validation outcomes. The learning module analyzes this history to detect patterns such as prompt structures that lead to consistent, high-quality responses, or prompts that result in frequent corrections. The learning module updates internal parameters of the prompt construction rules, such as preferred phrasing, ordering of content, and inclusion or exclusion of certain fields, to reduce the number of iterations required for stable results. In some embodiments, the learning module also trains or fine-tunes an auxiliary model that predicts optimal prompt configurations based on context, thus further automating prompt sentence generation.

The system provides technical improvements over conventional approaches in multiple ways. The server reduces redundant conversions between structured data and natural language by centralizing structure-to-prompt transformation in the prompt construction module. The server reduces processing latency by using aggregated metrics as compact representations of large transaction sets, thereby decreasing the amount of text that must be embedded into a prompt sentence. The server improves consistency of generative AI output by encoding explicit control parameters related to emotion and preferences, which constrains the generative AI model's behavior without requiring additional user interaction. The server enhances accuracy by validating numerical recommendations against rule information before presenting them to the user and before generating formal documents. The server reduces communication load by transmitting concise identifiers and aggregated metrics between modules rather than raw transaction data, and by reducing the number of back-and-forth clarification steps through emotion-adaptive explanations.

The system employs non-conventional processing sequences. The server does not simply automate a human advisor's reasoning; instead, the server uses an explicit pipeline in which numerical aggregation, symbolic rule checking, neural emotion estimation, and transformer-based text generation are orchestrated in a machine-optimized manner. The server converts emotional and preference signals into machine-readable parameters that directly alter neural network inputs, which is not a direct analog to human reasoning. The server then uses a learning module to adjust prompt construction rules based on historical performance metrics, an operation that is inherently algorithmic and not easily replicated by manual tuning.

In alternative embodiments, the server configures the generative AI model differently. In one variation, the server uses a smaller domain-specific transformer model deployed locally to reduce dependence on external resources. In another variation, the server uses a hybrid model in which a rule-based engine pre-computes certain outcomes and the generative AI model is used only to generate user-friendly explanations. In yet another variation, the server uses a generative AI model that accepts structured key-value pairs as separate input channels, allowing the prompt construction module to encode data in both natural language and structured form.

In further embodiments, the server uses different architectures for the emotion estimation model.

In one embodiment, the server uses a convolutional neural network applied to spectrogram representations of audio to classify emotion. In another embodiment, the server uses a transformer encoder applied to tokenized text to classify emotion and intensity. In both cases, the server trains the emotion estimation model using supervised learning on labeled data with a loss function such as cross-entropy, and uses regularization techniques such as dropout and weight decay to improve generalization.

In additional embodiments, the server extends the form generation module to control external devices or services. For example, the server may transmit the generated tax return document via an electronic filing interface to a remote tax processing system. By mapping strategy information to standardized electronic filing formats and by automatically generating compliant documents, the server enables machine-to-machine communication that reduces manual data entry and associated errors.

Because the described modules operate as concrete data flows and algorithmic steps implemented on specific hardware and software components, the system surpasses a mere abstract idea. The server improves the functioning of the computer system itself by reducing repeated parsing operations, by structuring prompt sentence generation as a deterministic transformation from compact, structured data, and by dynamically adjusting generative model behavior using emotion-derived control parameters. The resulting improvements include faster processing of large transaction datasets, lower communication overhead, reduced error rates in generated documents, and more stable generative AI outputs requiring fewer iterations.

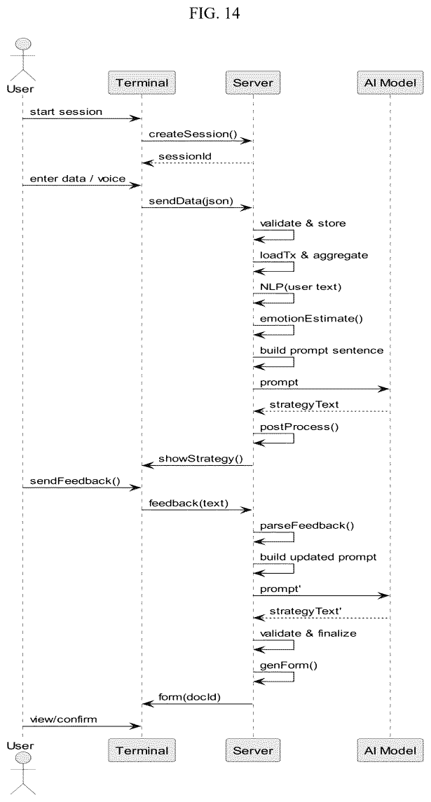

The following describes the processing flow using FIG. 14.

### Step 1

User activates an application on the terminal and initiates a tax or financial session.

Terminal displays an initial screen requesting login or identification and sends a session start request including a user identifier to the server.

Server receives the session start request as input and creates a session record in a session table with fields such as session_id, user_id, and start_timestamp as output.

Server writes the session record into the storage device so that all subsequent data and model outputs can be associated with this session.

### Step 2

User inputs tax information or financial information through the terminal.

Terminal receives text input values such as income amounts, expense descriptions, and deduction selections, and optionally records voice input via a microphone.

Terminal converts voice input into text using a speech-to-text engine and merges the transcription with typed text to form a unified JSON object as output.

Terminal sends the JSON object, including user_id, session_id, and field values, as input to the server via a network connection.

### Step 3

Server receives the JSON object containing raw user data as input and validates each field.

Server checks data types (for example, numeric, date, string), required fields, and value ranges using validation rules.

Server transforms valid data into normalized internal structures and rejects or flags invalid entries.

Server writes normalized records into tax information tables and transaction tables in the storage device as output, with keys linking them to user_id and session id.

### Step 4

Server retrieves electronic transaction information for the user from the storage device as input.

Server uses a data processing program to load the transaction records into an in-memory table structure.

Server performs data cleaning operations such as removing null records, normalizing dates, and standardizing currency formats.

Server classifies each transaction into a category (for example, medical, business, personal) based on merchant_code, category_code, and raw_description, using rule-based mappings and lookup tables.

Server aggregates classified transactions by category and time period, computing totals such as total_medical_expense and total_business_expense as output.

Server stores aggregated metrics into a summary table for use in later steps.

### Step 5

Server receives natural language input text from the terminal as input, representing user questions or explanations.

Server runs a natural language processing module to tokenize the text, tag parts of speech, and identify entities such as monetary amounts, dates, and tax concepts.

Server extracts user intent (for example, “wants to claim medical expense deduction”) and inquiry content (for example, “explanation of medical expense rules”) from the parsed structure.

Server maps extracted entities to structured fields in the tax information tables and updates or inserts normalized records as output, thereby supplementing existing tax information.

### Step 6

Server receives user text or acoustic feature data from the terminal as input for emotion estimation.

Server feeds tokenized text or acoustic feature vectors into an emotion estimation model, which computes internal activations and outputs a probability distribution over emotion labels.

Server selects the most probable emotion label, such as stress or confusion, and computes an explanation difficulty level and dialog tone parameter from a predefined mapping.

Server stores the emotion label and derived control parameters in a session state record as output.

### Step 7

Server collects multiple inputs: aggregated metrics from the summary table, structured tax information, user intent, and emotion-derived control parameters.

Server constructs a structured context object that contains key values such as income amount, total medical expenses, candidate deductible items, and user goals.

Server uses a prompt construction module to combine this context with template phrases to generate a natural language prompt sentence as output.

Server ensures that the prompt sentence explicitly encodes relevant numerical values, categories, and tone requirements, for example: “The user's annual income is 5,000,000 yen. The total medical expenses recorded in the transaction history are 180,000 yen. The user asked about the possibility of a medical expense deduction and is feeling stressed. Please evaluate eligibility for a medical expense deduction under applicable income tax rules and propose an optimal tax-saving strategy in simple, non-technical language.”

### Step 8

Server receives the constructed prompt sentence and associated structured context as input to a generative AI model.

Server tokenizes the prompt sentence into a sequence of tokens and converts them into numeric embeddings.

Server feeds the embeddings into the generative AI model, which processes them through multiple layers and computes a probability distribution over output tokens at each position.

Server applies a decoding strategy to generate a sequence of tokens representing a response, and converts the token sequence back into a text response as output.

Server stores the prompt sentence and response text in a prompt history table for later analysis.

### Step 9

Server passes the response text from the generative AI model as input to a post-processing module.

Server parses the response text to detect recommended actions, such as “claim medical expense deduction” and “reclassify certain expenses.”

Server maps these textual recommendations to internal identifiers and cross-checks them against aggregated metrics and rule information stored in rule tables.

Server adjusts or flags any recommendation that violates logical or regulatory constraints, for example by capping deduction amounts to computed totals.

Server generates a structured strategy object that includes validated recommendations, associated numerical values, and explanatory text as output.

### Step 10

Server uses the emotion-derived control parameters as input to adjust the explanation format of the strategy object.

Server decides whether to request a simplified or detailed explanation from the generative AI model.

Server, when necessary, constructs a secondary prompt sentence such as “Rewrite the following tax strategy in a very simple, step-by-step format, suitable for a user who is feeling confused, and avoid legal jargon: [previous strategy text].”

Server sends this secondary prompt sentence as input to the generative AI model, receives a refined explanation, and replaces the explanation portion of the strategy object with the refined text as output.

Server formats the final strategy object into presentation sections such as “Summary” and “Steps,” and sends this formatted strategy to the terminal.

### Step 11

Terminal receives the formatted strategy information from the server as input.

Terminal renders the strategy summary and detailed steps on the display, using headings, bullet points, and emphasis to enhance readability.

Terminal optionally uses a text-to-speech component to convert the text into audio and plays it through the speaker.

User reads or listens to the proposed tax or financial strategy and mentally evaluates whether the explanation is understandable and acceptable as output in terms of user perception.

### Step 12

User provides feedback using the terminal, for example by typing “This is too complex” or “I prefer a safer option,” or by selecting predefined feedback buttons.

Terminal packages the feedback text, along with session_id and strategy identifier, into a feedback message as output.

Terminal transmits the feedback message to the server as input.

### Step 13

Server receives the feedback message containing feedback text as input.

Server uses the natural language processing module to parse the feedback and extract preference indicators and constraint conditions, such as “simplicity,” “low risk,” or “reduced documentation.”

Server updates a user preference profile in the storage device with these indicators as output, linking them to user_id.

Server constructs an updated prompt sentence that reflects the extracted preferences, for example: “The user thinks the previous strategy is too complex and wants a simpler, low-risk approach. Using the same income and expense data, please propose a revised tax-saving strategy that reduces the number of required documents and minimizes audit risk, and explain it in three or four short paragraphs.”

Server sends the updated prompt sentence to the generative AI model and obtains a revised strategy, then repeats post-processing and formatting as in previous steps.

### Step 14

Server, after the strategy has been finalized, retrieves aggregated metrics and validated recommendation data as input for form generation.

Server loads a form template definition that specifies required fields for a tax return or financial report and mapping rules from internal fields to form fields.

Server applies mapping rules and arithmetic operations to compute item values, such as taxable income equals total income minus allowable deductions.

Server populates a form data structure with computed item values and generates a document representation (for example, a structured form or PDF) as output.

Server stores the generated document and returns a document identifier and access information to the terminal.

### Step 15

Terminal receives the document identifier and access information as input from the server.

Terminal requests the generated tax return document or financial report from the server and downloads the document data.

Terminal presents a preview of the document on the display, allowing the user to scroll through pages and inspect each field.

User reviews the document and either accepts it or requests corrections, for example by entering “Change the contact address” or “Clarify this item” as output feedback, which can initiate another iteration of the processing pipeline if necessary.

### Step 16

Server periodically or on demand reads history information from the storage device as input, including previous prompt sentences, responses, validation outcomes, and user feedback.

Server executes a learning module that analyzes correlations between prompt patterns and quality indicators such as frequency of corrections and validation errors.

Server adjusts parameters of prompt construction templates and rule thresholds, for example by prioritizing inclusion of certain numeric details or reordering explanation segments, as output updated configuration data.

Server stores updated configuration data in the storage device so that future executions of the prompt construction module and validation logic can operate more efficiently and accurately, thereby improving overall system performance over time.

The data generation model 58 is a so-called generative artificial intelligence (AI). Examples of the data generation model 58 include generative Als such as ChatGPT (registered trademark) (Internet search <URL: https://openai.com/blog/chatgpt>) and the like. The data generation model 58 is obtained by performing deep learning with a neural network. The data generation model 58 is input with a prompt including an instruction, and is input with inference data such as audio data representing speech, text data representing text, image data representing images (for example, still image data or video data), and the like. The data generation model 58 takes the input inference data, performs inference according to the instruction indicated in the prompt, and outputs an inference result in one or more data format from out of audio data, text data, image data, or the like. The data generation model 58 includes, for example, a text generative AI, an image generative AI, a multimodal generative AI, or the like. Reference here to inference indicates, for example, analysis, classification, prediction, and/or abstraction etc. The specific processing unit 290 performs the specific processing referred to above while using the data generation model 58. The data generation model 58 may be a model fine-tuned so as to output an inference result from a prompt not including an instruction, and in such cases the data generation model 58 is able to output an inference result from the prompt not including an instruction. There are plural types of the data generation model 58 included in the data processing device 12 or the like, and the data generation models 58 include an AI other than a generative AI. An AI other than a generative AI is, for example, a linear regression, a logistic regression, a decision tree, a random forest, a support vector machine (SVM), a k-means clustering, a convolutional neural network (CNN), a recurrent neural network (RNN), a generative adversarial network (GAN), a naïve Bayes, or the like and is capable of performing various processing, however there is no limitation to such examples. The AI may be an AI agent. Moreover, when the processing of each of the units mentioned above is performed by an AI, this processing is partly or entirely performed by the AI, however there is no limitation to such examples. Moreover, processing executed by an AI including a generative AI may be switched to rule-based processing, and rule-based processing may be switched to processing executed by an AI including a generative AI.

Moreover, although the processing by the data processing system 10 described above was executed by the specific processing unit 290 of the data processing device 12 or by the control unit 46A of the smart device 14, the processing may be executed by a specific processing unit 290 of the data processing device 12 and a control unit 46A of the smart device 14. Moreover, the specific processing unit 290 of the data processing device 12 acquires and collects information needed for processing from the smart device 14 or from an external device or the like, and the smart device 14 acquires and collects information needed for processing from the data processing device 12 or from an external device or the like.

For example, a collection unit is implemented by the control unit 46A of the smart device 14 and/or by the specific processing unit 290 of the data processing device 12. For example, an acquisition unit acquires number-of-steps data using the camera 42 and/or the communication I/F 44 of the smart device 14, and the number-of-steps data is processed by the specific processing unit 290 of the data processing device 12. For example, an analysis unit implemented by the specific processing unit 290 of the data processing device 12 analyzes data from the collection unit and the acquisition unit. For example, a generation unit implemented by the specific processing unit 290 of the data processing device 12 generates a cooking menu using a generative AI. For example, a supply unit implemented by the output device 40 of the smart device 14 and/or the specific processing unit 290 of the data processing device 12 supplies the generated cooking menu to the user. Correspondence relationships of each unit to devices and control units are not limited to the examples described above, and various modifications thereof are possible.

The above exemplary embodiment gives an implementation example in which the specific processing is performed by the data processing device 12, however technology disclosed herein is not limited thereto, and the specific processing may be performed by the smart device 14.

### Second Exemplary Embodiment

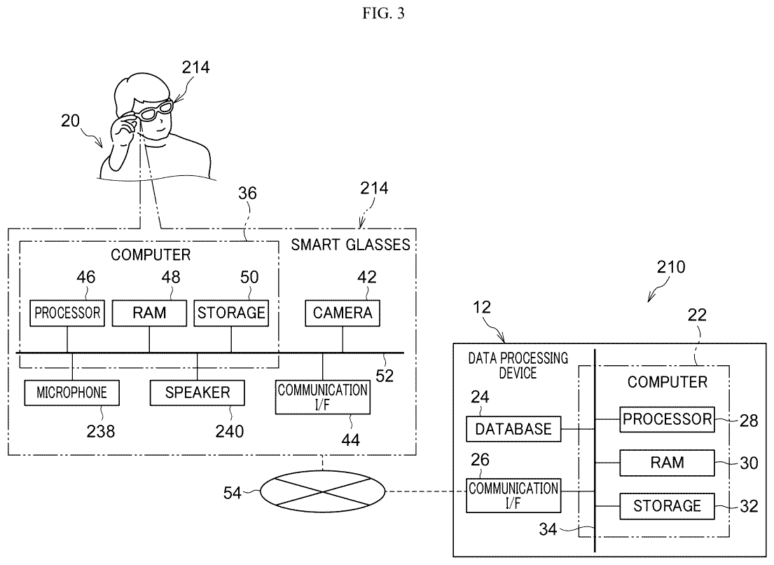

FIG. 3 illustrates an example of a configuration of a data processing system 210 according to a second exemplary embodiment.

As illustrated in FIG. 3, the data processing system 210 includes a data processing device 12 and smart glasses 214. A server is an example of the data processing device 12.

The data processing device 12 includes a computer 22, a database 24, and a communication I/F 26. The computer 22 is an example of a “computer” according to technology disclosed herein. The computer 22 includes a processor 28, RAM 30, and storage 32. The processor 28, the RAM 30, and the storage 32 are connected to a bus 34. The database 24 and the communication I/F 26 are also connected to the bus 34. The communication I/F 26 is connected to a network 54. Examples of the network 54 include a Wide Area Network (WAN) and/or a local area network (LAN).

The smart glasses 214 include a computer 36, a microphone 238, a speaker 240, a camera 42, and a communication I/F 44. The computer 36 includes a processor 46, RAM 48, and storage 50. The processor 46, the RAM 48, and the storage 50 are connected to a bus 52. The microphone 238, the speaker 240, the camera 42, and the communication I/F 44 are also connected to the bus 52.

The microphone 238 receives an instruction or the like from a user 20 by receiving speech uttered by the user 20. The microphone 238 captures the speech uttered by the user 20, converts the captured speech into audio data, and outputs the audio data to the processor 46. The speaker 240 outputs audio under instruction from the processor 46.

The camera 42 is a compact digital camera installed with an optical system such as a lens, an aperture, a shutter, and the like, and with an imaging device such as a complementary metal-oxide semiconductor (CMOS) image sensor or a charge coupled device (CCD) image sensor or the like. The camera 42 images the surroundings of the user 20 (for example, an imaging range defined by an angle of view equivalent to the width of visual field of an ordinary healthy subject).

The communication I/F 44 is connected to the network 54. The communication I/F 44 and the communication I/F 26 perform the role of exchanging various information between the processor 46 and the processor 28 over the network 54. The exchange of various information between the processor 46 and the processor 28 is performed in a secure state using the communication I/F 44 and the communication I/F 26.

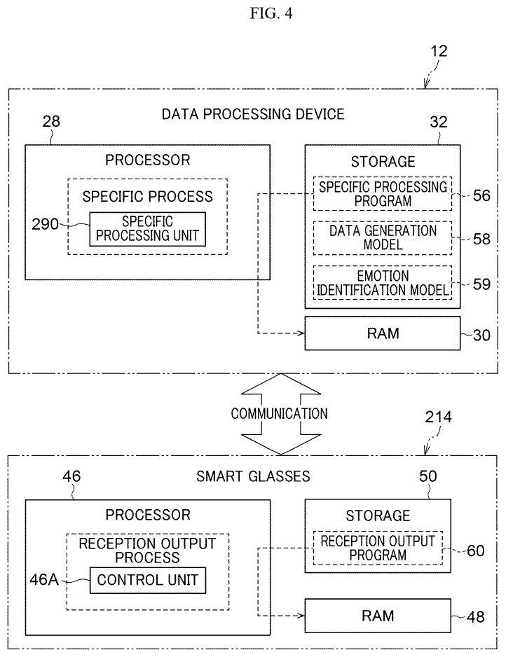

FIG. 4 illustrates an example of relevant functions of the data processing device 12 and the smart glasses 214. As illustrated in FIG. 4, specific processing is performed by the processor 28 in the data processing device 12. A specific processing program 56 is stored in the storage 32.

The specific processing program 56 is an example of a “program” according to technology disclosed herein. The processor 28 reads the specific processing program 56 from the storage 32, and in the RAM 30 executes the read specific processing program 56. The specific processing is implemented by the processor 28 operating as the specific processing unit 290 according to the specific processing program 56 executed in the RAM 30.

The data generation model 58 and the emotion identification model 59 are stored in the storage 32. The data generation model 58 and the emotion identification model 59 are employed by the specific processing unit 290. The specific processing unit 290 uses the emotion identification model 59 to estimate an emotion of a user, and is able to perform the specific processing using the user emotion. In an emotion estimation function (emotion identification function) that uses the emotion identification model 59, various estimations, predictions, and the like are performed related to emotions of the user, include estimating and predicting the emotion of the user, however, there is no limitation to such examples. Moreover, estimation and prediction of emotion also includes, for example, analyzing (parsing) emotions and the like.

Reception and output processing is performed by the processor 46 in the smart glasses 214. A reception and output program 60 is stored in the storage 50. The processor 46 reads the reception and output program 60 from the storage 50 and in the RAM 48 executes the read reception and output program 60. The reception and output processing is implemented by the processor 46 operating as the control unit 46A according to the reception and output program 60 executed in the RAM 48. Note that a configuration may be adopted in which the smart glasses 214 include a data generation model and an emotion identification model similar to the data generation model 58 and the emotion identification model 59, and processing similar to the specific processing unit 290 is performed using these models.

Next, description follows regarding the specific processing by the specific processing unit 290 of the data processing device 12. The units of the system described below are implemented by the data processing device 12 and the smart glasses 214. In the following description the data processing device 12 is called a “server”, and the smart glasses 214 is called a “terminal”.

### Example 1

Explanation of flow will be omitted due to being similar to a flow of the specific processing in Example 1 as described in the first exemplary embodiment above.

### Application Example 1

Explanation of flow will be omitted due to being similar to a flow of the specific processing in Application Example 1 as described in the first exemplary embodiment above.

### Example 2

Explanation of flow will be omitted due to being similar to a flow of the specific processing in Example 2 as described in the first exemplary embodiment above.

### Application Example 2

Explanation of flow will be omitted due to being similar to a flow of the specific processing in Application Example 2 as described in the first exemplary embodiment above.

The specific processing unit 290 transmits a result of the specific processing to the smart glasses 214. The control unit 46A in the smart glasses 214 outputs the specific processing result to the speaker 240. The microphone 238 acquires audio representing user input in response to the specific processing result. The control unit 46A transmits audio data representing the user input as acquired by the microphone 238 to the data processing device 12. The specific processing unit 290 in the data processing device 12 acquires the audio data.

The data generation model 58 is a so-called generative artificial intelligence (AI). Examples of the data generation model 58 include generative Als such as ChatGPT (registered trademark) (Internet search <URL: https://openai.com/blog/chatgpt>) and the like. The data generation model 58 is obtained by performing deep learning with a neural network. The data generation model 58 is input with a prompt including an instruction, and is input with inference data such as audio data representing speech, text data representing text, image data representing images (for example, still image data or video data), and the like. The data generation model 58 takes the input inference data, performs inference according to the instruction indicated in the prompt, and outputs an inference result in one or more data format from out of audio data, text data, image data, or the like. The data generation model 58 includes, for example, a text generative AI, an image generative AI, a multimodal generative AI, or the like. Reference here to inference indicates, for example, analysis, classification, prediction, and/or abstraction etc. The specific processing unit 290 performs the specific processing referred to above while using the data generation model 58. The data generation model 58 may be a model fine-tuned so as to output an inference result from a prompt not including an instruction, and in such cases the data generation model 58 is able to output an inference result from the prompt not including an instruction. There are plural types of the data generation model 58 included in the data processing device 12 or the like, and the data generation models 58 include an AI other than a generative AI. An AI other than a generative AI is, for example, a linear regression, a logistic regression, a decision tree, a random forest, a support vector machine (SVM), a k-means clustering, a convolutional neural network (CNN), a recurrent neural network (RNN), a generative adversarial network (GAN), a naïve Bayes, or the like and is capable of performing various processing, however there is no limitation to such examples. The AI may be an AI agent. Moreover, when the processing of each of the units mentioned above is performed by an AI, this processing is partly or entirely performed by the AI, however there is no limitation to such examples. Moreover, processing executed by an AI including a generative AI may be switched to rule-based processing, and rule-based processing may be switched to processing executed by an AI including a generative AI.

Although the processing by the data processing system 10 described above is executed by the specific processing unit 290 of the data processing device 12 or by the control unit 46A of the smart glasses 214, the processing may be executed by a specific processing unit 290 of the data processing device 12 and a control unit 46A of the smart glasses 214. Moreover, the specific processing unit 290 of the data processing device 12 acquires and collects information needed for processing from the smart glasses 214 or from an external device or the like, and the smart glasses 214 acquires and collects information needed for processing from the data processing device 12 or from an external device or the like.

For example, the collection unit is implemented by the control unit 46A of the smart glasses 214 and/or by the specific processing unit 290 of the data processing device 12. For example, an acquisition unit acquires number-of-steps data using the camera 42 and/or the communication I/F 44 of the smart glasses 214, and the number-of-steps data is processed by the specific processing unit 290 of the data processing device 12. For example, an analysis unit implemented by the specific processing unit 290 of the data processing device 12 analyzes data from the collection unit and the acquisition unit. For example, a generation unit implemented by the specific processing unit 290 of the data processing device 12 generates a cooking menu using a generative AI. For example, a supply unit implemented by the speaker 240 of the smart glasses 214 and/or the specific processing unit 290 of the data processing device 12 supplies the generated cooking menu to the user. Correspondence relationships of each unit to devices and control units are not limited to the examples described above, and various modifications thereof are possible.

The above exemplary embodiment gives an implementation example in which the specific processing is performed by the data processing device 12, however technology disclosed herein is not limited thereto, and the specific processing may be performed by the smart glasses 214.

### Third Exemplary Embodiment

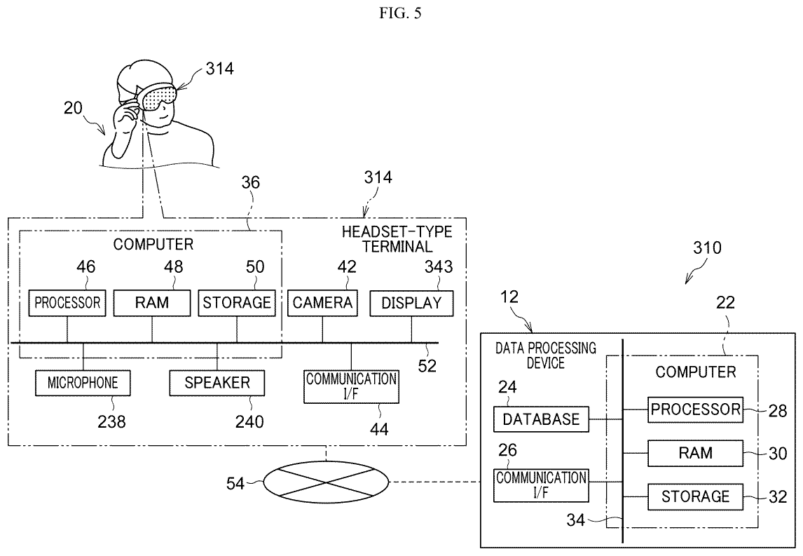

FIG. 5 illustrates an example of a configuration of a data processing system 310 according to a third exemplary embodiment.

As illustrated in FIG. 5, the data processing system 310 includes a data processing device 12 and a headset-type terminal 314. A server is an example of the data processing device 12.

The data processing device 12 includes a computer 22, a database 24, and a communication I/F 26. The computer 22 is an example of a “computer” according to technology disclosed herein. The computer 22 includes a processor 28, RAM 30, and storage 32. The processor 28, the RAM 30, and the storage 32 are connected to a bus 34. The database 24 and the communication I/F 26 are also connected to the bus 34. The communication I/F 26 is connected to a network 54. Examples of the network 54 include a Wide Area Network (WAN) and/or a local area network (LAN).

The headset-type terminal 314 includes a computer 36, a microphone 238, a speaker 240, a camera 42, a communication I/F 44, and a display 343. The computer 36 includes a processor 46, RAM 48, and storage 50. The processor 46, the RAM 48, and the storage 50 are connected to a bus 52. The microphone 238, the speaker 240, the camera 42, the display 343, and the communication I/F 44 are also connected to the bus 52.

The microphone 238 receives an instruction or the like from a user 20 by receiving speech uttered by the user 20. The microphone 238 captures the speech uttered by the user 20, converts the captured speech into audio data, and outputs the audio data to the processor 46. The speaker 240 outputs audio under instruction from the processor 46.

The camera 42 is a compact digital camera installed with an optical system such as a lens, an aperture, a shutter, and the like, and with an imaging device such as a complementary metal-oxide semiconductor (CMOS) image sensor or a charge coupled device (CCD) image sensor or the like. The camera 42 images the surroundings of the user 20 (for example, an imaging range defined by an angle of view equivalent to the width of visual field of an ordinary healthy subject).

The communication I/F 44 is connected to the network 54. The communication I/F 44 and the communication I/F 26 perform the role of exchanging various information between the processor 46 and the processor 28 over the network 54. The exchange of various information between the processor 46 and the processor 28 is performed in a secure state using the communication I/F 44 and the communication I/F 26.

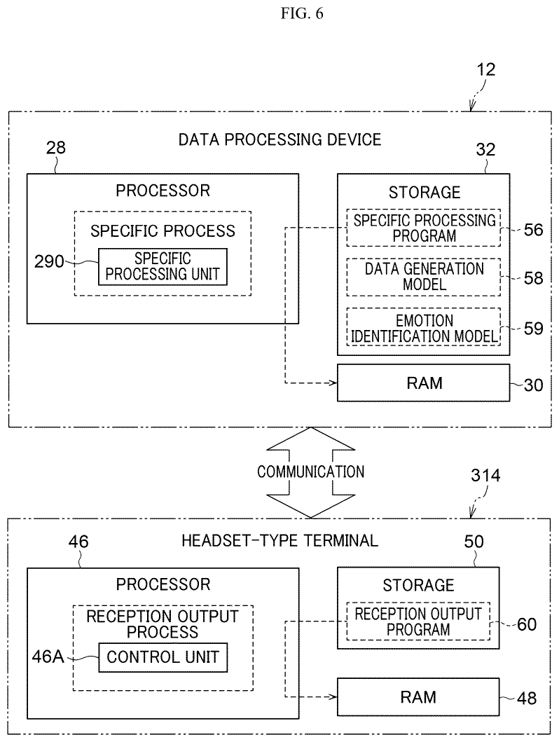

FIG. 6 illustrates an example of relevant functions of the data processing device 12 and the headset-type terminal 314. As illustrated in FIG. 6, specific processing is performed by the processor 28 in the data processing device 12. A specific processing program 56 is stored in the storage 32.

The specific processing program 56 is an example of a “program” according to technology disclosed herein. The processor 28 reads the specific processing program 56 from the storage 32, and in the RAM 30 executes the read specific processing program 56. The specific processing is implemented by the processor 28 operating as the specific processing unit 290 according to the specific processing program 56 executed in the RAM 30.

The data generation model 58 and the emotion identification model 59 are stored in the storage 32. The data generation model 58 and the emotion identification model 59 are employed by the specific processing unit 290.

Reception and output processing is performed by the processor 46 in the headset-type terminal 314. A reception and output program 60 is stored in the storage 50. The processor 46 reads the reception and output program 60 from the storage 50, and in the RAM 48 executes the read reception and output program 60. The reception and output processing is implemented by the processor 46 operating as the control unit 46A according to the reception and output program 60 executed in the RAM 48.

Next, description follows regarding the specific processing by the specific processing unit 290 of the data processing device 12. The units of the system described below are implemented by the data processing device 12 and the headset-type terminal 314. In the following description the data processing device 12 is called a “server”, and the headset-type terminal 314 is called a “terminal”.

### Example 1

Explanation of flow will be omitted due to being similar to a flow of the specific processing in Example 1 as described in the first exemplary embodiment above.

### Application Example 1

Explanation of flow will be omitted due to being similar to a flow of the specific processing in Application Example 1 as described in the first exemplary embodiment above.

### Example 2

Explanation of flow will be omitted due to being similar to a flow of the specific processing in Example 2 as described in the first exemplary embodiment above.

### Application Example 2

Explanation of flow will be omitted due to being similar to a flow of the specific processing in Application Example 2 as described in the first exemplary embodiment above.

The specific processing unit 290 transmits a result of the specific processing to the headset-type terminal 314. In the headset-type terminal 314, the control unit 46A outputs the result of the specific processing to the speaker 240 and the display 343. The microphone 238 acquires audio representing user input in response to the specific processing result. The control unit 46A transmits audio data representing the user input as acquired by the microphone 238 to the data processing device 12. The specific processing unit 290 in the data processing device 12 acquires the audio data.

The data generation model 58 is a so-called generative artificial intelligence (AI). Examples of the data generation model 58 include generative Als such as ChatGPT (registered trademark) (Internet search <URL: https://openai.com/blog/chatgpt>) and the like. The data generation model 58 is obtained by performing deep learning with a neural network. The data generation model 58 is input with a prompt including an instruction, and is input with inference data such as audio data representing speech, text data representing text, image data representing images (for example, still image data or video data), and the like. The data generation model 58 takes the input inference data, performs inference according to the instruction indicated in the prompt, and outputs an inference result in one or more data format from out of audio data, text data, image data, or the like. The data generation model 58 includes, for example, a text generative AI, an image generative AI, a multimodal generative AI, or the like. Reference here to inference indicates, for example, analysis, classification, prediction, and/or abstraction etc. The specific processing unit 290 performs the specific processing referred to above while using the data generation model 58. The data generation model 58 may be a model fine-tuned so as to output an inference result from a prompt not including an instruction, and in such cases the data generation model 58 is able to output an inference result from the prompt not including an instruction. There are plural types of the data generation model 58 included in the data processing device 12 or the like, and the data generation models 58 include an AI other than a generative AI. An AI other than a generative AI is, for example, a linear regression, a logistic regression, a decision tree, a random forest, a support vector machine (SVM), a k-means clustering, a convolutional neural network (CNN), a recurrent neural network (RNN), a generative adversarial network (GAN), a naïve Bayes, or the like and is capable of performing various processing, however there is no limitation to such examples. The AI may be an AI agent. Moreover, when the processing of each of the units mentioned above is performed by an AI, this processing is partly or entirely performed by the AI, however there is no limitation to such examples. Moreover, processing executed by an AI including a generative AI may be switched to rule-based processing, and rule-based processing may be switched to processing executed by an AI including a generative AI.

Although the processing by the data processing system 10 described above is executed by the specific processing unit 290 of the data processing device 12 or by the control unit 46A of the headset-type terminal 314, the processing may be executed by a specific processing unit 290 of the data processing device 12 and a control unit 46A of the headset-type terminal 314. Moreover, the specific processing unit 290 of the data processing device 12 acquires and collects information needed for processing from the headset-type terminal 314 or from an external device or the like, and the headset-type terminal 314 acquires and collects information needed for processing from the data processing device 12 or from an external device or the like.

For example, the collection unit is implemented by the control unit 46A of the headset-type terminal 314 and/or by the specific processing unit 290 of the data processing device 12. For example, an acquisition unit acquires number-of-steps data using the camera 42 and/or the communication I/F 44 of the headset-type terminal 314, and the number-of-steps data is processed by the specific processing unit 290 of the data processing device 12. For example, an analysis unit implemented by the specific processing unit 290 of the data processing device 12 analyzes data from the collection unit and the acquisition unit. For example, a generation unit implemented by the specific processing unit 290 of the data processing device 12 generates a cooking menu using a generative AI. For example, a supply unit implemented by the speaker 240 and the display 343 of the headset-type terminal 314 and/or the specific processing unit 290 of the data processing device 12 supplies the generated cooking menu to the user. Correspondence relationships of each unit to devices and control units are not limited to the examples described above, and various modifications thereof are possible.

The above exemplary embodiment gives an implementation example in which the specific processing is performed by the data processing device 12, however technology disclosed herein is not limited thereto, and the specific processing may be performed by the headset-type terminal 314.

### Fourth Exemplary Embodiment

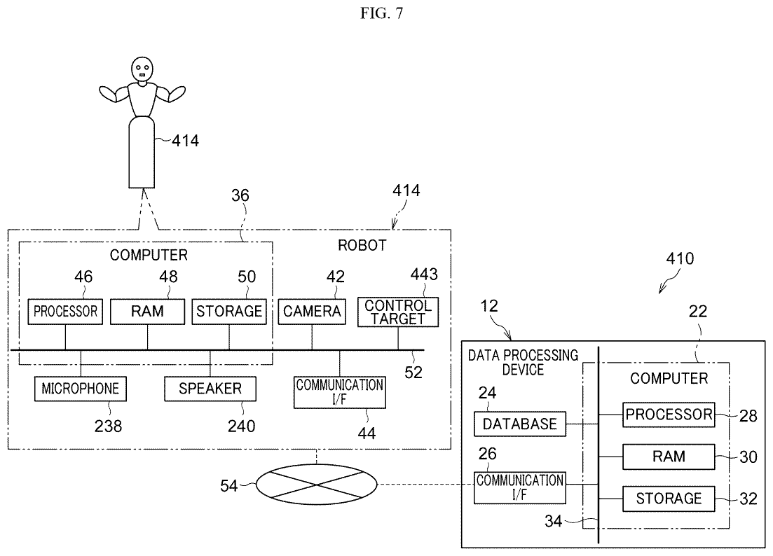

FIG. 7 illustrates an example of a configuration of a data processing system 410 according to a fourth exemplary embodiment

As illustrated in FIG. 7, the data processing system 410 includes a data processing device 12 and a robot 414. A server is an example of the data processing device 12.

The data processing device 12 includes a computer 22, a database 24, and a communication I/F 26. The computer 22 is an example of a “computer” according to technology disclosed herein. The computer 22 includes a processor 28, RAM 30, and storage 32. The processor 28, the RAM 30, and the storage 32 are connected to a bus 34. The database 24 and the communication I/F 26 are also connected to the bus 34. The communication I/F 26 is connected to a network 54. Examples of the network 54 include a Wide Area Network (WAN) and/or a local area network (LAN).

The robot 414 includes a computer 36, a microphone 238, a speaker 240, a camera 42, a communication I/F 44, and a control target 443. The computer 36 includes a processor 46, RAM 48, and storage 50. The processor 46, the RAM 48, and the storage 50 are connected to a bus 52. The microphone 238, the speaker 240, the camera 42, the control target 443, and the communication I/F 44 are also connected to the bus 52.

The microphone 238 receives an instruction or the like from a user 20 by receiving speech uttered by the user 20. The microphone 238 captures the speech uttered by the user 20, converts the captured speech into audio data, and outputs the audio data to the processor 46. The speaker 240 outputs audio under instruction from the processor 46.

The camera 42 is a compact digital camera installed with an optical system such as a lens, an aperture, a shutter, and the like, and with an imaging device such as a complementary metal-oxide semiconductor (CMOS) image sensor or a charge coupled device (CCD) image sensor or the like. The camera 42 images the surroundings of the robot 414 (for example, with an imaging range defined by an angle of view equivalent to the width of visual field of an ordinary healthy subject).

The communication I/F 44 is connected to the network 54. The communication I/F 44 and the communication I/F 26 perform the role of exchanging various information between the processor 46 and the processor 28 over the network 54. The exchange of various information between the processor 46 and the processor 28 is performed in a secure state using the communication I/F 44 and the communication I/F 26.

The control target 443 includes a display device, eye LEDs, and motors to drive arms, hands, feet, and the like. The posture and gesture of the robot 414 are controlled by controlling the motors of the arms, hands, feet, and the like. Part of an emotion of the robot 414 can be expressed by controlling these motors. Moreover, a facial expression of the robot 414 can be represented by controlling an illumination state of the eye LEDs of the robot 414.

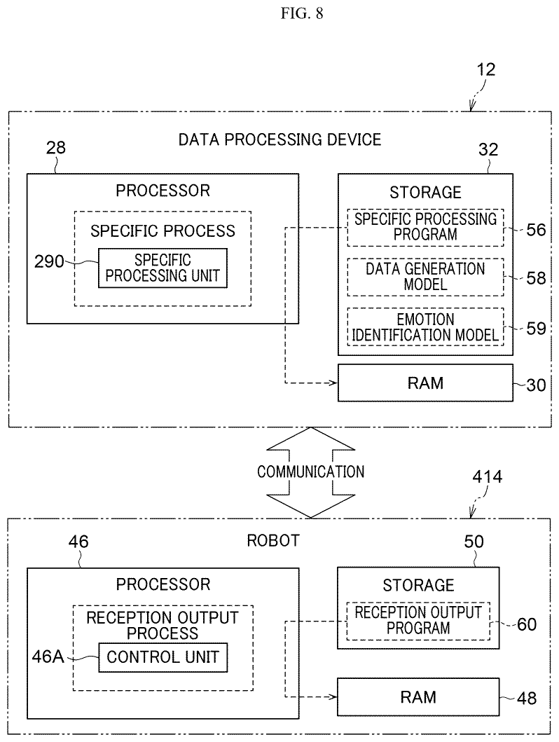

FIG. 8 illustrates an example of relevant functions of the data processing device 12 and the robot 414. As illustrated in FIG. 8, specific processing is performed by the processor 28 in the data processing device 12. A specific processing program 56 is stored in the storage 32.

The specific processing program 56 is an example of a “program” according to technology disclosed herein. The processor 28 reads the specific processing program 56 from the storage 32, and in the RAM 30 executes the read specific processing program 56. The specific processing is implemented by the processor 28 operating as the specific processing unit 290 according to the specific processing program 56 executed in the RAM 30.

The data generation model 58 and the emotion identification model 59 are stored in the storage 32. The data generation model 58 and the emotion identification model 59 are employed by the specific processing unit 290.

Reception and output processing is performed by the processor 46 in the robot 414. A reception and output program 60 is stored in the storage 50. The processor 46 reads the reception and output program 60 from the storage 50, and in the RAM 48 executes the read reception and output program 60. The reception and output processing is implemented by the processor 46 operating as the control unit 46A according to the reception and output program 60 executed in the RAM 48.

Next, description follows regarding the specific processing by the specific processing unit 290 of the data processing device 12. The units of the system described below are implemented by the data processing device 12 and the robot 414. In the following description the data processing device 12 is called a “server”, and the robot 414 is called a “terminal”.

### Example 1

Explanation of flow will be omitted due to being similar to a flow of the specific processing in Example 1 as described in the first exemplary embodiment above.

### Application Example 1

Explanation of flow will be omitted due to being similar to a flow of the specific processing in Application Example 1 as described in the first exemplary embodiment above.

### Example 2

Explanation of flow will be omitted due to being similar to a flow of the specific processing in Example 2 as described in the first exemplary embodiment above.

### Application Example 2

Explanation of flow will be omitted due to being similar to a flow of the specific processing in Application Example 2 as described in the first exemplary embodiment above.

The specific processing unit 290 transmits a result of the specific processing to the robot 414. In the robot 414, the control unit 46A outputs the result of the specific processing to the speaker 240 and the control target 443. The microphone 238 acquires audio representing user input in response to the specific processing result. The control unit 46A transmits audio data representing the user input as acquired by the microphone 238 to the data processing device 12. The specific processing unit 290 in the data processing device 12 acquires the audio data.

The data generation model 58 is a so-called generative artificial intelligence (AI). Examples of the data generation model 58 include generative Als such as ChatGPT (registered trademark) (Internet search <URL: https://openai.com/blog/chatgpt>) and the like. The data generation model 58 is obtained by performing deep learning with a neural network. The data generation model 58 is input with a prompt including an instruction, and is input with inference data such as audio data representing speech, text data representing text, image data representing images (for example, still image data or video data), and the like. The data generation model 58 takes the input inference data, performs inference according to the instruction indicated in the prompt, and outputs an inference result in one or more data format from out of audio data, text data, image data, or the like. The data generation model 58 includes, for example, a text generative AI, an image generative AI, a multimodal generative AI, or the like. Reference here to inference indicates, for example, analysis, classification, prediction, and/or abstraction etc. The specific processing unit 290 performs the specific processing referred to above while using the data generation model 58. The data generation model 58 may be a model fine-tuned so as to output an inference result from a prompt not including an instruction, and in such cases the data generation model 58 is able to output an inference result from the prompt not including an instruction. There are plural types of the data generation model 58 included in the data processing device 12 or the like, and the data generation models 58 include an AI other than a generative AI. An AI other than a generative AI is, for example, a linear regression, a logistic regression, a decision tree, a random forest, a support vector machine (SVM), a k-means clustering, a convolutional neural network (CNN), a recurrent neural network (RNN), a generative adversarial network (GAN), a naïve Bayes, or the like and is capable of performing various processing, however there is no limitation to such examples. The AI may be an AI agent. Moreover, when the processing of each of the units mentioned above is performed by an AI, this processing is partly or entirely performed by the AI, however there is no limitation to such examples. Moreover, processing executed by an AI including a generative AI may be switched to rule-based processing, and rule-based processing may be switched to processing executed by an AI including a generative AI.

Although the processing by the data processing system 10 described above is executed by the specific processing unit 290 of the data processing device 12 or by the control unit 46A of the robot 414, the processing may be executed by a specific processing unit 290 of the data processing device 12 and a control unit 46A of the robot 414. Moreover, the specific processing unit 290 of the data processing device 12 acquires and collects information needed for processing from the robot 414 or from an external device or the like, and the robot 414 acquires and collects information needed for processing from the data processing device 12 or from an external device or the like.

For example, the collection unit is implemented by the control unit 46A of the robot 414 and/or by the specific processing unit 290 of the data processing device 12. For example, an acquisition unit acquires number-of-steps data using the camera 42 and/or the communication I/F 44 of the robot 414, and the number-of-steps data is processed by the specific processing unit 290 of the data processing device 12. For example, an analysis unit implemented by the specific processing unit 290 of the data processing device 12 analyzes data from the collection unit and the acquisition unit. For example, a generation unit implemented by the specific processing unit 290 of the data processing device 12 generates a cooking menu using a generative AI. For example, a supply unit implemented by the speaker 240 and the control target 443 of the robot 414 and/or the specific processing unit 290 of the data processing device 12 supplies the generated cooking menu to the user. Correspondence relationships of each unit to devices and control units are not limited to the examples described above, and various modifications thereof are possible.

The above exemplary embodiment gives an implementation example in which the specific processing is performed by the data processing device 12, however technology disclosed herein is not limited thereto, and the specific processing may be performed by the robot 414.

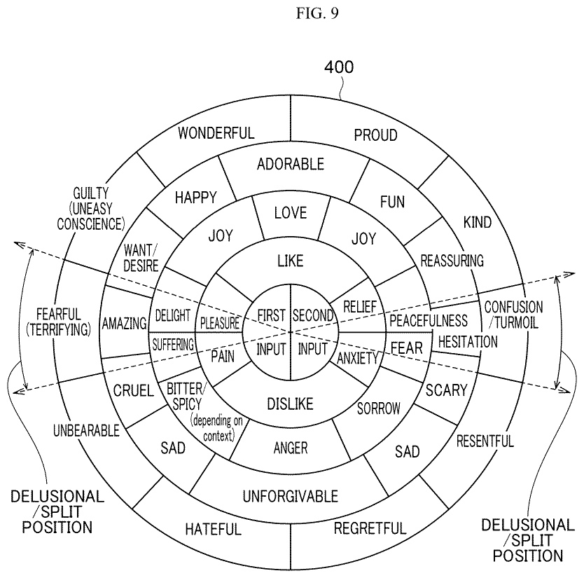

Note that the emotion identification model 59 serves as an emotion engine, and may decide the emotion of a user according to a specific mapping. Specifically, the emotion identification model 59 may decide the emotion of a user according to an emotion map (see FIG. 9) that is a specific mapping. Moreover, the emotion identification model 59 may also decide the emotion of the robot similarly, and the specific processing unit 290 may be configured so as to perform the specific processing using the emotion of the robot.

FIG. 9 is a diagram illustrating an emotion map 400 mapping plural emotions. In the emotion map 400, emotions are arranged in concentric circles that radiate out from the center. Primitive states of emotion are arranged nearer to the center of the concentric circles. Emotions expressing states and actions generated from states of mind are arranged further toward the outside of the concentric circles. Emotions are defined as including both affect and mental states. Emotions generated from reactions occurring in the brain are generally arranged at the left side of the concentric circles. Emotions induced by situational assessment are generally arranged at the right side of the concentric circles. Emotions generated from reactions occurring in the brain that are also emotions induced by situational assessment are generally arranged toward the top and toward the bottom of the concentric circles. Moreover, emotions of “euphoria” are arranged at the upper side of the concentric circles, and emotions of “dysphoria” are arranged at the lower side of the concentric circles. Plural emotions are accordingly mapped in this manner in the emotion map 400 based on a structure giving rise to emotions, and emotions that readily occur at the same time are mapped close to each other.

An example of such emotions is a distribution of emotions in the direction of 3 o'clock on the emotion map 400, generally around a boundary between relief and anxiety. Situational awareness dominates over internal sensations in the right half of the emotion map 400, with an impression of calm.

The inside of the emotion map 400 represents feelings, and the outside of the emotion map 400 represents actions, and so emotions further toward the outside of the emotion map 400 are more visible (are expressed by actions).

Human emotions are based on various balances, such as posture and blood sugar value balances, with a state of dysphoria being exhibited when these balances are far from ideal and a state of euphoria being exhibited when these balances are near to ideal. Even in a robot, a car, a motorbike, or the like, emotions can be thought of as being based on various balances such as orientation and remaining battery balances, with a state called dysphoria being exhibited when these balances are far from ideal and a state called euphoria being exhibited when these balances are near to ideal. An emotion map may, for example, be generated based on the emotion map of Dr. Mitsuyoshi (PhD Dissertation https://ci.nii.ac.jp/naid/500000375379: “Research on the phonetic recognition of feelings and a system for emotional physiological brain signal analysis”, Tokushima University). Emotions belonging to an area called “reaction” where feeling dominates are arranged in the left half of the emotion map. Moreover, emotions belonging to an area called “situation” where situational awareness dominates are arranged in the right half of the emotion map.

There are two types of emotion that facilitate leaning in an emotion map. One is an emotion in the vicinity of the center of negative “penitence” and “reflection” on the situational side. In other words, sometimes a negative “emotion” such as “I don't want to feel this way ever again” and “I don't want to be chided again” is experienced in a robot. Another is a positive emotion in the area of “desire” on the reaction side. In other words, there are times when a positive feeling such as “desire more” and “want to know more” is experienced.

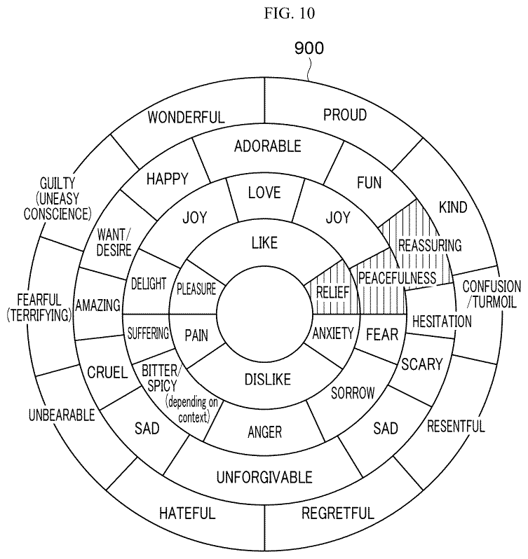

In the emotion identification model 59, user input is input to a pre-trained neural network, and emotion values indicating emotions shown on the emotion map 400 are acquired and the emotions of the user are decided. This neural network is pre-trained based on plural training data sets that each combine a user input with an emotion value indicating an emotion shown on the emotion map 400. The neural network is also trained such that emotions arranged close to each other have values that are close to each other, as in an emotion map 900 illustrated in FIG. 10. In FIG. 10 the plural emotions of “relief”, “peaceful”, and “reassured” are indicated as an example of close emotion values.

Although the system according to the present disclosure has been described mainly as functions of the data processing device 12, the system according to the present disclosure is not limited to being implemented in a server. The system according to the present disclosure may be implemented as a general information processing system. The present disclosure may, for example, be implemented by a software program operating on a personal computer, and may be implemented by an application operating on a smartphone or the like. The method according to the present disclosure may also be supplied to a user in the form of Software as a Service (Saas).

Although in the exemplary embodiments described above examples are given of embodiments in which the specific processing is performed by a single computer 22, technology disclosed herein is not limited thereto, and distributed processing may be performed for the specific processing, with the specific processing distributed across plural computers including the computer 22. For example, the data generation model 58 may be provided in a device external to the data processing device 12, such that data generation in response to input data is performed in the external device.

Although in the exemplary embodiments described above examples are described of embodiments in which the specific processing program 56 is stored in the storage 32, the technology disclosed herein is not limited thereto. For example, the specific processing program 56 may be stored on a portable, non-transitory, computer readable, storage medium, such as universal serial bus (USB) memory or the like. The specific processing program 56 stored on the non-transitory storage medium is then installed on the computer 22 of the data processing device 12. The processor 28 then executes the specific processing according to the specific processing program 56.

Moreover, the specific processing program 56 may be stored on a storage device, such as a server connected to the data processing device 12 over the network 54, with the specific processing program 56 then being downloaded in response to a request from the data processing device 12 and installed on the computer 22.

Note that there is no need to store the entire specific processing program 56 on the storage device, such as a server connected to the data processing device 12 over the network 54, or to store the entire specific processing program 56 on the storage 32, and part of the specific processing program 56 may be stored thereon.

Hardware resources for executing the specific processing may use various processors as listed below. Examples of processors include, for example, a CPU that is a general-purpose processor that functions as a hardware resource to execute the specific processing by executing software, namely a program. Moreover, the processor may, for example, be a dedicated electronic circuit that is a processor having a circuit configuration custom designed for executing the specific processing, such as a field-programmable gate array (FPGA), a programmable logic device (PLD), or an application specific integrated circuit (ASIC). Memory is inbuilt or connected to each of these processors, and the specific processing is executed by each of these processors using the memory.

The hardware resource that executes the specific processing may be configured from one of these various processors, or may be configured from a combination of two or more processors of the same or different type (for example, a combination of plural FPGAs, or a combination of a CPU and a FPGA). The hardware resource executing the specific processing may be a single processor.

Examples of configurations of a single processor include, firstly, a configuration of a single processor resulting from combining one or more CPU and software, in an embodiment in which this processor functions as the hardware resource for executing the specific processing. Secondly, as typified by a System-on-chip (SOC) or the like, there is also an embodiment that uses a processor realized by a single IC chip to function as an overall system including plural hardware resources for executing the specific processing. Adopting such an approach means that the specific processing is realized using one or more of the various processors described above as hardware resource.

Furthermore, more specifically, an electrical circuit that combines circuit elements such as semiconductor elements or the like may be employed as a hardware structure of these various processors. The specific processing is merely an example thereof. This means that obviously redundant steps may be omitted, new steps may be added, and the processing sequence may be swapped around within a range not departing from the spirit of the present disclosure.

The described content and drawing content illustrated above are a detailed description of parts according to the present disclosure, and are merely examples of the present disclosure. For example, description related to the above configuration, function, operation, and advantageous effects is a description related to examples of the configuration, function, operation, and advantageous effects of parts according to the present disclosure. This means that obviously redundant parts may be eliminated, new elements may be added, and switching around may be performed on the described content and drawing content illustrated above within a range not departing from the spirit of the present disclosure. Moreover, to avoid misunderstanding and to facilitate understanding of parts according to the present disclosure, description related to common knowledge in the art and the like not particularly needing description to enable implementation of the present disclosure is omitted in the described content and drawing content illustrated as described above.

All publications, patent applications and technical standards mentioned in the present specification are incorporated by reference in the present specification to the same extent as if each individual publication, patent application, or technical standard was specifically and individually indicated to be incorporated by reference.

Note that, regarding the above description, the following supplementary notes are further disclosed.

### Example 1

### Supplementary 1

A system comprising a processor, a storage device, a communication interface, and an input/output interface,
wherein the processor is configured to
receive authentication information from a user terminal via the communication interface,
compare the authentication information with authentication data stored in an authentication storage region of the storage device, and generate session information when the comparison is successful,
receive tax-related information, input as audio data or character data from the user terminal, via the communication interface, and record the received tax-related information in a processing history storage region of the storage device,
when the tax-related information is input as the audio data, cause a speech recognition processing apparatus to convert the audio data into character string data and store the character string data in the storage device in association with the processing history storage region,
apply a natural language processing algorithm to the character string data or the character data to perform preprocessing, part-of-speech analysis, named entity recognition, and structuring, and generate structured tax information including income information, deduction information, taxation period information, and other tax-related elements, and store the structured tax information in a structured tax information storage region of the storage device,
validate consistency of the structured tax information by detecting missing items or conflicting items and, with reference to auxiliary information including tax rate information and deduction limit information stored in an auxiliary information storage region of the storage device, complement the structured tax information,
construct a prompt sentence for input to a generative AI model based on the structured tax information and a user inquiry content, the prompt sentence including at least a role description, contextual tax information, and the user inquiry content,
transmit the prompt sentence and generation parameters to a generative AI model execution apparatus via the communication interface, and acquire, from the generative AI model execution apparatus, a response text including at least one candidate for a tax strategy,
apply at least one of rule-based determination processing and additional natural language processing to the response text to reconstruct tax strategy information including summary information, execution procedure information, required document information, and cautionary risk information, and store the tax strategy information in a tax strategy storage region of the storage device,
transmit the tax strategy information to the user terminal via the communication interface to be presented to a user through an interactive interface provided by the input/output interface,
receive feedback information input by the user via the user terminal and the communication interface, apply the natural language processing algorithm to the feedback information to analyze a content of the feedback information, and update at least one of the structured tax information and the tax strategy information in the storage device based on the analyzed content,
generate an updated prompt sentence for re-input to the generative AI model based on updated structured tax information and updated tax strategy information, transmit the updated prompt sentence to the generative AI model execution apparatus via the communication interface, and
acquire updated tax strategy information from the generative AI model execution apparatus, and
generate, based on at least the updated tax strategy information and the structured tax information, a declaration data structure in accordance with a predetermined declaration form definition, and cause a declaration document generation apparatus to automatically create tax return data stored in a declaration data storage region of the storage device.

### Supplementary 2

The system according to supplementary 1,
wherein the processor is configured to
associate the feedback information received from the user with a plurality of items of past structured tax information and past tax strategy information stored in the storage device, generate context information including a dialogue history context based on the associated information,
and add the context information to the prompt sentence to dynamically update input content to the generative AI model.

### Supplementary 3

The system according to supplementary 1,
wherein the processor is configured to
assign income information, deduction information, and tax credit information, obtained from the structured tax information and the tax strategy information stored in the storage device, to items defined by an item mapping rule corresponding to an electronic filing data format prescribed by a tax authority, and generate, as the tax return data, declaration document data that is outputtable as an electronic file or a print file.

### Application Example 1

### Supplementary 1

A system comprising a processor,
wherein the processor is configured to
perform input/output processing to collect taxation-related information from a user through an interactive interface between a terminal and the system,
generate structured information including the taxation-related information, and perform data processing to construct a prompt sentence including the structured information and to input the prompt sentence into a generative AI model,
acquire electronic transaction history data of the user by using a communication function of an electronic payment service or a financial service, and perform data acquisition processing and pre-processing to normalize and classify the electronic transaction history data,
generate a prompt sentence for determining a classification and a deductibility for each transaction based on the electronic transaction history data and the taxation-related information, and perform inference processing to input the prompt sentence into the generative AI model and obtain response data including transaction classification information and deductibility determination information,
aggregate the transaction classification information and the deductibility determination information, perform tax amount calculation processing to calculate a taxable amount and a deduction amount based on tax amount calculation rules, and perform strategy generation processing to generate strategy information representing a tax burden reduction strategy,
convert the strategy information and explanation information generated by the generative AI model into a format viewable by the user, transmit the converted information to the terminal, and present the converted information as notification information by output processing, and
receive feedback information and transaction classification correction information from the user, and perform strategy updating processing and prompt generation updating processing to update contents of the prompt sentence and the strategy information based on the feedback information and the transaction classification correction information.

### Supplementary 2

The system according to supplementary 1,
wherein the processor is configured to
perform the strategy updating processing and the prompt generation updating processing so as to update a classification rule for a specific transaction type or transaction entity based on the feedback information and the transaction classification correction information from the user, and
to incorporate the updated classification rule into a subsequent prompt sentence, thereby improving processing accuracy of transaction classification and deductibility determination by the generative AI model.

### Supplementary 3

The system according to supplementary 1,
wherein the processor is configured to
perform the tax amount calculation processing and the strategy generation processing so as to automatically generate description items of taxation-related documentation based on the taxable amount and the deduction amount, and to cause the generative AI model, by using a prompt sentence, to generate an explanatory text for the user, thereby generating output data including contents and grounds of preparation of the taxation-related documentation.

### Example 2

### Supplementary 1

A system comprising a processor,
wherein the processor is configured to
provide an input/output interface by which a user terminal interacts with the system to collect taxation-related information from a user,
store the taxation-related information as structured information in a storage device by using a relational database management mechanism,
read the taxation-related information stored in the relational database management mechanism and generate a machine-learning data set by executing data preprocessing including missing-value completion, data-type conversion, duplicate elimination, and aggregation processing by using data-processing software operating on a general-purpose program execution environment,
construct and store a trained prediction model by executing a learning process including regression analysis based on the machine-learning data set by using a machine-learning software library, the trained prediction model outputting prediction results regarding tax-saving effectiveness,
generate, for individual taxation-related information of the user, a plurality of simulation conditions, and estimate, by using the trained prediction model, a tax-burden index and a tax-saving effectiveness index for each of the simulation conditions to calculate a set of candidate tax-saving strategies,
configure a prompt sentence for causing a generative artificial intelligence model to generate a natural-language explanatory text based on the set of candidate tax-saving strategies and the tax-burden index, input the prompt sentence into the generative artificial intelligence model, and
obtain, from the generative artificial intelligence model, a natural-language tax-saving strategy explanation,
present the obtained tax-saving strategy explanation to the user through the input/output interface and acquire feedback information including evaluation information or additional input from the user regarding the presented tax-saving strategy explanation, and
store the feedback information in association with the taxation-related information in the relational database management mechanism and, based on the feedback information, update at least one of a selection criterion for the set of candidate tax-saving strategies and a component of the prompt sentence so as to dynamically adjust at least one of a utilization manner of the trained prediction model and the prompt sentence to improve a subsequently generated tax-saving strategy explanation.

### Supplementary 2

The system according to supplementary 1,
wherein the processor is configured to
analyze the feedback information to extract preference information and comprehension-level indices for the user, generate a modified prompt sentence including at least one of an additional explanation request, a specification of terminology difficulty, and an output-format specification reflecting the preference information and the comprehension-level indices, and input the modified prompt sentence into the generative artificial intelligence model to cause the tax-saving strategy explanation to be regenerated.

### Supplementary 3

The system according to supplementary 1,
wherein the processor is configured to
automatically arrange the taxation-related information into an electronic data format corresponding to a predetermined declaration form based on an output of the trained prediction model and the tax-saving strategy explanation obtained from the generative artificial intelligence model, generate a tax-declaration record, store the tax-declaration record in the storage device, and present or externally transmit the tax-declaration record through the input/output interface.

### Application Example 2

### Supplementary 1

A system comprising a processor and a storage device,
wherein the processor is configured to
provide an information input/output interface for acquiring tax information or financial information from a user through an interactive dialog,
store acquired tax information or financial information and electronic transaction information into the storage device, and execute a data processing program to classify and aggregate the electronic transaction information so as to identify candidate deductible expense items or candidate non-taxable income items,
execute natural language processing on natural language input information acquired from the user to extract user intent and inquiry content and to supplement the tax information or the financial information,
estimate an emotional state of the user on the basis of input information or voice information from the user by using an emotion estimation model, and determine an explanation difficulty level or a dialog tone in accordance with the emotional state,
automatically generate a prompt sentence to be input to a generative AI model on the basis of the identified candidate deductible expense items or the identified candidate non-taxable income items, the supplemented tax information or the supplemented financial information, the user intent, and the emotional state,
input the prompt sentence and a data processing result to the generative AI model and acquire response information including a tax strategy or a financial strategy applicable to the user from the generative AI model,
post-process recommended items included in the response information in accordance with rule information or a verification process and generate strategy information whose explanation format or detail level is adjusted in accordance with the emotional state of the user,
present the strategy information to the user via the information input/output interface and acquire feedback information from the user,
analyze the feedback information to extract constraint conditions or preferences of the user and generate an update prompt sentence reflecting the constraint conditions or the preferences, and re-input the update prompt sentence to the generative AI model so as to update the tax strategy or the financial strategy, and
calculate item values of declaration form data on the basis of the updated tax strategy or the updated financial strategy and the data processing result, and automatically generate a tax return document or a financial report document.

### Supplementary 2

The system according to supplementary 1,
wherein the processor is configured to
generate the prompt sentence to be input to the generative AI model multiple times while gradually changing content and expression style of the prompt sentence on the basis of the emotional state of the user and the feedback information, and cause the generative AI model to generate at least one of a simplified explanation strategy and a detailed explanation strategy as different forms of the tax strategy or the financial strategy.

### Supplementary 3

The system according to supplementary 1,
wherein the processor is configured to
store the data processing result and the response information acquired from the generative AI model as history information, and execute a learning process that uses the history information to optimize future prompt sentence generation processing and automatic generation processing of the tax return document or the financial report document.

What is claimed is:

1. A system comprising:
circuitry configured to:
receive, via a communication interface coupled to a packet-switched network, input data comprising at least one of character data or audio data from a terminal device;
when the input data comprises audio data, apply speech recognition processing to the audio data to generate character string data, and apply a natural language processing algorithm to the character string data or the character data to perform preprocessing, part-of-speech analysis, and named entity recognition, and generate structured attribute data comprising a plurality of category-classified numerical items and associated metadata;
validate consistency of the structured attribute data by detecting missing items or conflicting items with reference to auxiliary rule information stored in a storage device, and complement the structured attribute data based on the auxiliary rule information;
construct a first prompt sentence based on the structured attribute data and a user inquiry content, the first prompt sentence including at least a role description and contextual information, input the first prompt sentence to a generative neural network model, and acquire from the generative neural network model a response text comprising at least one candidate optimization strategy;
apply at least one of rule-based determination processing or additional natural language processing to the response text to reconstruct strategy information comprising summary information, execution procedure information, required document information, and risk information, and transmit the strategy information as a notification data packet to the terminal device; and
receive user correction data from the terminal device, apply the natural language processing algorithm to the user correction data to analyze a content of the user correction data, update at least one of the structured attribute data or the strategy information based on the analyzed content, and generate an updated prompt sentence for re-input to the generative neural network model to acquire updated strategy information.

2. The system according to claim 1, wherein the circuitry is configured to generate a structured declaration document by mapping elements of the updated strategy information and the structured attribute data to items defined by an item mapping rule corresponding to a predetermined declaration format, and store the structured declaration document in the storage device.

3. The system according to claim 2, wherein the structured declaration document is outputtable as at least one of an electronic file conforming to a prescribed electronic filing data format or a print file.

4. The system according to claim 1, wherein the speech recognition processing comprises applying an acoustic model to convert the audio data into phoneme-level representations and applying a language model to the phoneme-level representations to generate the character string data.

5. The system according to claim 1, wherein the named entity recognition identifies the category-classified numerical items as at least income information, deduction information, and taxation period information, and wherein the structured attribute data further comprises extracted numerical values and associated classification labels.

6. The system according to claim 5, wherein the validation of consistency comprises comparing extracted numerical values against upper limit values and lower limit values stored in the auxiliary rule information, and generating a correction prompt when a detected value exceeds a threshold.

7. The system according to claim 1, wherein the generative neural network model comprises a transformer-based architecture including multiple self-attention layers and feed-forward layers, and wherein the circuitry is configured to transmit the first prompt sentence and generation parameters to a model execution apparatus via the communication interface and acquire the response text from the model execution apparatus.

8. The system according to claim 1, wherein the circuitry is configured to associate the user correction data with a plurality of items of past structured attribute data and past strategy information stored in the storage device, generate context information comprising a dialogue history context based on the associated information, and add the context information to the updated prompt sentence.

9. The system according to claim 1, wherein the circuitry is configured to acquire electronic transaction record data of a user via the communication interface, perform data acquisition processing and preprocessing to normalize and classify the electronic transaction record data, and generate a prompt sentence for determining a classification and an applicability for each transaction based on the electronic transaction record data and the structured attribute data.

10. The system according to claim 9, wherein the circuitry is configured to input the prompt sentence for determining classification to the generative neural network model and obtain response data comprising transaction classification information and applicability determination information, and to aggregate the transaction classification information and the applicability determination information to calculate a total applicable amount and a reduction amount based on calculation rules stored in the storage device.

11. The system according to claim 10, wherein the circuitry is configured to update a classification rule for a specific transaction type or transaction entity based on the user correction data, and to incorporate the updated classification rule into a subsequent prompt sentence for the generative neural network model.

12. The system according to claim 1, wherein the circuitry is configured to receive authentication information from the terminal device via the communication interface, compare the authentication information with authentication data stored in an authentication storage region of the storage device, and generate session information when the comparison is successful.

13. The system according to claim 1, wherein the circuitry is configured to store the structured attribute data and the strategy information as history information in the storage device, and to execute an optimization process that uses the history information to adjust future prompt sentence generation processing.

14. The system according to claim 1, wherein the circuitry is configured to estimate an emotional state of a user based on at least one of the audio data, the character data, or voice feature information extracted from the audio data, and to adjust at least one of an explanation difficulty level or a dialog tone in the first prompt sentence based on the estimated emotional state.

15. The system according to claim 14, wherein the circuitry is configured to generate the first prompt sentence multiple times while gradually changing content and expression style based on the estimated emotional state and the user correction data, and to cause the generative neural network model to generate at least one of a simplified explanation strategy and a detailed explanation strategy.

16. The system according to claim 1, wherein the circuitry is configured to construct a trained prediction model by executing a learning process including regression analysis on a machine-learning data set derived from the structured attribute data, and to generate a plurality of simulation conditions and estimate, using the trained prediction model, an effectiveness index for each simulation condition to calculate a set of candidate strategies.

17. The system according to claim 16, wherein the circuitry is configured to configure the first prompt sentence based on the set of candidate strategies and the effectiveness index, input the first prompt sentence to the generative neural network model, and obtain from the generative neural network model a natural language explanatory text for the candidate strategies.

18. A system comprising:
circuitry configured to:
receive, via a communication interface coupled to a packet-switched network, input data comprising at least one of character data or audio data from a terminal device, and when the input data comprises audio data, apply speech recognition processing to convert the audio data into character string data;
apply a natural language processing algorithm including named entity recognition to the character string data or the character data to generate structured attribute data comprising category-classified numerical items including income information, deduction information, and period information, and validate consistency of the structured attribute data with reference to auxiliary rule information stored in a storage device;
construct a first prompt sentence comprising the structured attribute data and a user inquiry content, input the first prompt sentence to a generative neural network model comprising a transformer-based architecture, and acquire a response text comprising at least one candidate optimization strategy, and apply rule-based determination processing to the response text to reconstruct strategy information;
receive user correction data from the terminal device, generate context information comprising a dialogue history context, generate an updated prompt sentence based on the user correction data, the structured attribute data, and the context information, re-input the updated prompt sentence to the generative neural network model, and acquire updated strategy information;
estimate an emotional state of a user based on at least one of the audio data or the character data, and adjust at least one of an explanation difficulty level or a content style of the updated prompt sentence based on the estimated emotional state; and
generate a structured declaration document by mapping elements of the updated strategy information and the structured attribute data to items defined by an item mapping rule, and transmit, via the communication interface, a notification data packet comprising the strategy information to the terminal device.

19. The system according to claim 18, wherein the circuitry is configured to acquire electronic transaction record data via the communication interface, classify and aggregate the electronic transaction record data by inputting a classification prompt sentence to the generative neural network model, and incorporate transaction classification results into the structured attribute data for generating the first prompt sentence.

20. A method comprising:
receiving, via a communication interface coupled to a packet-switched network, input data comprising at least one of character data or audio data from a terminal device;
when the input data comprises audio data, applying speech recognition processing to the audio data to generate character string data, and applying a natural language processing algorithm to the character string data or the character data to perform preprocessing, part-of-speech analysis, and named entity recognition, and generating structured attribute data comprising a plurality of category-classified numerical items and associated metadata;
validating consistency of the structured attribute data by detecting missing items or conflicting items with reference to auxiliary rule information stored in a storage device, and complementing the structured attribute data based on the auxiliary rule information;
constructing a first prompt sentence based on the structured attribute data and a user inquiry content, inputting the first prompt sentence to a generative neural network model, and acquiring from the generative neural network model a response text comprising at least one candidate optimization strategy;
applying at least one of rule-based determination processing or additional natural language processing to the response text to reconstruct strategy information comprising summary information, execution procedure information, required document information, and risk information, and transmitting the strategy information as a notification data packet to the terminal device; and
receiving user correction data from the terminal device, applying the natural language processing algorithm to the user correction data, updating at least one of the structured attribute data or the strategy information based on analyzed content, and generating an updated prompt sentence for re-input to the generative neural network model to acquire updated strategy information.
